(19) United States
(12) Patent Application Publication
(10) Pub. No.: US 2026/0247253 A1
(43) Pub. Date: Aug. 20, 2026

(54) Conditional Reconfiguration Re-Use in a Communication Network

(71) Applicant: Telefonaktiebolaget LM Ericsson (publ), Stockholm (SE)

(72) Inventors: Jens Bergqvist, Linköping (SE); Icaro Leonardo Da Silva, Solna (SE); Alessio Terzani, Stockholm (SE); Cecilia Eklöf, Täby (SE)

(21) Appl. No.: 19/164,828

(22) PCT Filed: Mar. 13, 2024
(86) PCT No.: PCT/SE2024/050231

§ 371 Date: Sep. 12, 2025

Related U.S. Application Data
(60) Provisional application No. 63/452,336, filed on Mar. 15, 2023.

(51) Int. Cl. H04W 36/36

(52) U.S. Cl. CPC H04W 36/362

(57) ABSTRACT

A user equipment, UE, (12) is configured for re-using a conditional reconfiguration (40) both for conditional addition of a primary cell of a secondary cell group, PSCell, in multi-connectivity operation and for conditional change of a PSCell in multi-connectivity operation. The UE (12) receives (2000) conditional reconfigurations (40) for respective PSCell target candidate cells. The conditional reconfigurations (40) are either conditional PSCell addition, CPA, configurations or conditional PSCell change, CPC, configurations. Each of the conditional reconfigurations (40) includes a first execution condition (42) and further includes a PSCell target candidate configuration (44) to be applied towards the PSCell target candidate cell of the conditional reconfiguration (40) when the conditional reconfiguration (40) is executed. Each of at least one of the conditional reconfigurations (40) also includes information (46) about how to, upon execution of the conditional reconfiguration (40), update the first execution condition (42) of, or add a second execution condition to, each of one or more others of the conditional reconfigurations (40).

### TECHNICAL FIELD

The present application relates generally to a communication network, and relates more particularly to re-use of a conditional reconfiguration in such a network.

### BACKGROUND

Robustness of multi-connectivity procedures to failure proves challenging particularly in New Radio (NR) systems whose radio links are more prone to fast fading due to their higher operating frequencies. Conditional reconfiguration is one approach to improve robustness in this regard. Under this approach, a communication device may be commanded to apply a reconfiguration, e.g., multi-connectivity reconfiguration, earlier than traditionally commanded. But the communication device is commanded to wait to apply that reconfiguration until the communication device detects that a certain condition is fulfilled. Once the device detects that condition, the device may autonomously apply the reconfiguration without receiving any other signaling on the source radio link, e.g., so that the procedure proves robust to changing channel conditions.

These and other types of conditional configurations nonetheless threaten to increase signaling overhead, resulting in resource waste and/or reduced system performance.

### SUMMARY

Some embodiments herein enable re-use of a conditional reconfiguration, e.g., for multiple different types of multi-connectivity procedures. Some embodiments for example enable a communication device to re-use the same conditional reconfiguration for both adding a primary cell of a secondary cell group (SCG) (PSCell) in multi-connectivity operation and for changing the primary cell of an SCG. The communication device may for instance use the conditional reconfiguration for adding a PSCell if the communication device is not already configured with a PSCell or SCG but use the conditional reconfiguration for changing the PSCell if the communication device is already configured with a PSCell or SCG. Reusing the same conditional reconfiguration advantageously reduces signaling overhead, which in turn reduces resource waste and/or improves system performance.

More particularly, embodiments herein include a method performed by a user equipment, UE, for re-using a conditional reconfiguration both for conditional addition of a primary cell of a secondary cell group, PSCell, in multi-connectivity operation and for conditional change of a PSCell in multi-connectivity operation. The method comprises receiving conditional reconfigurations for respective PSCell target candidate cells. In some embodiments, the conditional reconfigurations are either conditional PSCell addition, CPA, configurations or conditional PSCell change, CPC, configurations. In some embodiments, each of the conditional reconfigurations includes a first execution condition that needs to be fulfilled in order to trigger execution of the conditional reconfiguration. In some embodiments, each of the conditional reconfigurations includes a PSCell target candidate configuration that is a configuration to be applied towards the PSCell target candidate cell of the conditional reconfiguration when the conditional reconfiguration is executed. In some embodiments, each of at least one of the conditional reconfigurations also includes information about how to, upon execution of the conditional reconfiguration, update the first execution condition of, or add a second execution condition to, each of one or more others of the conditional reconfigurations.

In some embodiments, the information included in each of the at least one of the conditional reconfigurations is information about how to, upon execution of the conditional reconfiguration, add a second execution condition to each of one or more others of the conditional reconfigurations. In some embodiments, the conditional reconfigurations are CPA configurations, and the information in each of at least one of the conditional reconfigurations is information about how to, upon execution of the conditional reconfiguration, add a second execution condition to each of one or more others of the conditional reconfigurations in order to configure the other conditional reconfiguration to be re-usable as a CPC configuration. In some embodiments, the information included in each of the at least one of the conditional reconfigurations is information about how to, upon execution of the conditional reconfiguration towards the PSCell target candidate cell of the conditional reconfiguration, add a second execution condition to each of one or more others of the conditional reconfigurations in order to configure the other conditional reconfiguration to be re-usable as a CPC configuration that is based on the PSCell target candidate cell of the conditional configuration being a serving PSCell for the UE. In some embodiments, for each of the one or more others of the conditional reconfigurations to which a second execution condition is added, the first execution condition needs to be fulfilled in order to trigger execution of the conditional reconfiguration when the UE is not configured with any serving PSCell configuration or with any secondary cell group, SCG. In some embodiments, for each of the one or more others of the conditional reconfigurations to which a second execution condition is added the second execution condition needs to be fulfilled in order to trigger execution of the conditional reconfiguration when the UE is configured with a serving PSCell configuration or with an SCG. In some embodiments, for each of the one or more others of the conditional reconfigurations to which a second execution condition is added the first execution condition is associated with conditional event A4. In some embodiments, for each of the one or more others of the conditional reconfigurations to which a second execution condition is added the second execution condition is associated with conditional event A3 or conditional event A5. In some embodiments, the information included in each of the at least one of the conditional reconfigurations comprises the second execution condition to be added to each of the one or more other conditional reconfigurations. In some embodiments, for each of the one or more others of the conditional reconfigurations to which a second execution condition is added, the second execution condition is added in a condExecutionCondSCG information element of the conditional reconfiguration.

In some embodiments, for each of the conditional reconfigurations, the first execution condition is included in a condExecutionCond information element of the conditional reconfiguration.

In some embodiments, receiving the conditional reconfigurations comprises receiving the conditional reconfigurations when the UE is not configured with any serving PSCell configuration or with any SCG.

In some embodiments, the information included in each of the at least one of the conditional reconfigurations is information about how to, upon execution of the conditional reconfiguration, update the first execution condition of each of one or more others of the conditional reconfigurations in order to change the other conditional reconfiguration from a CPA configuration to a CPC configuration or from a CPC configuration to a CPA configuration.

In some embodiments, the information included in each of the at least one of the conditional reconfigurations is included in the conditional reconfiguration outside of the PSCell target candidate configuration of the conditional reconfiguration.

In some embodiments, receiving the conditional reconfigurations comprises receiving one or more radio resource control, RRC, reconfiguration messages, wherein each RRC reconfiguration message includes a condReconfig ToAddModList information element that comprises a list of one or more of the conditional reconfigurations.

In some embodiments, the method further comprises detecting fulfillment of the execution condition included in a first conditional reconfiguration among said conditional reconfigurations. In some embodiments, the method further comprises executing the first conditional reconfiguration based on said detecting. In some embodiments, the method further comprises upon executing the first conditional reconfiguration, updating the first execution condition of, or adding a second execution condition to, each of one or more others of the conditional reconfigurations according to the information included in the first conditional reconfiguration about how to perform said updating or adding. In some embodiments, said updating or adding comprises adding a second execution condition to each of one or more others of the conditional reconfigurations according to the information included in the first conditional reconfiguration about how to perform said updating or adding. In some embodiments, the method further comprises, after said adding, for each of the one or more others of the conditional reconfigurations to which a second execution condition is added, determining whether to execute the conditional reconfiguration by evaluating whether the second execution condition is fulfilled. In some embodiments, the method further comprises, after said adding, receiving a message that configures a release of a PSCell configuration of the UE. In some embodiments, the method further comprises, after said adding, after receiving the message, for each of the one or more others of the conditional reconfigurations to which a second execution condition is added, determining whether to execute the conditional reconfiguration by evaluating whether the first execution condition is fulfilled.

Other embodiments herein include a method performed by a network node in a communication network for enabling a user equipment, UE, to re-use a conditional reconfiguration both for conditional addition of a primary cell of a secondary cell group, PSCell, in multi-connectivity operation and for conditional change of a PSCell in multi-connectivity operation. The method comprises transmitting, to the UE, conditional reconfigurations for respective PSCell target candidate cells. In some embodiments, the conditional reconfigurations are either conditional PSCell addition, CPA, configurations or conditional PSCell change, CPC, configurations. In some embodiments, each of the conditional reconfigurations includes a first execution condition that needs to be fulfilled in order to trigger execution of the conditional reconfiguration. In some embodiments, each of the conditional reconfigurations includes a PSCell target candidate configuration that is a configuration to be applied towards the PSCell target candidate cell of the conditional reconfiguration when the conditional reconfiguration is executed. In some embodiments, each of at least one of the conditional reconfigurations also includes information about how to, upon execution of the conditional reconfiguration, update the first execution condition of, or add a second execution condition to, each of one or more others of the conditional reconfigurations.

In some embodiments, the information included in each of the at least one of the conditional reconfigurations is information about how to, upon execution of the conditional reconfiguration, add a second execution condition to each of one or more others of the conditional reconfigurations. In some embodiments, the conditional reconfigurations are CPA configurations, and the information in each of at least one of the conditional reconfigurations is information about how to, upon execution of the conditional reconfiguration, add a second execution condition to each of one or more others of the conditional reconfigurations in order to configure the other conditional reconfiguration to be re-usable as a CPC configuration. In some embodiments, the information included in each of the at least one of the conditional reconfigurations is information about how to, upon execution of the conditional reconfiguration towards the PSCell target candidate cell of the conditional reconfiguration, add a second execution condition to each of one or more others of the conditional reconfigurations in order to configure the other conditional reconfiguration to be re-usable as a CPC configuration that is based on the PSCell target candidate cell of the conditional configuration being a serving PSCell for the UE. In some embodiments, for each of the one or more others of the conditional reconfigurations to which a second execution condition is added, the first execution condition needs to be fulfilled in order to trigger execution of the conditional reconfiguration when the UE is not configured with any serving PSCell configuration or with any secondary cell group, SCG. In some embodiments, for each of the one or more others of the conditional reconfigurations to which a second execution condition is added, the second execution condition needs to be fulfilled in order to trigger execution of the conditional reconfiguration when the UE is configured with a serving PSCell configuration or with an SCG. In some embodiments, for each of the one or more others of the conditional reconfigurations to which a second execution condition is added, the first execution condition is associated with conditional event A4. In some embodiments, for each of the one or more others of the conditional reconfigurations to which a second execution condition is added, the second execution condition is associated with conditional event A3 or conditional event A5. In some embodiments, the information included in each of the at least one of the conditional reconfigurations comprises the second execution condition to be added to each of the one or more other conditional reconfigurations. In some embodiments, for each of the one or more others of the conditional reconfigurations to which a second execution condition is added, the second execution condition is added in a condExecutionCondSCG information element of the conditional reconfiguration.

In some embodiments, for each of the conditional reconfigurations, the first execution condition is included in a condExecutionCond information element of the conditional reconfiguration.

In some embodiments, transmitting the conditional reconfigurations comprises transmitting the conditional reconfigurations when the UE is not configured with any serving PSCell configuration or with any SCG.

In some embodiments, the information included in each of the at least one of the conditional reconfigurations is information about how to, upon execution of the conditional reconfiguration, update the first execution condition of each of one or more others of the conditional reconfigurations in order to change the other conditional reconfiguration from a CPA configuration to a CPC configuration or from a CPC configuration to a CPA configuration.

In some embodiments, the information included in each of the at least one of the conditional reconfigurations is included in the conditional reconfiguration outside of the PSCell target candidate configuration of the conditional reconfiguration.

In some embodiments, transmitting the conditional reconfigurations comprises transmitting one or more radio resource control, RRC, reconfiguration messages, wherein each RRC reconfiguration message includes a condReconfig ToAddModList information element that comprises a list of one or more of the conditional reconfigurations.

Other embodiments herein include a user equipment, UE, configured for re-using a conditional reconfiguration both for conditional addition of a primary cell of a secondary cell group, PSCell, in multi-connectivity operation and for conditional change of a PSCell in multi-connectivity operation. The UE is configured to receive conditional reconfigurations for respective PSCell target candidate cells. In some embodiments, the conditional reconfigurations are either conditional PSCell addition, CPA, configurations or conditional PSCell change, CPC, configurations. In some embodiments, each of the conditional reconfigurations includes a first execution condition that needs to be fulfilled in order to trigger execution of the conditional reconfiguration. In some embodiments, each of the conditional reconfigurations includes a PSCell target candidate configuration that is a configuration to be applied towards the PSCell target candidate cell of the conditional reconfiguration when the conditional reconfiguration is executed. In some embodiments, each of at least one of the conditional reconfigurations also includes information about how to, upon execution of the conditional reconfiguration, update the first execution condition of, or add a second execution condition to, each of one or more others of the conditional reconfigurations.

In some embodiments, the UE is configured to perform the steps described above for a UE for re-using a conditional reconfiguration both for conditional addition of a primary cell of a secondary cell group, PSCell, in multi-connectivity operation and for conditional change of a PSCell in multi-connectivity operation.

Other embodiments herein include a network node configured for use in a communication network for enabling a user equipment, UE, to re-use a conditional reconfiguration both for conditional addition of a primary cell of a secondary cell group, PSCell, in multi-connectivity operation and for conditional change of a PSCell in multi-connectivity operation. The network node is configured to transmit, to the UE, conditional reconfigurations for respective PSCell target candidate cells. In some embodiments, the conditional reconfigurations are either conditional PSCell addition, CPA, configurations or conditional PSCell change, CPC, configurations. In some embodiments, each of the conditional reconfigurations includes a first execution condition that needs to be fulfilled in order to trigger execution of the conditional reconfiguration. In some embodiments, each of the conditional reconfigurations includes a PSCell target candidate configuration that is a configuration to be applied towards the PSCell target candidate cell of the conditional reconfiguration when the conditional reconfiguration is executed. In some embodiments, each of at least one of the conditional reconfigurations also includes information about how to, upon execution of the conditional reconfiguration, update the first execution condition of, or add a second execution condition to, each of one or more others of the conditional reconfigurations.

In some embodiments, the network node is configured to perform the steps described above for a network node in a communication network for enabling a user equipment, UE, to re-use a conditional reconfiguration both for conditional addition of a primary cell of a secondary cell group, PSCell, in multi-connectivity operation and for conditional change of a PSCell in multi-connectivity operation.

In some embodiments, a computer program comprising instructions which, when executed by at least one processor of a user equipment, causes the user equipment to perform the steps described above for a UE for re-using a conditional reconfiguration both for conditional addition of a primary cell of a secondary cell group, PSCell, in multi-connectivity operation and for conditional change of a PSCell in multi-connectivity operation.

In some embodiments, a computer program comprising instructions which, when executed by at least one processor of a user equipment, causes the user equipment to perform the steps described above for a network node in a communication network for enabling a user equipment, UE, to re-use a conditional reconfiguration both for conditional addition of a primary cell of a secondary cell group, PSCell, in multi-connectivity operation and for conditional change of a PSCell in multi-connectivity operation.

In some embodiments, a carrier containing the computer program is one of an electronic signal, optical signal, radio signal, or computer readable storage medium.

Other embodiments herein include a user equipment, UE, configured for re-using a conditional reconfiguration both for conditional addition of a primary cell of a secondary cell group, PSCell, in multi-connectivity operation and for conditional change of a PSCell in multi-connectivity operation. The UE comprises communication circuitry and processing circuitry. The processing circuitry is configured to receive conditional reconfigurations for respective PSCell target candidate cells. In some embodiments, the conditional reconfigurations are either conditional PSCell addition, CPA, configurations or conditional PSCell change, CPC, configurations. In some embodiments, each of the conditional reconfigurations includes a first execution condition that needs to be fulfilled in order to trigger execution of the conditional reconfiguration. In some embodiments, each of the conditional reconfigurations includes a PSCell target candidate configuration that is a configuration to be applied towards the PSCell target candidate cell of the conditional reconfiguration when the conditional reconfiguration is executed. In some embodiments, each of at least one of the conditional reconfigurations also includes information about how to, upon execution of the conditional reconfiguration, update the first execution condition of, or add a second execution condition to, each of one or more others of the conditional reconfigurations.

In some embodiments, the processing circuitry is configured to perform the steps described above for a UE for re-using a conditional reconfiguration both for conditional addition of a primary cell of a secondary cell group, PSCell, in multi-connectivity operation and for conditional change of a PSCell in multi-connectivity operation.

Other embodiments herein include a network node configured for use in a communication network for enabling a user equipment, UE, to re-use a conditional reconfiguration both for conditional addition of a primary cell of a secondary cell group, PSCell, in multi-connectivity operation and for conditional change of a PSCell in multi-connectivity operation. The network node comprises communication circuitry and processing circuitry. The processing circuitry is configured to transmit, via the communication circuitry, to the UE, conditional reconfigurations for respective PSCell target candidate cells. In some embodiments, the conditional reconfigurations are either conditional PSCell addition, CPA, configurations or conditional PSCell change, CPC, configurations. In some embodiments, each of the conditional reconfigurations includes a first execution condition that needs to be fulfilled in order to trigger execution of the conditional reconfiguration. In some embodiments, each of the conditional reconfigurations includes a PSCell target candidate configuration that is a configuration to be applied towards the PSCell target candidate cell of the conditional reconfiguration when the conditional reconfiguration is executed. In some embodiments, each of at least one of the conditional reconfigurations also includes information about how to, upon execution of the conditional reconfiguration, update the first execution condition of, or add a second execution condition to, each of one or more others of the conditional reconfigurations.

In some embodiments, the processing circuitry is configured to perform the steps described above for a network node in a communication network for enabling a user equipment, UE, to re-use a conditional reconfiguration both for conditional addition of a primary cell of a secondary cell group, PSCell, in multi-connectivity operation and for conditional change of a PSCell in multi-connectivity operation.

### BRIEF DESCRIPTION OF THE DRAWINGS

FIG. 1 is a block diagram of a communication network according to some embodiments.

FIG. 2 is a block diagram of a conditional reconfiguration transmitted from a network node to a communication device according to some embodiments.

FIG. 3 is a block diagram of a conditional reconfiguration according to some embodiments.

FIG. 4 is a block diagram of a conditional reconfiguration according to other embodiments.

FIG. 5 is a block diagram of a conditional reconfiguration according to other embodiments.

FIG. 6 is a block diagram of a conditional reconfiguration according to other embodiments.

FIG. 7 is a block diagram of a conditional reconfiguration according to other embodiments.

FIG. 8 is a block diagram of conditional reconfigurations transmitted from a network node to a communication device in a communication network according to other embodiments.

FIG. 9A is a block diagram of conditional reconfigurations according to some embodiments.

FIG. 9B is a block diagram of conditional reconfigurations according to other embodiments.

FIG. 10 is a block diagram of dual connectivity configured for a User Equipment, UE, according to some embodiments.

FIG. 11 is a block diagram of dual connectivity configured for a User Equipment, UE, according to other embodiments.

FIG. 12 is a block diagram of dual connectivity configured for a User Equipment, UE, according to other embodiments.

FIG. 13 is a call flow diagram for serving and a target cell, according to some embodiments.

FIG. 14 is a call flow diagram for serving and a target cell, according to some embodiments.

FIG. 15 is a logic flow diagram of a method performed by a communication device in accordance with particular embodiments.

FIG. 16 is a logic flow diagram of a method performed by a communication device in accordance with particular embodiments.

FIG. 17 is a logic flow diagram of a method performed by a communication device in accordance with particular embodiments.

FIG. 18 is a logic flow diagram of a method performed by a network node in accordance with particular embodiments.

FIG. 19 is a logic flow diagram of a method performed by a network node in accordance with particular embodiments.

FIG. 20 is a logic flow diagram of a method performed by a UE in accordance with particular embodiments.

FIG. 21 is a logic flow diagram of a method performed by a network node in accordance with particular embodiments.

FIG. 22 is a block diagram of a communication device in accordance with particular embodiments.

FIG. 23 is a block diagram of a network node in accordance with particular embodiments.

FIG. 24 is a block diagram of a communication system in accordance with some embodiments.

FIG. 25 is a block diagram of a user equipment according to some embodiments.

FIG. 26 is a block diagram of a network node according to some embodiments.

FIG. 27 is a block diagram of a host according to some embodiments.

FIG. 28 is a block diagram of a virtualization environment according to some embodiments.

FIG. 29 is a block diagram of a host communicating via a network node with a UE over a partially wireless connection in accordance with some embodiments.

### DETAILED DESCRIPTION

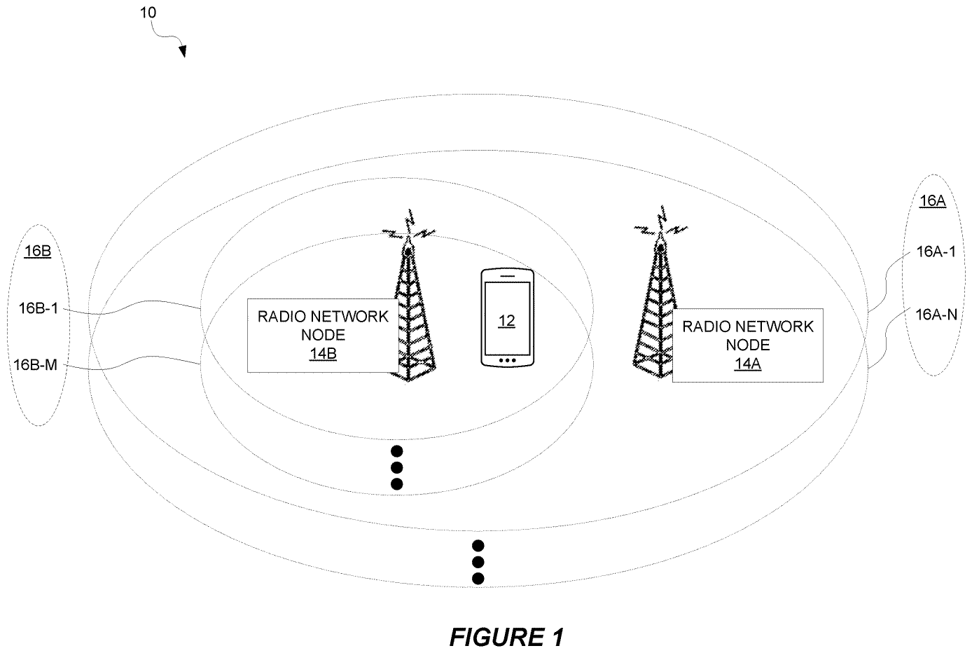

FIG. 1 shows a communication network 10 according to some embodiments. The communication network 10 is configured to provide communication service to a communication device 12, e.g., a user equipment (UE). The network 10 as shown includes radio network nodes 14A and 14B, e.g., in the form of base stations. The radio network nodes 14A and 14B may be included in a radio access network (RAN) portion of the network 10, which may in turn connect to a core network (CN) portion (not shown).

Each radio network node 14A, 14B serves one or more cells. As shown, for example, a first radio network node 14A provides a first cell group 16A that includes N cells 16A-1, . . . 16A-N, for N≥1. A second radio network node 14B provides a second cell group 16B that includes M cells 16B-1, . . . 16B-M, for M≥1. Different cells may for instance be provided on different carrier frequencies, with different frequency bandwidths, and/or using different radio access technologies.

In some embodiments, the communication device 12 is configured with and/or capable of multi-connectivity operation. In multi-connectivity operation, the communication device 12 simultaneously connects, e.g., at a radio resource control, RRC, layer, to multiple different radio network nodes 14A, 14B, or to multiple different cells served by different radio network nodes 14A, 14B. The multiple different radio network nodes or cells may use the same radio access technology, e.g., both may use Evolved Universal Terrestrial Radio Access (E-UTRA) or both may use New Radio (NR). Or, the multiple different radio network nodes or cells may use different radio access technologies, e.g., one may use E-UTRA and another may use NR.

One example of multi-connectivity is dual connectivity (DC) in which the communication device 12 is simultaneously connected to two different radio network nodes, or to two different cells served by two different radio network nodes. In this case, the communication device 12 may be configured with a so-called master cell group (MCG) and a secondary cell group (SCG). Here, the MCG includes one or more cells served by the radio network node acting as a master node, i.e., a group of serving cells associated with the master node. The MCG may include a primary cell and optionally one or more secondary cells. The primary cell of the MCG is referred to as a PCell. The SCG includes one or more cells served by the radio network node acting as a secondary node, i.e., a group of serving cells associated with the secondary node. The SCG may include a primary cell and optionally one or more secondary cells. The primary cell of the SCG is referred to as the PSCell.

The master node may be a master in the sense that it controls the secondary node. Alternatively or additionally, the master node may be a master in the sense that it is a radio access node that provides the control plane connection for the communication device 12 to the core network, whereas the secondary node lacks a control plane connection for the communication device 12 to the core network.

Different types of dual connectivity may be employed by different embodiments. In some embodiments, the communication device 12 operates with E-UTRA-NR (EN) DC, where the master node uses E-UTRA and the secondary node uses NR. In other embodiments, the communication device 12 operates with NR-E-UTRA (NE) DC, where the master node uses NR and the secondary node uses E-UTRA. In still other embodiments, the communication device 12 operates with NR-DC, where both the master node and secondary node use NR. Generally, though, the communication device 12 in some embodiments operates with multi-radio (MR) DC, which refers to dual connectivity between E-UTRA and NR nodes, or between two NR nodes. MR-DC therefore may be seen as a generalization of Intra-U-UTRA DC, where a multiple receiver/transmitter capable device is configured to utilize resources provided by two different nodes connected via a non-ideal backhaul, one providing NR access and the other providing either E-UTRA or NR access. Regardless, in MR-DC, the communication device 12 may have a single RRC state, based on the master node RRC and a single control plane connection towards the core network. RRC protocol data units (PDUs) generated by the secondary node can be transmitted via the master node to the communication device 12.

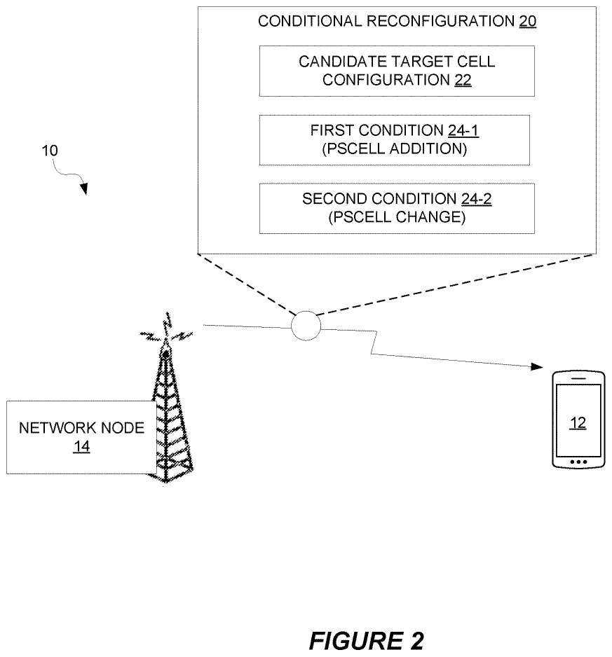

In this context, FIG. 2 shows that the communication device 12 in some embodiments receives a conditional reconfiguration 20, e.g., from a network node 14 which may be radio network node 14A or radio network node 14B in FIG. 1. The conditional reconfiguration 20 may be received in a message, e.g., an RRC message, in which case the message may include one or more conditional reconfigurations, including the conditional reconfiguration 20.

The conditional reconfiguration 20 as shown includes a configuration 22 of a candidate target cell. The candidate target cell may be a candidate for being the target of a multi-connectivity procedure, e.g., a PSCell addition procedure or a PSCell change procedure. The configuration 22 may take the form of an RRC configuration that the communication device 12 is to apply, e.g., as part of executing a procedure, when a condition is fulfilled.

The conditional reconfiguration 20 in this regard includes first and second conditions 24-1, 24-2. In some embodiments, the first and second conditions 24-1, 24-2 are alternative conditions, where fulfilment of either condition triggers the communication device 12 to apply the configuration 22 of the candidate target cell.

However, in some embodiments, the communication device 12 is configured evaluate the first and second conditions 24-1, 24-2 under different circumstances. The communication device 12 is to evaluate the first condition 24-1, for determining whether to apply the configuration 22, when the communication device 12 is not configured with a serving PSCell, e.g., because the communication device 12 is not configured with any SCG. By contrast, the communication device 12 is to evaluate the second condition 24-2, for determining whether to apply the configuration 22, when the communication device 12 is configured with a serving PSCell.

In these and other embodiments, inclusion of the first and second conditions 24-1, 24-2 may enable reuse of the conditional configuration 20. For example, the conditional reconfiguration may be reusable for PSCell addition or PSCell change. In this case, the condition reconfiguration 20 may correspond to a conditional PSCell addition configuration when the communication device 12 is not configured with a serving PSCell and correspond to a conditional PSCell change configuration when the communication device 12 is configured with a serving PSCell.

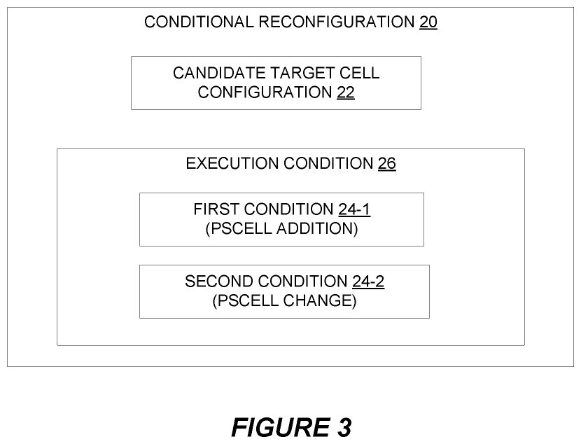

In some embodiments, as shown in FIG. 3, the conditional reconfiguration 20 includes an execution condition field 26 that indicates both the first and second conditions 24-1, 24-2. The execution condition field 26 may do so directly or indirectly.

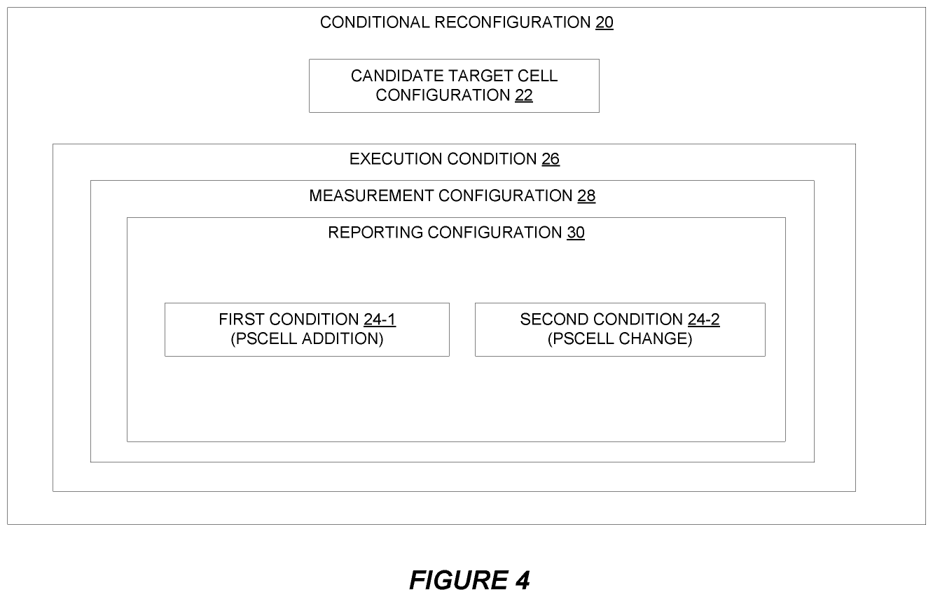

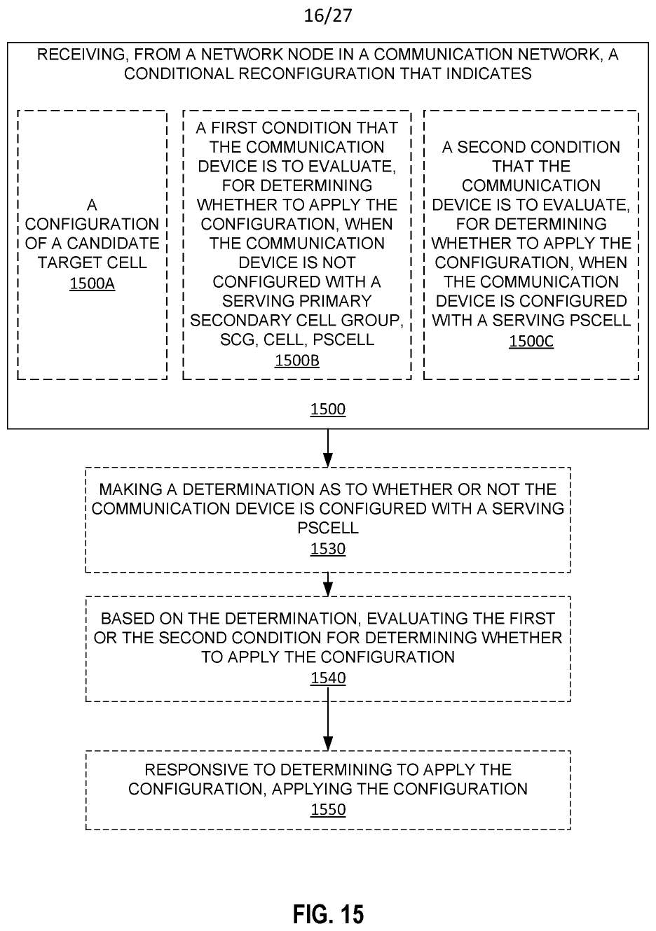

As an example, FIG. 4 shows that in some embodiments the execution condition field 26 identifies a measurement configuration 28. The measurement configuration 28 is associated with a reporting configuration 30. And the reporting configuration 30 indicates both the first and second conditions 24-1, 24-2. For details on variations of these embodiments, see FIG. 15 and the description thereof as well as Embodiments A4-A11 in GROUP A EMBODIMENTS herein.

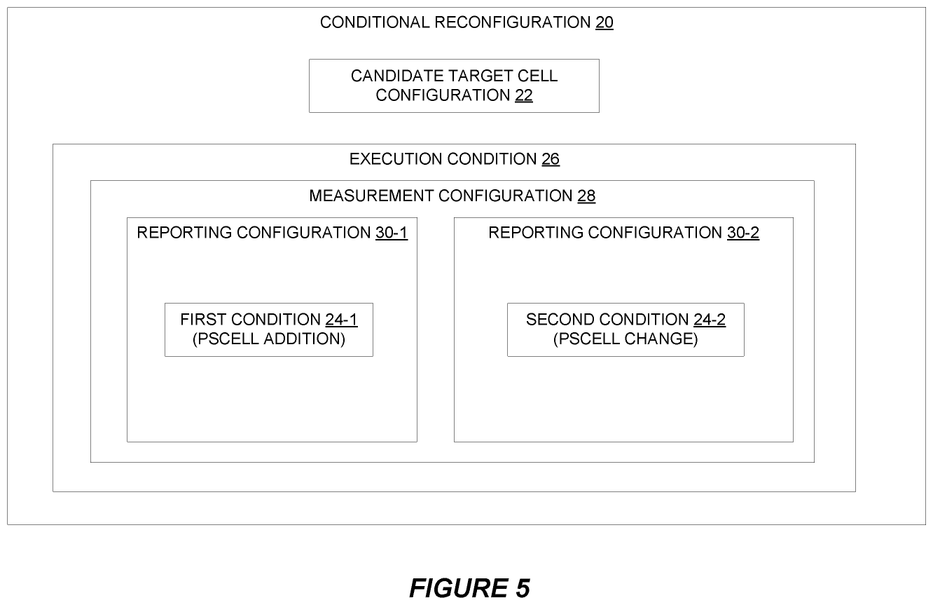

FIG. 5 shows another example. In this example, the execution condition field 26 also identifies a measurement configuration 28. But the measurement configuration 28 is associated with first and second reporting configurations 30-1, 30-2. The first reporting configuration 30-1 indicates the first condition 24-1 and the second reporting configuration 30-2 indicates the second condition 24-2. For details on variations of these embodiments, see FIG. 15 and the description thereof as well as Embodiments A13-A14 in GROUP A EMBODIMENTS herein.

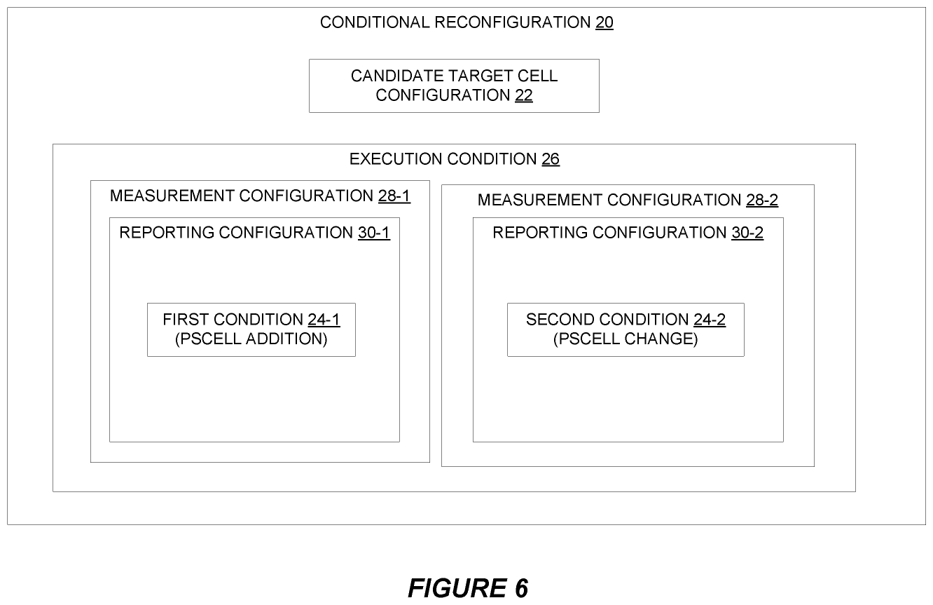

FIG. 6 shows yet another example. In this example, the execution condition field 26 identifies first and second measurement configurations 28-1, 28-2. The first measurement configuration 28-1 is associated with a first reporting configuration 30-1, and the second measurement configuration 28-2 is associated with a second reporting configuration 30-2. The first reporting configuration 30-1 indicates the first condition 24-1 and the second reporting configuration 30-2 indicates the second condition 24-2. For details on variations of these embodiments, see FIG. 15 and the description thereof as well as Embodiments A16-A19 in GROUP A EMBODIMENTS herein.

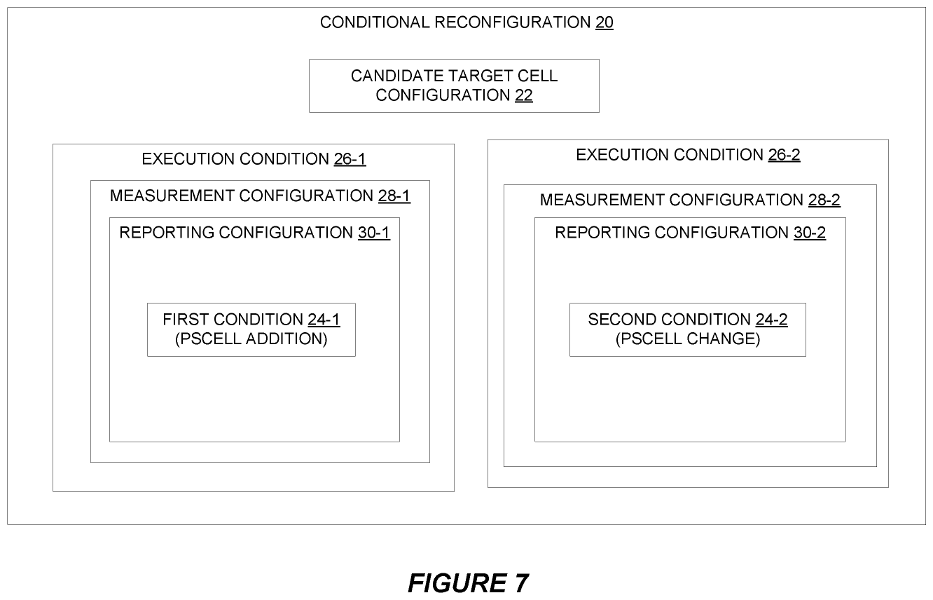

FIG. 7 shows other embodiments where the conditional reconfiguration 20 includes first and second execution condition fields 26-1, 26-2 that respectively indicate the first and second conditions 24-1, 24-2. In this example, the first execution condition field 26-1 identifies a first measurement configuration 28-1, and the second execution condition field 26-2 identifies a second measurement configuration 28-2. The first measurement configuration 28-1 is associated with a first reporting configuration 30-1, and the second measurement configuration 28-2 is associated with a second reporting configuration 30-2. The first reporting configuration 30-1 indicates the first condition 24-1 and the second reporting configuration 30-2 indicates the second condition 24-2. For details on variations of these embodiments, see FIG. 15 and the description thereof as well as Embodiments A22-A23 in GROUP A EMBODIMENTS herein.

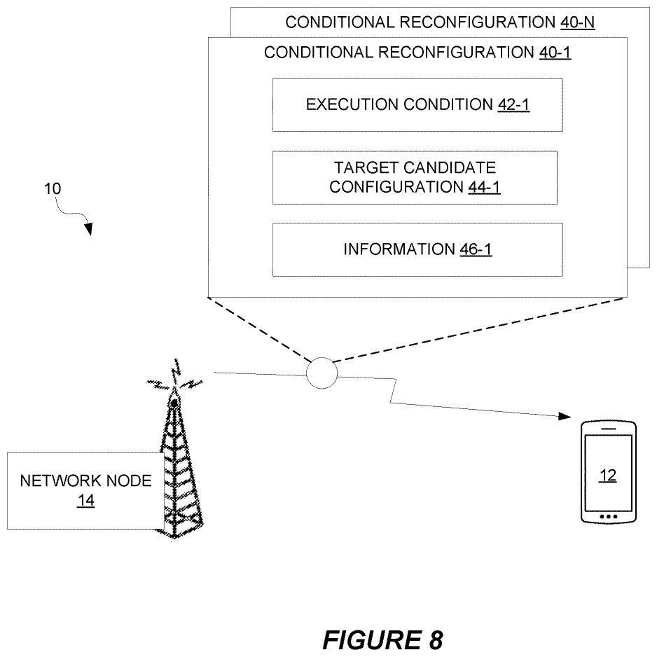

FIG. 8 shows yet other embodiments herein. As shown, the communication device 12 in some embodiments receives multiple conditional reconfigurations 40-1 . . . 40-N, generally referred to as conditional reconfigurations 40. The communication device 12 may receive the conditional reconfigurations 40 from a network node 14 which may be radio network node 14A or radio network node 14B in FIG. 1. At least some of the conditional reconfigurations 40 may be received in the same message or in different messages, e.g., in RRC message(s). In one such embodiment, the communication device 12 may receive one or more radio resource control (RRC) reconfiguration messages, where each RRC reconfiguration message includes a condReconfig ToAddModList information element (IE) that comprises a list of one or more of the conditional reconfigurations 40-1 . . . 40-N.

The conditional reconfigurations 40 are for respective target candidate cells, e.g., that are candidates for being the target of a multi-connectivity procedure such as a PSCell addition procedure or a PSCell change procedure. For example, the conditional reconfigurations 40 may be for respective PSCell target candidate cells. In this case, the conditional reconfigurations 40 may be either conditional PSCell addition (CPA) configurations or conditional PSCell change (CPC) configurations.

Each of the conditional reconfigurations 40-1 . . . 40-N includes a respective execution condition 42-1 . . . 42-N and a respective target candidate configuration 44-1 . . . 44-N. The execution condition 42 included in a conditional reconfiguration 40 is a condition that needs to be fulfilled in order to trigger execution of the conditional reconfiguration 40. The target candidate configuration 44 included in a conditional reconfiguration 40 is a configuration to be applied towards the target candidate cell of the conditional reconfiguration 40 when the conditional reconfiguration 40 is executed. Where the target candidate cells are candidate PSCells, then, a target candidate configuration 44 may be a PSCell target candidate configuration. Either way, the target candidate configuration 44 may take the form of an RRC configuration that the communication device 12 is to apply, e.g., as part of executing a procedure, when the conditional reconfiguration 40 is executed.

Notably, each of at least one of the conditional reconfigurations 40-1 . . . 40-N also includes information 46-1 . . . 46-N. In some embodiments, the information 46-1 . . . 46-N included in each of the at least one of the conditional reconfigurations 40-1 . . . 40-N is information about how to, upon execution of the conditional reconfiguration 44-1 . . . 44-N, update the execution condition 42-1 . . . 42-N of each of one or more others of the conditional reconfiguration 44-1 . . . 44-N. As shown, for example, the information 46-1 . . . 46-N included in each of the at least one of the conditional reconfigurations 40-1 . . . 40-N may be included in the conditional reconfiguration 40 outside of the target candidate configuration 44 of the conditional reconfiguration 40. In embodiments where the target candidate cells are candidate PSCells, the information 46-1 . . . 46-N included in each of the at least one of the conditional reconfigurations 40-1 . . . 40-N may be information about how to, upon execution of the conditional reconfiguration 40-1 . . . 40-N, update the execution condition 42-1 . . . 42-N of each of one or more others of the conditional reconfigurations 40-1 . . . 40-N in order to change the other conditional reconfiguration from a CPA configuration to a CPC configuration or from a CPC configuration to a CPA configuration. The information about how to update an execution condition 42 may for instance include an updated execution condition that is to replace the existing execution condition.

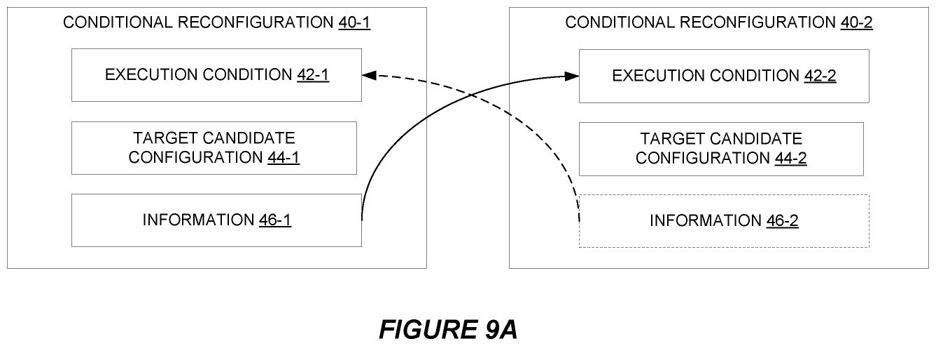

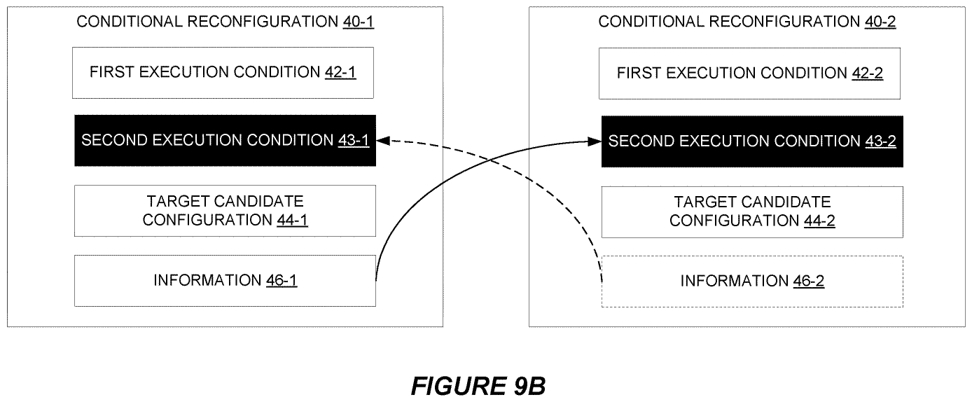

FIG. 9A for instance shows a simple example for two conditional reconfigurations 40-1 and 40-2. In this example, conditional reconfiguration 40-1 includes information 46-1 about how to, upon execution of the conditional reconfiguration 40-1, update the execution condition 42-2 of conditional reconfiguration 40-2. Likewise, in some embodiments, conditional reconfiguration 40-2 includes information 46-2 about how to, upon execution of the conditional reconfiguration 40-2, update the execution condition 42-1 of conditional reconfiguration 40-1.

In some embodiments, for instance, the conditional reconfigurations 40-1 and 40-2 as received by the communication device 12 are CPA configurations. This may be the case for example where the communication device 12 receives the conditional reconfigurations 40-1 and 40-2 when the communication device 12 is not configured with any serving PSCell configuration. Regardless, in this case, the information 46-1 in conditional reconfiguration 40-1 may be information about how to, upon execution of the conditional reconfiguration 40-1, update the execution condition 42-2 of conditional reconfiguration 40-2 in order to change that conditional reconfiguration 40-2 into a CPC configuration, e.g., that is based on the PSCell target candidate cell of the conditional configuration 40-1 being a serving PSCell for the communication device 12. The information 46-1 may for instance be information about how to update the execution condition 42-2 of conditional reconfiguration 40-2 from being associated with conditional event A4 to be associated with conditional event A3 or conditional event A5. Such would enable the conditional reconfiguration 40-2 (originally a CPA configuration) to be re-used as a CPC configuration, i.e., so that conditional reconfiguration 40-2 can be re-used for both CPA and CPC. That is, after the communication device 12 detects fulfillment of the execution condition 42-1 and executes conditional reconfiguration 40-1 for CPA, the conditional reconfiguration 40-2 that was not executed for CPA is updated based on the information 46-1 so as to convert that conditional reconfiguration 40-2 to being a candidate for CPC.

Likewise, the information 46-2 in conditional reconfiguration 40-2 may be information about how to, upon execution of the conditional reconfiguration 40-2, update the execution condition 42-1 of conditional reconfiguration 40-1 in order to change that conditional reconfiguration 40-1 into a CPC configuration, e.g., that is based on the PSCell target candidate cell of the conditional configuration 40-2 being a serving PSCell for the communication device 12. The information 46-2 may for instance be information about how to update the execution condition 42-1 of conditional reconfiguration 40-1 from being associated with conditional event A4 to be associated with conditional event A3 or conditional event A5. This would similarly enable the conditional reconfiguration 40-1 (originally a CPA configuration) to be re-used as a CPC configuration, i.e., so that conditional reconfiguration 40-1 can be re-used for both CPA and CPC. That is, after the communication device 12 detects fulfillment of the execution condition 42-2 and executes conditional reconfiguration 40-2 for CPA, the conditional reconfiguration 40-1 that was not executed for CPA is updated based on the information 46-2 so as to convert that conditional reconfiguration 40-1 to being a candidate for CPC.

In other embodiments, as another example, the conditional reconfigurations 40-1 and 40-2 as received by the communication device 12 are CPC configurations. This may be the case for example where the communication device 12 receives the conditional reconfigurations 40-1 and 40-2 when the communication device 12 is configured with a serving PSCell configuration. Regardless, in this case, the information 46-1 in conditional reconfiguration 40-1 may be information about how to, upon execution of the conditional reconfiguration 40-1, update the execution condition 42-2 of conditional reconfiguration 40-2 in order to change that conditional reconfiguration 40-2 into a CPA configuration. The information 46-1 may for instance be information about how to update the execution condition 42-2 of conditional reconfiguration 40-2 from being associated with conditional event A3 or conditional event A5 to be associated with conditional event A4. Such would enable the conditional reconfiguration 40-2 (originally a CPC configuration) to be re-used as a CPA configuration, i.e., so that conditional reconfiguration 40-2 can be re-used for both CPA and CPC. That is, after the communication device 12 detects fulfillment of the execution condition 42-1 and executes conditional reconfiguration 40-1 for CPC, the conditional reconfiguration 40-2 that was not executed for CPC is updated based on the information 46-1 so as to convert that conditional reconfiguration 40-2 being a candidate for CPA.

Likewise, the information 46-2 in conditional reconfiguration 40-2 may be information about how to, upon execution of the conditional reconfiguration 40-2, update the execution condition 42-1 of conditional reconfiguration 40-1 in order to change that conditional reconfiguration 40-1 into a CPA configuration. The information 46-2 may for instance be information about how to update the execution condition 42-1 of conditional reconfiguration 40-1 from being associated with conditional event A3 or conditional event A5 to be associated with conditional event A4. This would similarly enable the conditional reconfiguration 40-1 (originally a CPC configuration) to be re-used as a CPA configuration, i.e., so that conditional reconfiguration 40-1 can be re-used for both CPA and CPC. That is, after the communication device 12 detects fulfillment of the execution condition 42-2 and executes conditional reconfiguration 40-2 for CPC, the conditional reconfiguration 40-1 that was not executed for CPC is updated based on the information 46-2 so as to convert that conditional reconfiguration 40-1 being a candidate for CPA.

In other embodiments, the information 46-1 . . . 46-N included in each of the at least one of the conditional reconfigurations 40-1 . . . 40-N in FIG. 8 is information about how to, upon execution of the conditional reconfiguration 44-1 . . . 44-N, add a new execution condition (not shown) to each of one or more others of the conditional reconfiguration 44-1 . . . 44-N. Such information 46-1 . . . 46-N included in each of the at least one of the conditional reconfigurations 40-1 . . . 40-N may be included in the conditional reconfiguration 40 outside of the target candidate configuration 44 of the conditional reconfiguration 40. In embodiments where the target candidate cells are candidate PSCells, the information 46-1 . . . 46-N included in each of the at least one of the conditional reconfigurations 40-1 . . . 40-N may be information about how to, upon execution of the conditional reconfiguration 40-1 . . . 40-N, add a new execution condition to each of one or more others of the conditional reconfigurations 40-1 . . . 40-N in order to configure the other conditional reconfiguration to be re-used as a CPC configuration (if originally a CPA configuration) or as a CPA configuration (if originally a CPC configuration). The information about how to add a new execution condition may for instance include the new execution condition that is to be added.

FIG. 9B for instance shows a simple example for two conditional reconfigurations 40-1 and 40-2. Conditional reconfiguration 40-1 as received includes execution condition 42-1, referred to as first execution condition 42-1, whereas conditional reconfiguration 40-2 as received includes execution condition 42-2, referred to as first execution condition 42-2. As such, the original execution conditions 42-1, 42-2 included in the conditional reconfigurations 40-1, 40-2 as received are referred to as first execution conditions 42-1, 42-2. In this example, conditional reconfiguration 40-1 includes information 46-1 about how to, upon execution of the conditional reconfiguration 40-1, add a second execution condition 43-2 to conditional reconfiguration 40-2. Likewise, in some embodiments, conditional reconfiguration 40-2 includes information 46-2 about how to, upon execution of the conditional reconfiguration 40-2, add a second execution condition 43-1 to conditional reconfiguration 40-1. The second execution conditions 43-1, 43-2 to be added to the conditional reconfigurations 40-1, 40-2 are therefore new execution conditions, in the sense that they are newly added since reception of the conditional reconfigurations 40-1, 40-2.

In some embodiments, for instance, the conditional reconfigurations 40-1 and 40-2 as received by the communication device 12 are CPA configurations. This may be the case for example where the communication device 12 receives the conditional reconfigurations 40-1 and 40-2 when the communication device 12 is not configured with any serving PSCell configuration or any SCG. Regardless, in this case, the information 46-1 in conditional reconfiguration 40-1 may be information about how to, upon execution of the conditional reconfiguration 40-1, add the second execution condition 43-2 to conditional reconfiguration 40-2 in order to configure that conditional reconfiguration 40-2 to be re-used as a CPC configuration, e.g., that is based on the PSCell target candidate cell of the conditional configuration 40-1 being a serving PSCell for the communication device 12. In some embodiments, for example, the first execution condition 42-2 of conditional reconfiguration 40-2 may be associated with conditional event A4 (which is usable for CPA, not CPC), but the second execution condition 43-2 of conditional reconfiguration 40-2 may be associated with conditional event A3 or conditional event A5 (which is usable for CPC, not CPA). The addition of the second execution condition 43-2 thereby enables the conditional reconfiguration 40-2 (originally a CPA configuration) to be re-used as a CPC configuration. That is, after the communication device 12 detects fulfillment of the first execution condition 42-1 of conditional reconfiguration 40-1 and executes conditional reconfiguration 40-1 for CPA, the communication device 12 uses the information 46-1 included in the conditional reconfiguration 40-1 that was executed for CPA in order to add the second execution condition 43-2 to the conditional reconfiguration 40-2 that was not executed for CPA. This enables the conditional reconfiguration 40-2 that was not executed for CPA to be re-used for CPC, so that conditional reconfiguration 40-2 becomes a candidate for CPC.

Likewise, the information 46-2 in conditional reconfiguration 40-2 may be information about how to, upon execution of the conditional reconfiguration 40-2, add second execution condition 43-1 to conditional reconfiguration 40-1 in order to configure that conditional reconfiguration 40-1 to be re-used as a CPC configuration, e.g., that is based on the PSCell target candidate cell of the conditional configuration 40-2 being a serving PSCell for the communication device 12. In some embodiments, for example, the first execution condition 42-1 of conditional reconfiguration 40-1 may be associated with conditional event A4 (which is usable for CPA, not CPC), but the second execution condition 43-1 of conditional reconfiguration 40-1 may be associated with conditional event A3 or conditional event A5 (which is usable for CPC, not CPA). The addition of the second execution condition 43-1 thereby enables the conditional reconfiguration 40-1 (originally a CPA configuration) to be re-used as a CPC configuration. That is, after the communication device 12 detects fulfillment of the first execution condition 42-2 of conditional reconfiguration 40-2 and executes conditional reconfiguration 40-2 for CPA, the communication device 12 uses the information 46-2 included in the conditional reconfiguration 40-2 that was executed for CPA in order to add the second execution condition 43-1 to the conditional reconfiguration 40-1 that was not executed for CPA. This enables the conditional reconfiguration 40-1 that was not executed for CPA to be re-used for CPC, so that conditional reconfiguration 40-1 becomes a candidate for CPC.

In the above examples, the conditional events A3, A4, and A5 may be described as follows.

CondEvent A3: Conditional reconfiguration candidate becomes amount of offset better than PCell/PSCell.

CondEvent A4: Conditional reconfiguration candidate becomes better than absolute threshold.

CondEvent A5: PCell/PSCell becomes worse than absolute threshold1 AND Conditional reconfiguration candidate becomes better than another absolute threshold2.

Consider now some embodiments herein as applicable in the following context where the communication device 12 is exemplified as a UE and where the communication network 10 is exemplified as a 5G network.

### 3GPP Dual Connectivity

Some embodiments herein are applicable to Dual Connectivity. In 3GPP Rel-12, the Long Term Evolution (LTE) feature Dual Connectivity (DC) was introduced to enable the UE to be connected in two cell groups, each controlled by an LTE access node (eNBs), labelled as the Master eNB (MeNB) and the Secondary eNB (SeNB). The UE still only has one RRC connection with the network. In 3GPP, the Dual Connectivity (DC) solution has since then evolved and is now also specified for New Radio (NR) as well as between LTE and NR. Multi-connectivity (MC) is the case when there are more than 2 nodes involved. With the introduction of 5G, the term MR-DC (Multi-Radio Dual Connectivity, see also 3GPP TS 37.340 V17.3.0) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

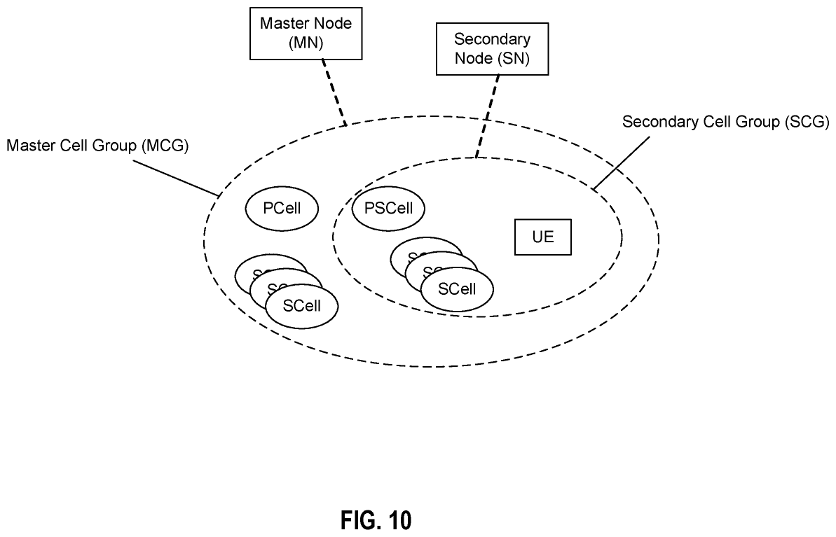

Further, in MR-DC, when dual connectivity is configured for the UE, within each of the two cell groups, MCG and SCG, carrier aggregation may be used as well. In this case, within the Master Cell Group, MCG, controlled by the master node (MN), the UE may use one PCell and one or more SCell(s). And within the Secondary Cell Group (SCG) controlled by the secondary node (SN), the UE may use one Primary SCell (PSCell, also known as the primary SCG cell in NR) and one or more SCell(s). This combined case is illustrated in FIG. 10. In NR, the primary cell of a master or secondary cell group is sometimes also referred to as the Special Cell (SpCell). Hence, the SpCell in the MCG is the PCell and the SpCell in the SCG is the PSCell.

Some embodiments herein are applicable in any number of different ways to deploy a 5G network with or without interworking with LTE (also referred to as E-UTRA) and evolved packet core (EPC). In principle, NR and LTE can be deployed without any interworking, denoted by NR stand-alone (SA) operation, also known as Option 2; that is gNB in NR can be connected to 5G core network (5GC) and eNB in LTE can be connected to Evolved Packet Core (EPC) with no interconnection between the two, also known as Option 1.

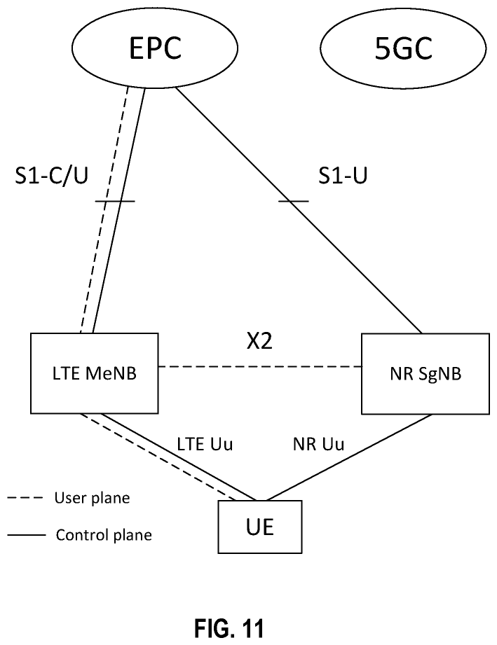

On the other hand, the first supported version of NR uses dual connectivity, denoted as EN-DC (E-UTRAN-NR Dual Connectivity), also known as Option 3, as depicted in FIG. 11. In such a deployment, dual connectivity between NR and LTE is applied, where the UE is connected with both the LTE radio interface (LTE Uu in the figure) to an LTE access node and the NR radio interface (NR Uu in the figure) to an NR access node. Further, in EN-DC, the LTE access node acts as the master node (in this case known as the Master eNB, MeNB), controlling the master cell group (MCG), and the NR access node acts as the secondary node (in this case sometimes also known as the Secondary gNB (SgNB)), controlling the secondary cell group (SCG). The SgNB may not have a control plane connection to the core network (EPC) which instead is provided MeNB and, in this case, the NR. This is also called a “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells.

Some embodiments herein are also applicable to other options that are valid with the introduction of 5GC. As mentioned above, Option 2 supports stand-alone NR deployment where gNB is connected to 5GC. Similarly, LTE can also be connected to 5GC using Option 5 (also known as eLTE, E-UTRA/5GC, or LTE/5GC, and the node can be referred to as an ng-eNB). In these cases, both NR and LTE are seen as part of the NG-RAN (and both the ng-eNB and the gNB can be referred to as NG-RAN nodes).

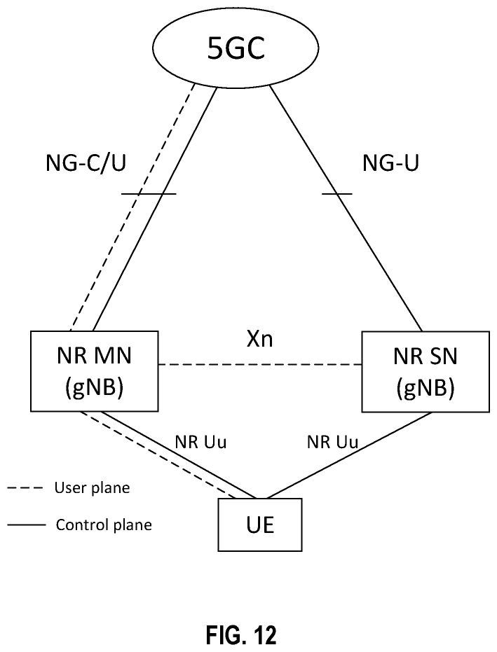

Some embodiments herein are also applicable to other variants of dual connectivity between LTE and NR which have been standardized as part of NG-RAN connected to 5GC. Under the MR-DC umbrella, this includes: (i) EN-DC (Option 3) where LTE is the master node and NR is the secondary node (EPC core network (CN) employed, as depicted in FIG. 11); (ii) NE-DC (Option 4) where NR is the master node and LTE is the secondary (5GCN employed); (iii) NGEN-DC (Option 7) where LTE is the master node and NR is the secondary (5GCN employed); and/or (iv) NR-DC (variant of Option 2) which involves dual connectivity where both the master node, MN, controlling the MCG, and the secondary node, SN, controlling the SCG, are NR (5GCN employed, as depicted in FIG. 12). In particular, FIG. 12 shows a scenario where the master node, MN, controlling the MCG is a gNB connected to the 5GC and serving the UE via NR, and also the secondary node, SN, controlling the SCG is a gNB connected to the 5GC and serving the UE via NR.

### Conditional Handover (CHO)

Some embodiments have their roots based on conditional handover as specified by 3GPP. In 3GPP Rel-16, the conditional handover was standardized as a solution to increase the robustness at handover. In order to avoid the undesired dependence on the serving radio link upon the time (and radio conditions) where the UE should execute the handover, the possibility to provide radio resource control (RRC) signaling for the handover to the UE earlier was standardized. It is possible to associate the HO command with a condition, e.g., based on radio conditions possibly similar to the ones associated to an A3 event, where a given neighbour becomes X db better than target. As soon as the condition is fulfilled, the UE executes the handover in accordance with the provided handover command.

Such a condition could e.g., be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo (or the RRCReconfiguration with reconfigurationWithSync) at a time when the radio link between the source cell and the UE is still stable. The execution of the handover is done at a later point in time (and threshold), which is considered optimal for the handover execution.

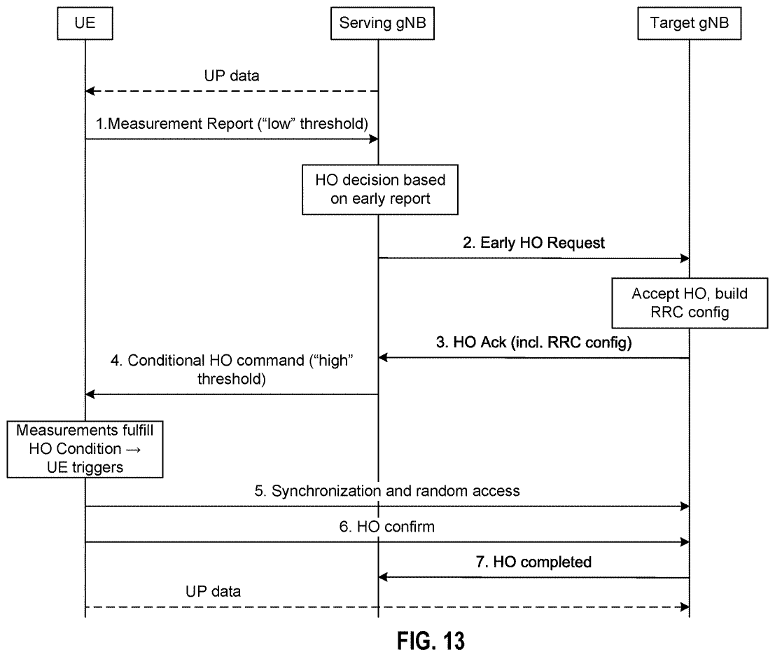

FIG. 13 depicts an example with just a UE, a serving and a target cell. More particularly, in FIG. 13, the serving gNB may exchange user plane (UP) data with the UE. In step 1, the UE sends a measurement report with a “low” threshold to the serving gNB. The serving gNB makes a handover (HO) decision based on this early report. In step 2, the serving gNB sends an early HO request to a target gNB. The target gNB accepts the HO request and builds an RRC configuration. The target gNB returns a HO acknowledgement, including the RRC configuration, to the serving gNB in step 3. In step 4, a conditional HO command with a “high” threshold is sent to the

UE. Subsequently, measurements by the UE may fulfil the HO condition of the conditional HO command. The UE thus triggers the pending conditional handover. The UE performs synchronization and random access with the target gNB in step 5, and HO confirm is exchanged in step 6. In step 7, the target gNB informs the serving gNB that HO is completed. The target gNB may then exchange user plane (UP) data with the UE.

In practice there may often be many cells or beams that the UE reported as possible candidates based on its preceding RRM measurements. The network should then have the freedom to issue conditional handover commands for several of those candidates. The RRCConnectionReconfiguration/RRCReconfiguration message for each of those candidates may differ not just concerning the target cell but also, e.g., in terms of the HO execution condition (RS to measure and threshold to exceed) as well as in terms of the RA preamble to be sent when a condition is met.

While the UE evaluates the condition, it continues operating per its current RRC configuration, i.e., without applying the conditional HO command. When the UE determines that the condition is fulfilled, it disconnects from the serving cell, applies the conditional HO command, and connects to the target cell. These steps are equivalent to the legacy handover execution.

When the UE has successfully performed the random access procedure towards the target cell during a conditional handover or a normal handover, it then releases all the conditional reconfigurations that it has stored. The target cell may then configure new conditional reconfigurations to the UE if it is considered useful.

### Conditional PSCell Change (CPC) in 3GPP Rel-16

Some embodiments herein are applicable for a Conditional PSCell Change (CPC) procedure, e.g., as standardized in Rel-16. Therein a UE operating in Multi-Radio Dual Connectivity (MR-DC) receives in a conditional reconfiguration one or multiple RRC Reconfiguration(s) (e.g., an RRCReconfiguration message) containing an SCG configuration (e.g., a secondaryCellGroup of IE CellGroupConfig) with a reconfigurationWithSync that is stored and associated with an execution condition (e.g., a condition like an A3/A5 event configuration), so that one of the stored messages is only applied upon the fulfillment of the execution condition, e.g., associated with the serving PSCell, upon which the UE would perform PSCell change (in case it finds a neighbour cell that is better than the current SpCell of the SCG). Only intra-SN CPC without MN involvement is standardized in 3GPP Rel-16, i.e., for cases where the (candidate) target PSCells are located in the current serving SN. Similar to conditional handover, in case a random access was performed for a target PSCell and the UE was configured with CPC, the UE then releases all the conditional reconfigurations that it has stored.

### CPA and Inter-SN CPC in 3GPP Rel-17

Some embodiments herein are applicable for Conditional PSCell Addition (CPA) and inter-SN CPC, e.g., according to 3GPP Rel-17. The CPA procedure is used for adding a PSCell/SCG to the configuration for a UE that is currently only configured with an MCG, when associated execution conditions are fulfilled. CPA is initiated by the MN by requesting an SCG configuration, which is to be provided as part of a conditional reconfiguration to the UE, from a (candidate) target SN (T-SN), and then sending it in a conditional reconfiguration to the UE together with the associated execution conditions.

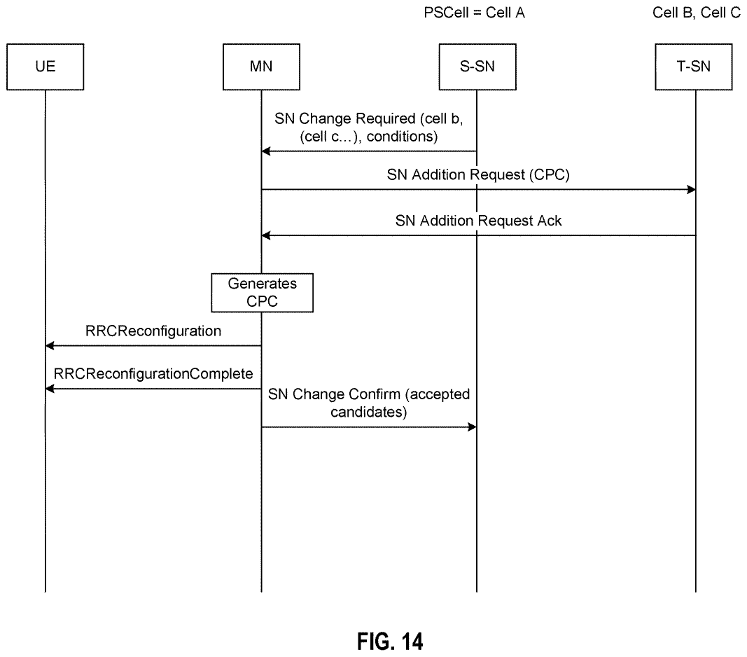

The inter-SN CPC can be initiated either by the MN or by the source SN (S-SN), where the signalling towards the source SN and the (candidate) target SNs, as well as towards the UE, in both cases is handled by the MN. One of the possible signalling sequences for configuration of an inter-SN CPC, which is initiated by the source SN, can be seen in the signaling flow in FIG. 14.

Also, for Rel-17 Conditional PSCell change (CPC)/Conditional PSCell addition (CPA), it can be expected that the UE configured with CPC/CPA has to release the CPC/CPA configurations when completing random access towards the target PSCell.

### Conditional (Re)Configurations

In some embodiments, the conditional configurations, or rather reconfigurations, are configured to the UE as a configuration, e.g., an RRC Reconfiguration message, that is to be applied only when the associated execution/triggering conditions are fulfilled.

The UE is provided with such a conditional reconfiguration through an RRC Reconfiguration message that includes the IEs for the conditional reconfiguration. In some embodiments, the IEs to configure conditional reconfiguration is as otherwise specified in TS 38.331 V17.3.0 (Rel-17A conditional reconfiguration is added or modified by inclusion of the corresponding CondReconfig ToAddMod-r16 instance in condReconfig ToAddModList-r16 within ConditionalReconfiguration IE. For each conditional reconfiguration, the configuration to be applied towards the target cell, when the execution conditions are fulfilled, is included in condRRCReconfig-r16 (i.e. as an RRC Reconfiguration message, e.g. RRCReconfiguration) within CondReconfig ToAddMod-r16. The associated execution conditions are included either in condExecutionCond-r16 or in condExecutionCondSCG-r17 in CondReconfig ToAddMod-r16, depending on the type of conditional reconfiguration.

The conditional reconfiguration 20 herein in FIG. 2 in this case may be exemplified by a CondReconfig ToAddMod-r16 instance in condReconfig ToAddModList-r16 within ConditionalReconfiguration IE.

### Conditional Events

More particularly, each execution condition (as configured through condExecutionCond or condExecutionCondSCG) consists of one or two MeasId(s), where the MeasId is associated to a measObjectId and to a reportConfigId. The reportConfigId is then, in turn, associated to a reporting configuration (a ReportConfigToAddMod instance) that is configured as a conditional event, i.e., it includes a ReportConfigNR with a conditional event. This can be seen in TS 38.331 V17.3.0:

For some of the events that are defined to trigger a measurement report, there is thus a corresponding conditional event defined, which is to be used in order to determine that an execution condition is fulfilled, such as the conditional events A3, A4 and A5 (configured as condEventA3, condEventA4 and condEventA5, respectively). The conditional events condEventA3, condEventA4 and condEventA5 are considered as satisfied/fulfilled based on the same procedure as for the normal events for A3, A4 and A5. The conditional event A3 is thus satisfied/fulfilled when the conditional reconfiguration candidate becomes an amount of offset better than the serving PCell/PSCell, the conditional event A4 is satisfied/fulfilled when the conditional reconfiguration candidate becomes better than an absolute threshold, and the conditional event A5 is satisfied/fulfilled when the serving PCell/PSCell becomes worse than one absolute threshold AND the conditional reconfiguration candidate becomes better than another absolute threshold.

NR-DC with Selective Activation of the Cell Groups (at Least for SCG) Via L3 Enhancements in 3GPP Rel-18

Some embodiments herein are applicable for enhancements for different mobility procedures, e.g., as specified in RP-213565, New WI: Further NR mobility enhancements, MediaTek, 3GPP TSG RAN Meeting #94e, Dec. 6-17, 2021. Some embodiments in this regard facilitate mechanisms and procedures of NR-DC with selective activation of the cell groups (at least for SCG) via L3 enhancements, to allow subsequent cell group change after changing CG without reconfiguration and re-initiation of CPC/CPA.

Some embodiments accordingly enable a UE to perform a subsequent cell group change after a first cell group change, without reconfiguring or re-initiation Conditional PSCell Change (CPC) or Conditional PSCell Addition (CPA). This would then be done in order to reduce the interruption time and the signalling overhead for SCG changes, especially in the case of frequent SCG changes when operating in FR2 in NR, compared to when these configurations are released when the UE completes random access towards the target PSCell, as in the previous releases.

Some embodiments accordingly enable a CPA conditional configuration to used for CPC (but with different triggering conditions). A CPA configuration, or at least the condRRCReconfig (i.e., as an RRC Reconfiguration message, e.g., RRCReconfiguration) within CondReconfig ToAddMod for the CPA configuration would then be used for CPC, but that there then would be different triggering/execution conditions for CPA and CPC.

Some embodiments herein in particular enable achievement of a Conditional PSCell Addition (CPA) configuration that can be used for Conditional PSCell Change (CPC) with different triggering/execution conditions. A CPA configuration is configured as a CondReconfigToAddMod instance that includes a candidate target cell configuration (in condRRCReconfig) and execution condition in condExecutionCond, where the execution condition is associated to conditional event A4 (condEventA4).

Some embodiments overcome a number of challenges to achieving this. One challenge is that the A4 event that is used for CPA only includes a check if the candidate target PSCell is good enough, i.e., that it becomes better than an absolute threshold. This makes sense since the UE is then not configured with any serving PSCell. A CPC configuration, which is used when the UE is already configured with a PSCell, should however compare the candidate target PSCell with the serving PSCell, e.g., so that a PSCell change is not triggered when the current serving PSCell is still good and perhaps even better than the candidate target PSCell. The conditional A4 event is therefore not heretofore useful for CPC. This is especially true in case of intra-frequency candidate target cells where mobility to such a neighbour PSCell may lead to increased interference and worse performance, in case it is worse than the current serving PSCell or if the current serving PSCell is still in good coverage. For CPC, execution conditions associated to conditional events A3 and A5 (condEventA3 and condEventA5) should therefore be used.

Another challenge is that CPA is configured by the MN, including a target cell configuration (in condRRCReconfig) generated by the candidate target SN. It is then the MN that sets the execution condition for execution of the CPA configuration (adding the PSCell). For CPC it can however either be the MN or the SN that sets the execution condition. When the SN triggers the CPC configurations and sets the execution conditions for those it is in control of the SCG mobility. Intra-SN CPC is only configured by the SN and there is then no MN involvement in the generation of the configuration. Some embodiments herein notably allow a CPA configuration to be used for CPC with a different triggering/execution condition, where only the MN can set the execution condition for CPC.

Some embodiments enable a UE to reuse the same conditional reconfiguration with a PSCell target candidate cell for both CPA and for CPC, where the configuration is considered to be a CPA configuration when the UE is not configured with a serving PSCell/SCG configuration and to be a CPC configuration when the UE is configured with a serving PSCell/SCG configuration, and using different triggering/execution conditions for CPA and for CPC.

In one alternative, the UE conditional reconfiguration includes an execution condition that corresponds to event A5 (conditional event A5, i.e., CondEvent A5) and the UE is currently not configured with any serving PSCell, i.e., the UE considers the conditional reconfiguration with a candidate target PSCell to correspond to a CPA configuration. The UE then considers conditions for the event to be satisfied by only taking aspects or measurements related to the neighbour cell (i.e., the candidate target PSCell of the conditional reconfiguration) into account. In other words, the UE does not consider aspects or measurements related to the SpCell (i.e., a serving PSCell) into account when considering if the conditions for the event are satisfied. In one alternative, a similar solution is used for the case where the conditional reconfiguration includes an execution condition that corresponds to event A3 (conditional event A3, i.e., CondEvent A3). In that case, the UE evaluates the condition for CPA by using a separate configuration of a threshold value, which then is used when checking whether the candidate target PSCell is good enough for the CPA configuration to be applied and executed.

Some embodiments also include methods where new events, which are useful for both CPA and CPC, are introduced and where the evaluation of the conditions is done in a manner that depends on if it is done for CPC or for CPA, i.e., whether the UE is currently configured with a serving PSCell/SCG or not.

Methods are also included where the configuration includes multiple reporting configurations for the same execution condition, and the UE uses the reporting configuration relevant for CPA in case of evaluation for CPA and the reporting configuration relevant for CPC in case of evaluation for CPC. In one option, the two measIds that are part of the same execution condition are divided into one for CPA (with conditional event A4) and one for CPC (with conditional event A3 or A5).

In some embodiments, the UE gets an update of the other stored CPA configurations when applying one CPA configuration, so that the execution conditions of those CPA/CPC configurations then are changed to be relevant for CPC (e.g., conditional events A3 or A5). It is then also included that the UE can get an update of the execution conditions for the CPA/CPC configurations that are stored when the PSCell/SCG is released, i.e., so they then are changed to be relevant for CPA (e.g., conditional event A4).

Embodiments herein also include corresponding methods for the network configuration.

Some embodiments advantageously allow a UE to be configured with a single conditional reconfiguration, including alternatives with a single execution condition, that is useful for both CPA (when the UE is not configured with any serving PSCell) and for CPC (when the UE is configured with a serving PSCell). Some embodiments allow that the execution condition then takes into account the radio strength and/or quality for only the candidate target PSCell in case of CPA and for both the serving PSCell and the candidate target PSCell in case of CPC.

Certain embodiments may provide one or more of the following technical advantage(s). Some embodiments enable that a UE can be configured with a single conditional reconfiguration (including that the UE is configured with a single execution condition) that can be used both as a CPA configuration and a CPC configuration where the radio strength and/or quality for the serving PSCell is taken into account only when determining whether to trigger the CPC execution.

Consider now various embodiments herein.

Evaluation of (Conditional) Event A5 without Taking Serving SpCell Aspects into Account

One alternative to have a conditional reconfiguration (CondReconfigToAddMod) with two separate triggering/execution conditions depending on if the configuration is to be used for CPA or CPC is to include two separate execution conditions, e.g., the existing condExecutionCond and an additional conditional reconfiguration that is also set by the MN, in CondReconfigToAddMod where one would be used in case of CPA and one in case of CPC.

Other embodiments however avoid a need for additional measurement configurations and measurement configurations identities (MeasIds) for the same conditional reconfiguration. Indeed, the different execution conditions would need to be configured with different measurement configurations identities in order to associate them to different conditional events, e.g., CondEvent A4 for CPA and CondEvent A3 or A5 for CPC. These other embodiments, then, avoid the need for configuration of multiple measurement configurations, and the corresponding need for additional measurement configuration identities (MeasIds), in order to achieve different triggering conditions for the conditional reconfiguration depending on if it is used CPA or CPC.

These embodiments that exploit a single execution condition field 26 are exemplified herein with Embodiments A3-A19 in GROUP A EMBODIMENTS HEREIN, and with respect to FIGS. 3-6.

A first set of embodiments includes methods for a User Equipment (UE) for performing evaluation of at least one conditional reconfiguration with a PSCell target candidate cell.

The method comprises the UE receiving a message (e.g., RRCReconfiguration) including a conditional reconfiguration with a PSCell target candidate cell (with an execution condition and a SCG/PSCell target candidate configuration). The conditional reconfiguration with a PSCell target candidate cell corresponds to either a Conditional PSCell Addition (CPA) configuration or a Conditional PSCell Change (CPC) configuration. For example, the conditional reconfiguration corresponds to a Conditional PSCell Addition (CPA) configuration when the UE is not configured with a serving PSCell/SCG configuration, but corresponds to a Conditional PSCell Change (CPC) configuration when the UE is configured with a serving PSCell/SCG configuration.

The method further comprises the UE performing the evaluation of the execution condition according to whether the conditional reconfiguration corresponds to a Conditional PSCell Addition (CPA) configuration or to a Conditional PSCell Change (CPC) configuration, i.e., whether the UE is configured with a serving PSCell or not.

In some embodiments where the execution condition corresponds/is associated to event A5 (conditional event A5, i.e., CondEvent A5) and the UE is not configured with any serving PSCell, i.e., the method may comprise the UE considering the conditional reconfiguration with a candidate target PSCell to correspond to a CPA configuration, wherein the UE considers conditions for the event to be satisfied by only taking aspects or measurements related to the neighbour cell (i.e., the candidate target PSCell of the conditional reconfiguration) into account. In other words, the UE does not consider aspects or measurements related to the SpCell (i.e., a serving PSCell) into account when considering if the conditions for the event are satisfied.

As an alternative, when checking if the entering condition for conditional event A5 (CondEvent A5) is fulfilled for a CPA configuration, i.e., a conditional reconfiguration with a candidate target PSCell configuration and the UE is not configured with a serving PSCell, the UE only considers whether the measurement result of the candidate target PSCell is above the configured threshold (taking hysteresis parameter and offset values, if any, into account).

Below is an example implementation for TS 38.331, V17.3.0 (Rel-17), with additions underlined:

5.5.4.6 Event A5 (SpCell Becomes Worse than Threshold1 and Neighbour Becomes Better than Threshold2)

The UE shall:
1> if the event is a CondEvent A5 that is associated to a Conditional PSCell Addition (CPA) configuration, i.e. where the UE is not configured with a serving PSCell:
   2> consider the entering condition for this event to be satisfied when condition A5-2, as specified below, is fulfilled;
1> else consider the entering condition for this event to be satisfied when both condition A5-1 and condition A5-2, as specified below, are fulfilled;
1> if the event is a CondEvent A5 that is associated to a Conditional PSCell Addition (CPA) configuration, i.e. where the UE is not configured with a serving PSCell:
   2> consider the leaving condition for this event to be satisfied when condition A5-4 as specified below, is fulfilled;
1> else consider the leaving condition for this event to be satisfied when condition A5-3 or condition A5-4, i.e. at least one of the two, as specified below, is fulfilled;
1> use the SpCell for Mp.
NOTE 1: The parameters of the reference signal(s) of the cell(s) that triggers the event are indicated in the measObjectNR associated to the event which may be different from the measObjectNR of the NR SpCell.

### Inequality A5-1 (Entering Condition 1)

$$Mp + Hys < Thresh 1$$

### Inequality A5-2 (Entering Condition 2)

$$Mn + Ofn + Ocn - Hys > Thresh 2$$

### Inequality A5-3 (Leaving Condition 1)

$$Mp - Hys > Thresh 1$$

### Inequality A5-4 (Leaving Condition 2)

$$Mn + Ofn + Ocn + Hys < Thresh 2$$

The variables in the formula are defined as follows:
Mp is the measurement result of the NR SpCell, not taking into account any offsets.
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold1 as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.
NOTE 2: The definition of Event A5 also applies to CondEvent A5.

The method in some embodiments also comprises that the UE preserves the conditional reconfiguration with a candidate target PSCell after a PSCell addition procedure, where the same conditional configuration (including the same execution condition that corresponds to/is associated to conditional event A5) is considered to correspond to a CPC configuration after completion of the PSCell addition procedure. The UE then considers conditions for the (conditional) event A5 to be satisfied by taking both aspects or measurements related to the neighbour cell (i.e., the candidate target PSCell of the conditional reconfiguration) and aspects or measurements related to the SpCell (i.e., the serving PSCell) into account when considering if the conditions for the event are satisfied.

Evaluation of (Conditional) Event A3 without Taking Serving SpCell Aspects into Account

In one alternative, a method herein comprises that the execution condition corresponds/is associated to event A3 (conditional event A3, i.e., CondEvent A3) and the UE is not configured with any serving PSCell, i.e., the UE considers the conditional reconfiguration with a candidate target PSCell to correspond to a CPA configuration. In this case, the UE considers conditions for the event to be satisfied by only taking aspects or measurements related to the neighbour cell (i.e., the candidate target PSCell of the conditional reconfiguration) into account. In other words, the UE does not consider aspects or measurements related to the SpCell (i.e., a serving PSCell) into account when considering if the conditions for the event are satisfied. In one alternative, the UE then receives an additional configuration for the threshold (e.g., a cpa-threshold parameter) that the candidate target PSCell measurement should fulfill, similar to the a4-Threshold-r17 that is part of condEventA4-r17. This additional threshold is received outside the condEventA3 configuration, but it is used as part of the procedure to evaluate if the conditional event A3 is fulfilled/satisfied.

In one example, the additional threshold (e.g., cpa-threshold) is included within CondReconfig ToAddMod. In another example, it is included within CondTriggerConfig.

Below is an example implementation for TS 38.331, V17.3.0 (Rel-17), with additions underlined:

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
    },
    ...,
```

| | |
|---|---|
| condEventA4-r17 | SEQUENCE { |
| a4-Threshold-r17 | MeasTriggerQuantity, |
| hysteresis-r17 | Hysteresis, |
| timeToTrigger-r17 | TimeToTrigger |
| }, | |
| condEventD1-r17 | SEQUENCE { |

```
      distanceThreshFromReference1-r17 INTEGER(0.. 65525),
      distanceThreshFromReference2-r17 INTEGER(0.. 65525),
```

| | |
|---|---|
| referenceLocation1-r17 | ReferenceLocation-r17, |
| referenceLocation2-r17 | ReferenceLocation-r17, |
| hysteresisLocation-r17 | HysteresisLocation-r17, |
| timeToTrigger-r17 | TimeToTrigger |

},

| | |
|---|---|
| condEventT1-r17 | SEQUENCE { |
| t1-Threshold-r17 | INTEGER (0..549755813887), |
| duration-r17 | INTEGER (1..6000) |

```
    }
  },
```

| | |
|---|---|
| rsType-r16 | NR-RS-Type, |

```
  ...,
    cpa-Threshold-r18 MeasTriggerQuantity
}
```

5.5.4.4 Event A3 (Neighbour Becomes Offset Better than SpCell)

The UE shall:
1> if the event is a CondEvent A3 that is associated to a Conditional PSCell Addition (CPA) configuration, i.e. where the UE is not configured with a serving PSCell:
   2> consider the entering condition for this event to be satisfied when condition A3-3, as specified below, is fulfilled;
1> else consider the entering condition for this event to be satisfied when condition A3-1, as specified below, is fulfilled;
1> if the event is a CondEvent A3 that is associated to a Conditional PSCell Addition (CPA) configuration, i.e. where the UE is not configured with a serving PSCell:
   2> consider the leaving condition for this event to be satisfied when condition A3-4 as specified below, is fulfilled;
1> else consider the leaving condition for this event to be satisfied when condition A3-2, as specified below, is fulfilled;
1> use the SpCell for Mp, Ofp and Ocp.
NOTE 1: The cell(s) that triggers the event has reference signals indicated in the measObjectNR associated to this event which may be different from the NR SpCell measObjectNR.

### Inequality A3-1 (Entering Condition)

$$Mn + Ofn + Ocn - Hys > Mp + Ofp + Ocp + Off$$

### Inequality A3-2 (Leaving Condition)

$$Mn + Ofn + Ocn - Hys < Mp + Ofp + Ocp + Off$$

### Inequality A3-3 (Entering Condition)

$$Mn + Ofn + Ocn - Hys > Cpa - thresh$$

### Inequality A3-4 (Leaving Condition)

$$Mn + Ofn + Ocn + Hys < Cpa - thresh$$

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Cpa-thresh is the threshold parameter for this event in case it is a CondEvent A3 that is associated to a Conditional PSCell Addition (CPA) configuration, i.e. where the UE is not configured with a serving PSCell (i.e. as defined by cpa-Threshold within CondTriggerConfig).
Mn, Mp are expressed in dBm in case of RSRP, or in dB in case of RSRQ and RS-SINR.
Ofn, Ocn, Ofp, Ocp, Hys, Off are expressed in dB.
Cpa-thresh is expressed in the same unit as Mn.
NOTE 2: The definition of Event A3 also applies to CondEvent A3.

In one alternative, the UE preserves the conditional reconfiguration with a candidate target PSCell after a PSCell addition procedure, where the same conditional configuration (including the same execution condition that corresponds to conditional event A3) is considered to correspond to a CPC configuration after completion of the PSCell addition procedure. The UE then considers conditions for the (conditional) event A3 to be satisfied by taking both aspects or measurements related to the neighbour cell (i.e., the candidate target PSCell of the conditional reconfiguration) and aspects or measurements related to the SpCell (i.e., the serving PSCell) into account when considering if the conditions for the event are satisfied.

One set of embodiments includes a method for a network node, e.g., a node acting as a Master Node (MN) for a UE, for configuring the UE with at least one conditional reconfiguration with a PSCell target candidate cell. According to this method, the network node sends a message (e.g., RRCReconfiguration) to the UE including a conditional reconfiguration with a PSCell target candidate cell (with an execution condition and a SCG/PSCell target candidate configuration). Here, the conditional reconfiguration with a PSCell target candidate cell corresponds to either a Conditional PSCell Addition (CPA) configuration or a Conditional PSCell Change (CPC) configuration.

In some embodiments, the execution condition is associated to a conditional event A3. In some embodiments, the message includes a new configuration for the threshold that the candidate target PSCell measurement should fulfill for the conditional event A3 to be fulfilled/satisfied, e.g., a cpa-threshold parameter. In one example, the new threshold parameter (e.g., cpa-threshold) is included within CondReconfigToAddMod. In another example, it is included within CondTriggerConfig.

In one example, the conditional reconfiguration with a PSCell target candidate cell corresponds to a Conditional PSCell Addition (CPA) configuration if/when the UE is not configured with any serving PSCell/SCG and it corresponds to a Conditional PSCell Change (CPC) configuration if/when the UE is configured with a serving PSCell/SCG.

Change of Evaluated Event if there is No SpCell (Serving PSCell) Configured

Embodiments herein also include a method for a User Equipment (UE) for performing evaluation of at least one conditional reconfiguration with a PSCell target candidate cell. According to this method, the UE receives a message (e.g., RRCReconfiguration) including a conditional reconfiguration with a PSCell target candidate cell (with an execution condition and a SCG/PSCell target candidate configuration). The conditional reconfiguration with a PSCell target candidate cell corresponds to either a Conditional PSCell Addition (CPA) configuration or a Conditional PSCell Change (CPC) configuration. The conditional reconfiguration corresponds to a Conditional PSCell Addition (CPA) configuration when the UE is not configured with a serving PSCell/SCG configuration. And the conditional reconfiguration corresponds to a Conditional PSCell Change (CPC) configuration when the UE is configured with a serving PSCell/SCG configuration.

According to the method, the UE determines the event to be evaluated for the execution condition depending on whether the conditional reconfiguration corresponds to a Conditional PSCell Addition (CPA) configuration or to a Conditional PSCell Change (CPC) configuration, i.e., whether the UE is configured with a serving PSCell or not.

In some embodiments, the execution conditions are configured corresponding to event A5 (conditional event A5, i.e., CondEvent A5) or event A3 (conditional event A3, i.e., CondEvent A3) and the UE is not configured with any serving PSCell, i.e., the UE considers the conditional reconfiguration with a candidate target PSCell to correspond to a CPA configuration. In one such embodiment, the UE evaluates event A4 (conditional event A4, i.e., CondEvent A4) instead of event A5 (conditional event A5, i.e., CondEvent A5) or event A3 (conditional event A3, i.e., CondEvent A3) for the execution conditions. In other words, the UE changes the evaluated event when it is configured with a CPA configuration, i.e., a conditional reconfiguration with a candidate target PSCell and there is no current SpCell (i.e., a serving PSCell) configured.

In one example, the UE determines to evaluate according to conditional event A4 even though the configuration consists of a conditional event A5 (condEventA5), based on that the associated conditional reconfiguration is for CPA, i.e., the configuration is for a candidate target PSCell and the UE is not configured with any serving PSCell/SCG configuration.

Below is an example implementation for TS 38.331, V17.3.0 (Rel-17), with additions underlined:

5.5.4.5 Event A4 (Neighbour Becomes Better than Threshold)

The UE shall:
1> consider the entering condition for this event to be satisfied when condition A4-1, as specified below, is fulfilled;
1> consider the leaving condition for this event to be satisfied when condition A4-2, as specified below, is fulfilled.

### Inequality A4-1 (Entering Condition)

$$Mn + Ofn + Ocn - Hys > Thresh$$

### Inequality A4-2 (Leaving Condition)

$$Mn + Ofn + Ocn + Hys < Thresh$$

The variables in the formula are defined as follows:
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the measurement object specific offset of the neighbour cell (i.e. cellIndividualOffset as defined within measObjectNR corresponding to the neighbour cell), and set to zero if not configured for the neighbour cell.
Hys is the hysteresis parameter for this event (i.e. hysteresis as defined within reportConfigNR for this event or as hysteresis defined within condEventA5 in reportConfigNR, in case the UE is configured with CondEvent A5 for a conditional reconfiguration with a candidate target PSCell that is associated to a Conditional PSCell Addition (CPA) configuration, i.e. where the UE is not configured with a serving PSCell).
Thresh is the threshold parameter for this event (i.e. a4-Threshold as defined within reportConfigNR for this event or as a5-Threshold2 defined within condEventA5 in reportConfigNR, in case the UE is configured with CondEvent A5 for a conditional reconfiguration with a candidate target PSCell that is associated to a Conditional PSCell Addition (CPA) configuration, i.e. where the UE is not configured with a serving PSCell).
Mn is expressed in dBm in case of RSRP, or in dB in case of RSRQ and RS-SINR.
Ofn, Ocn, Hys are expressed in dB.
Thresh is expressed in the same unit as Mn.
NOTE: The definition of Event A4 also applies to CondEvent A4.
NOTE 2: The definition of Event A4 also applies to CondEvent A5, in case the UE is configured with CondEvent A5 for a conditional reconfiguration with a candidate target PSCell that is associated to a Conditional PSCell Addition (CPA) configuration, i.e. where the UE is not configured with a serving PSCell.

### Introduction of New Conditional Events for CPA and CPC

Embodiments herein also include a method for a User Equipment (UE) for performing evaluation of at least one conditional reconfiguration with a PSCell target candidate cell. According to this method, the UE receives a message (e.g., RRCReconfiguration) including a conditional reconfiguration with a PSCell target candidate cell (with an execution condition and a SCG/PSCell target candidate configuration). The conditional reconfiguration with a PSCell target candidate cell corresponds to either a Conditional PSCell Addition (CPA) configuration or a Conditional PSCell Change (CPC) configuration. For example, the conditional reconfiguration corresponds to a Conditional PSCell Addition (CPA) configuration when the UE is not configured with a serving PSCell/SCG configuration, and the conditional reconfiguration corresponds to a Conditional PSCell Change (CPC) configuration when the UE is configured with a serving PSCell/SCG configuration.

According to the method, the UE performs the evaluation of the execution condition according to whether the conditional reconfiguration corresponds to a Conditional PSCell Change (CPC) configuration or to a Conditional PSCell Addition (CPA) configuration, i.e., whether the UE is configured with a serving PSCell or not.

In some embodiments, the method comprises that the execution condition corresponds to/is associated to at least one new event specific for CPA/CPC, i.e., that it can be used either for CPA or CPC depending on whether the UE is configured with a serving PSCell or not when evaluating the execution condition.

In one example there is a new event that corresponds to the conditional event A3 for CPC, here called for instance, conditional event A3-CPAC (i.e. CondEvent A3-CPAC). The conditional reconfiguration then includes the new event CondEvent A3-CPAC:

If the UE is configured with at least one serving PSCell (SpCell for the SCG), the UE considers the conditional reconfiguration with a candidate target PSCell to correspond to a CPC configuration. In this case, the UE considers conditions for the new event to be satisfied by taking into consideration both the measurement result of the SpCell (i.e. a serving PSCell) and the neighbour cells.

If the UE is not configured with any serving PSCell (SpCell for the SCG), the UE considers the conditional reconfiguration with a candidate target PSCell to correspond to a CPA configuration. In this case, the UE cannot take the aspects or measurements related to the SpCell (i.e. a serving PSCell) into account when considering if the conditions for the new event are satisfied, since no PSCell (SpCell for the SCG) exists. The UE then considers conditions for the new event to be satisfied by only considering aspects or measurements related to the neighbor cells (i.e., the candidate target PSCell of the conditional reconfiguration) into account, comparing with a threshold received in the event configuration.

In one example, there is a new event that corresponds to the conditional event A5 for CPC, here called for instance, conditional event A5-CPAC (i.e., CondEvent A5-CPAC). The conditional reconfiguration then includes the new event CondEvent A5-CPAC:

If the UE is configured with one/more serving PSCell/SpCell, the UE considers the conditional reconfiguration with a candidate target PSCell to correspond to a CPC configuration. In this case, the UE considers conditions for the new event to be satisfied by taking into consideration both the measurement result of the SpCell (i.e., a serving PSCell) and the neighbour cell, when comparing with the relevant thresholds.

If the UE is not configured with any serving PSCell, the UE considers the conditional reconfiguration with a candidate target PSCell to correspond to a CPA configuration. In this case, the UE considers conditions for the new event to be satisfied by only taking aspects or measurements related to the neighbour cell (i.e., the candidate target PSCell of the conditional reconfiguration) into account, comparing that with a threshold received in the event configuration. In other words, the UE does not consider aspects or measurements related to the SpCell (i.e., a serving PSCell) into account when considering if the conditions for the new event are satisfied.

Below is an example implementation of the ASN.1 and two new sections for procedural text for TS 38.331, V17.3.0 (Rel-17). The additions are underlined and the highlights in the procedures indicate the main changes compared to existing corresponding procedures:

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
    },
    ...,
```

| | |
|---|---|
| condEventA4-r17 | SEQUENCE { |
| a4-Threshold-r17 | MeasTriggerQuantity, |
| hysteresis-r17 | Hysteresis, |
| timeToTrigger-r17 | TimeToTrigger |

},

| | |
|---|---|
| condEventD1-r17 | SEQUENCE { |

```
      distanceThreshFromReference1-r17 INTEGER(0.. 65525),
      distanceThreshFromReference2-r17 INTEGER(0.. 65525),
```

| | |
|---|---|
| referenceLocation1-r17 | ReferenceLocation-r17, |
| referenceLocation2-r17 | ReferenceLocation-r17, |
| hysteresisLocation-r17 | HysteresisLocation-r17, |
| timeToTrigger-r17 | TimeToTrigger |

},

| | |
|---|---|
| condEventT1-r17 | SEQUENCE { |
| t1-Threshold-r17 | INTEGER (0..549755813887), |
| duration-r17 | INTEGER (1..6000) |

},

| | |
|---|---|
| condEventA3-CPAC-r18 | SEQUENCE { |
| a3-Offset-r18 | MeasTriggerQuantityOffset, |
| hysteresis-r18 | Hysteresis, |
| timeToTrigger-r18 | TimeToTrigger |
| a3-Threshold-CPA-r18 | MeasTriggerQuantity, |

},

| | |
|---|---|
| condEventA5-CPAC-r18 | SEQUENCE { |
| a5-Threshold1-r18 | MeasTriggerQuantity, |
| a5-Threshold2-r18 | MeasTriggerQuantity, |
| hysteresis-r18 | Hysteresis |
| timeToTrigger-r18 | TimeToTrigger |

```
    }
  },
```

| | |
|---|---|
| rsType-r16 | NR-RS-Type, |

...
}

5.5.4.x Event A3-CPAC (Neighbour Becomes Offset Better than SpCell (for CPC) or Better than a Threshold (for CPA))
The UE shall:
1> consider the entering condition for this event to be satisfied when condition A3-CPAC-1, as specified below, is fulfilled;
1> consider the leaving condition for this event to be satisfied when condition A3-CPAC-2, as specified below, is fulfilled;
1> use the SpCell for Mp, Ofp and Ocp.
NOTE 1: The cell(s) that triggers the event has reference signals indicated in the measObjectNR associated to this event which may be different from the NR SpCell measObjectNR.

### Inequality A3-CPAC-1 (Entering Condition)

If the event is a CondEvent A3-CPAC that is associated to a Conditional PSCell Change (CPC) configuration:

$$Mn + Ofn + Ocn - Hys > Mp + Ofp + Ocp + Off$$

Else, if the event is a CondEvent A3-CPAC that is associated to a Conditional PSCell Addition (CPA) configuration, i.e. where the UE is not configured with a serving PSCell:

$$Mn + Ofn + Ocn - Hys > Thresh - CPA$$

### Inequality A3-CPAC-2 (Leaving Condition)

If the event is a CondEvent A3-CPAC that is associated to a Conditional PSCell Change (CPC) configuration:

$$Mn + Ofn + Ocn - Hys < Mp + Ofp + Ocp + Off$$

Else, if the event is a CondEvent A3-CPAC that is associated to a Conditional PSCell Addition (CPA) configuration, i.e. where the UE is not configured with a serving PSCell:

$$Mn + Ofn + Ocn - Hys < Thresh - CPA$$

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Thresh-CPA is the threshold parameter for this event (i.e. a3-Threshold-CPA as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.
   5.5.4.Y Event A5-CPAC (CPC: SpCell Becomes Worse than Threshold1 and Neighbour Becomes Better than Threshold2; CPA: Neighbour Becomes Better than Threshold2)
   The UE shall:
1> if the event is a CondEvent A5-CPAC that is associated to a Conditional PSCell Addition (CPA) configuration, i.e. where the UE is not configured with a serving PSCell:
   2> consider the entering condition for this event to be satisfied when condition A5-CPAC-2, as specified below, is fulfilled;
1> else consider the entering condition for this event to be satisfied when both condition A5-CPAC-1 and condition A5-CPAC-2, as specified below, are fulfilled;
1> if the event is a CondEvent A5-CPAC that is associated to a Conditional PSCell Addition (CPA) configuration, i.e. where the UE is not configured with a serving PSCell:
   2> consider the leaving condition for this event to be satisfied when condition A5-CPAC-4 as specified below, is fulfilled;
1> consider the leaving condition for this event to be satisfied when condition A5-CPAC-3 or condition A5-CPAC-4, i.e. at least one of the two, as specified below, is fulfilled;
1> use the SpCell for Mp.
NOTE 1: The parameters of the reference signal(s) of the cell(s) that triggers the event are indicated in the measObjectNR associated to the event which may be different from the measObjectNR of the NR SpCell.

### Inequality A5-CPAC-1 (Entering Condition 1)

$$Mp + Hys < Thresh 1$$

### Inequality A5-CPAC-2 (Entering Condition 2)

$$Mn + Ofn + Ocn - Hys > Thresh 2$$

### Inequality A5-CPAC-3 (Leaving Condition 1)

$$Mp - Hys > Thresh 1$$

### Inequality A5-CPAC-4 (Leaving Condition 2)

$$Mn + Ofn + Ocn + Hys < Thresh 2$$

The variables in the formula are defined as follows:
Mp is the measurement result of the NR SpCell, not taking into account any offsets.
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold1 as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.

Further embodiments herein include a method for a network node, e.g., a node acting as a Master Node (MN) for a UE, for configuring the UE with at least one conditional reconfiguration with a PSCell target candidate cell. According to the method, the network node sends a message (e.g., RRCReconfiguration) to the UE including a conditional reconfiguration with a PSCell target candidate cell (with an execution condition and a SCG/PSCell target candidate configuration). The conditional reconfiguration with a PSCell target candidate cell corresponds to either a Conditional PSCell Addition (CPA) configuration or a Conditional PSCell Change (CPC) configuration. For example, the execution condition is associated to a new conditional event, e.g., CondEvent A3-CPAC or CondEvent A5-CPAC used for evaluation of either CPA (taking only the neighbour/candidate target cell into account) or CPC (taking both the neighbour/candidate target cell and the current serving cell into account).

In one example, the conditional reconfiguration with a PSCell target candidate cell corresponds to a Conditional PSCell Addition (CPA) configuration if/when the UE is not configured with any serving PSCell/SCG, and it corresponds to a Conditional PSCell Change (CPC) configuration if/when the UE is configured with a serving PSCell/SCG.

In one example, it is a node that is acting as, or that is a candidate to become, a Secondary Node (SN) for the UE that generates (or that provides input to) the configuration for the new conditional event.

In one set of embodiments, the UE is configured with an execution condition (e.g., MeasId) which points to a measurement configuration (e.g., to the IE MeasIdToAddMod) which is associated to a first and a second reporting configurations (e.g., a first ReportConfigNR IE, a second instance of the ReportConfigNR IE), wherein the first reporting configuration includes parameters for an event A3 (e.g., conditional event A3, i.e., CondEvent A3) or an event A5 (e.g., conditional event A5, i.e., CondEvent A5) and the second reporting configuration includes parameters for an event A4 (e.g., conditional event A4, i.e., CondEvent A4). Then, depending on whether the UE is evaluating the condition for CPA or CPC, the UE selects the first or the second reporting configuration.

In one embodiment, the UE receives an instance of the MeasIdToAddMod IE (or another equivalent IE) which includes a measId (same value which is configured in the execution condition for CPA or CPC), and the two reporting configurations, the first and the second, in the form of a first reporting configuration Id, and a second reporting configuration Id. In some embodiments, when the UE needs to evaluate the condition for CPC (e.g., when the UE is configured with a serving PSCell and/or when the UE is configured with an SCG) the UE uses the reporting configuration for events A3/A5. In other embodiments, when the UE needs to evaluate the condition for CPA (e.g., when the UE is NOT configured with a serving PSCell and/or when the UE is NOT configured with an SCG) the UE uses the reporting configuration for event A4.

In one option, the reporting configuration(s) in this case is of a type associated to a conditional reconfiguration, CPC or CPA e.g. ReportConfigNR IE (or reportConfig instance in the UE variable VarMeasConfig) has a reportType set to ‘condTriggerConfig’.

In one alternative embodiment, the UE receives an instance of the MeasIdToAddMod IE (or another equivalent IE) which includes a measId (same value which is configured in the execution condition for the CPA/CPC configuration), and a measurement reporting configuration identity (reportConfigId), where the reportConfigId is included in a reporting configuration (a ReportConfigToAddMod instance) that includes two different reporting configurations, a first and a second, e.g., in the form of two separate ReportConfigNR instances:

When the UE needs to evaluate the triggering/execution condition for CPC (e.g., when the UE is configured with a serving PSCell and/or when the UE is configured with an SCG) the UE uses the reporting configuration for event A3 (e.g., conditional event A3, i.e., CondEvent A3) or event A5 (e.g., conditional event A5, i.e., CondEvent A5).

When the UE needs to evaluate the condition for CPA (e.g., when the UE is NOT configured with a serving PSCell and/or when the UE is NOT configured with an SCG) the UE uses the reporting configuration for event A4 (e.g., conditional event A4, i.e., CondEvent A4).

In one option, the reporting configuration(s) in this case is of a type associated to a conditional reconfiguration, CPC or CPA, e.g., ReportConfigNR IE (or reportConfig instance in the UE variable VarMeasConfig) has a reportType set to ‘condTriggerConfig’.

In one option, the ReportConfig ToAddMod includes indication about what reporting configuration that is to be used by the UE at evaluation of the triggering/execution conditions for CPA and for CPC, respectively.

This solution means that the same identities for measurement configuration (MeasId) and for reporting configuration (ReportConfigId) can be used for the CPA/CPC configuration even though different triggering/execution conditions are to be used for CPA and for CPC.

Below is an example implementation for TS 38.331, V17.3.0 (Rel-17), with additions underlined:

-- ASN1START
-- TAG-REPORTCONFIGTOADDMODLIST-START

| | |
|---|---|
| ReportConfigToAddModList ::= | SEQUENCE (SIZE (1..maxReportConfigId)) OF |

ReportConfigToAddMod

| | |
|---|---|
| ReportConfigToAddMod ::= | SEQUENCE { |
| reportConfigId | ReportConfigId, |
| reportConfig | CHOICE { |
| reportConfigNR | ReportConfigNR, |

...,

| | |
|---|---|
| reportConfigInterRAT | ReportConfigInterRAT, |
| reportConfigNR-SL-r16 | ReportConfigNR-SL-r16, |

```
    reportConfigNR-CPAC-r18 SEQUENCE (SIZE (1..2)) OF
ReportConfigNR
  }
  }
-- TAG-REPORTCONFIGTOADDMODLIST-STOP
-- ASN1STOP
```

### 5.3.5.13.4 Conditional Reconfiguration Evaluation

The UE shall:
1> for each condReconfigId within the VarConditionalReconfig:
   2> if the RRCReconfiguration within condRRCReconfig includes the masterCellGroup including the reconfigurationWithSync:
      3> consider the cell which has a physical cell identity matching the value indicated in the ServingCellConfigCommon included in the reconfigurationWith Sync within the masterCellGroup in the received condRRCReconfig to be applicable cell;
   2> else if the RRCReconfiguration within condRRCReconfig includes the secondaryCellGroup including the reconfigurationWith Sync:
      3> consider the cell which has a physical cell identity matching the value indicated in the ServingCellConfigCommon included in the reconfigurationWith Sync within the secondaryCellGroup within the received condRRCReconfig to be applicable cell;
      3> if the UE is currently configured with an SpCell for the SCG (i.e a PSCell);
         4> in the remainder of the procedure, consider the conditional reconfiguration with condReconfigId to correspond to a CPC configuration;
         4> in the remainder of the procedure, consider the reporting configuration with a condEventId that is associated with condEventA3 or condEventA5;
      3> else (the UE is currently not configured with any SpCell for the SCG, i.e. PSCell);
         4> in the remainder of the procedure, consider the conditional reconfiguration with condReconfigId to correspond to a CPA configuration;
         4> in the remainder of the procedure, consider the reporting configuration with a condEventId that is associated with condEventA4;
   2> if condExecutionCondSCG is configured:
      3> in the remainder of the procedure, consider each measId indicated in the condExecutionCondSCG as a measId in the VarMeasConfig associated with the SCG measConfig;
   2> if condExecutionCond is configured:
      3> if it is configured via SRB3 or configured within nr-SCG or within nr-SecondaryCellGroupConfig (specified in TS 36.331 [10]) via SRB1;
         4> in the remainder of the procedure, consider each measId indicated in the condExecutionCond as a measId in the VarMeasConfig associated with the SCG measConfig;
      3> else:
         4> in the remainder of the procedure, consider each measId indicated in the condExecutionCond as a measId in the VarMeasConfig associated with the MCG measConfig;
   2> for each measId included in the measIdList within VarMeasConfig indicated in the condExecutionCond or condExecutionCondSCG associated to condReconfigId:
      3> if the condEventId is associated with condEventT1, and if the entry condition applicable for this event associated with the condReconfigId, i.e. the event corresponding with the condEventId(s) of the corresponding condTriggerConfig within VarConditionalReconfig, is fulfilled for the applicable cell; or
      3> if the condEventId is associated with condEventD1, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding timeToTrigger defined for this event within the VarConditionalReconfig; or
      3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time To Trigger defined for this event within the VarConditionalReconfig:
         4> consider the event associated to that measId to be fulfilled;
      3> if the measId for this event associated with the condReconfigId has been modified; or
      3> if the condEventId is associated with condEventT1, and if the leaving condition applicable for this event associated with the condReconfigId, i.e. the event corresponding with the condEventId(s) of the corresponding condTriggerConfig within VarConditionalReconfig, is fulfilled for the applicable cell; or
      3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding time To Trigger defined for this event within the VarConditionalReconfig; or
      3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time To Trigger defined for this event within the VarConditionalReconfig:
         4> consider the event associated to that measId to be not fulfilled;
   2> if event(s) associated to all measId(s) within condTriggerConfig for a target candidate cell within the stored condRRCReconfig are fulfilled:
      3> consider the target candidate cell within the stored condRRCReconfig, associated to that condReconfigId, as a triggered cell;
      3> initiate the conditional reconfiguration execution, as specified in 5.3.5.13.5;
NOTE 1: Up to 2 MeasId can be configured for each condReconfigId. The conditional reconfiguration event of the 2 MeasId may have the same or different event conditions, triggering quantity, time to trigger, and triggering threshold.
NOTE 2: Void.

Other embodiments herein include a method for a network node, e.g., a node acting as a Master Node (MN) for a UE, for configuring the UE with at least one conditional reconfiguration with a PSCell target candidate cell. According to the method, the network node sends a message (e.g. RRCReconfiguration) to the UE including a conditional reconfiguration with a PSCell target candidate cell (with an execution condition and a SCG/PSCell target candidate configuration). Here, the conditional reconfiguration with a PSCell target candidate cell corresponds to either a Conditional PSCell Addition (CPA) configuration or a Conditional PSCell Change (CPC) configuration.

In some embodiments, the execution condition is associated to two separate conditional events, e.g., one conditional event A4 and the other is conditional event A3 or A5. In one example, the two conditional events associated to the execution condition are provided as two measurement reporting configurations (e.g., ReportConfigNR) within ReportConfig ToAddMod. In another example, the two conditional events associated to the execution condition are provided as two measurement reporting configurations within MeasIdToAddMod. In some embodiments, only one of the two separate conditional events associated to the execution condition is used by the UE, depending on whether the evaluation is for CPA or for CPC.

In one example, the conditional reconfiguration with a PSCell target candidate cell corresponds to a Conditional PSCell Addition (CPA) configuration if/when the UE is not configured with any serving PSCell/SCG, and it corresponds to a Conditional PSCell Change (CPC) configuration if/when the UE is configured with a serving PSCell/SCG.

In one example, it is a node that is acting as, or that is a candidate to become, a Secondary Node (SN) for the UE that generates (or that provides input to) the configuration for at least one of the measurement reporting configurations (or measurement configurations).

In one set of embodiments, the UE is configured with an execution condition (e.g., MeasId) which points to a measurement identifier value (measId=X) in the measurement configuration (e.g., to the IE MeasIdToAddMod). The UE receives in a measurement configuration two different configurations with the same measurement identifier, e.g., the UE receives two instances of the IE MeasIdToAddMod where both instances have the same measurement identifier (e.g., MeasId=X), but one instance is pointing to a first reporting configuration (e.g., for CPC, configuring a Conditional Event A3 or A5), and the other instance is pointing to a second reporting configuration (e.g., for CPA, configuring a Conditional Event A4). Then, depending on whether the UE is evaluating the execution condition for CPA or for CPC, the UE selects the first or the second measurement configuration, for the same measId. The selection of measurement configuration is then done based on whether the execution condition is evaluated for CPA or for CPC, where the measurement configuration that is associated to (pointing to) a reporting configuration with a Conditional Event A3 or A5 is used in case the evaluation is for CPC, and the measurement configuration that is associated to (pointing to) a reporting configuration with a Conditional Event A4 is used in case the evaluation is for CPA.

In one option, the reporting configuration(s) in this case is of a type associated to a conditional reconfiguration, CPC or CPA e.g., ReportConfigNR IE (or reportConfig instance in the UE variable VarMeasConfig) has a reportType set to ‘condTriggerConfig’.

In one option, the reporting configuration (e.g., within ReportConfigToAddMod) or the measurement configuration includes an indication whether it is to be used for CPA or for CPC. In that case, the UE uses the indication to determine which reporting configuration and associated measurement configuration to use at evaluation of the CPA or CPC configuration, respectively.

In one alternative embodiment, the UE is configured with an execution condition (e.g., MeasId) which points to a measurement identifier value in the measurement configuration (e.g., to the IE MeasIdToAddMod), which then includes, e.g., an identity of a measurement reporting configuration (reportConfigId) that is associated to the measurement configuration, and the UE receives two different measurement reporting configurations (ReportConfigToAddMod) with the same identity (reportConfigId). E.g., the UE is configured with two separate instances of the IE ReportConfigToAddMod where both instances have the same identifier (e.g., reportConfigId=X), but one instance includes a reporting configuration for CPC, e.g., configuring a Conditional Event A3 or A5, and the other instance includes a reporting configuration for CPA, e.g., configuring a Conditional Event A4. Then, depending on whether the UE is evaluating the execution condition for CPA or for CPC, the UE selects the first or the second measurement reporting configuration, for the same reportConfigId. The selection of measurement reporting configuration (i.e., ReportConfigToAddMod instance with the indicated reportConfigId, e.g., with reportConfigId=X) is then done based on whether the execution condition is evaluated for CPA or for CPC, where the reporting configuration with a Conditional Event A3 or A5 is used in case the evaluation is for CPC, and the reporting configuration with a Conditional Event A4 is used in case the evaluation is for CPA.

In one option, the reporting configuration(s) in this case is of a type associated to a conditional reconfiguration, CPC or CPA, e.g., ReportConfigNR IE (or reportConfig instance in the UE variable VarMeasConfig) has a reportType set to ‘condTriggerConfig’.

In one option, the reporting configuration (e.g., within ReportConfigToAddMod) or the measurement configuration includes an indication whether it is to be used for CPA or for CPC. In that case, the UE uses the indication to determine which reporting configuration and associated measurement configuration to use at evaluation of the CPA or CPC configuration, respectively.

Other embodiments include a method for a network node, e.g., a node acting as a Master Node (MN) for a UE, for configuring the UE with at least one conditional reconfiguration with a PSCell target candidate cell. According to the method, the network node sends a message (e.g., RRCReconfiguration) to the UE including a conditional reconfiguration with a PSCell target candidate cell (with an execution condition and a SCG/PSCell target candidate configuration).

The conditional reconfiguration with a PSCell target candidate cell corresponds to either a Conditional PSCell Addition (CPA) configuration or a Conditional PSCell Change (CPC) configuration.

The execution condition includes at least one measurement configuration identity (measId) that is included in two separate MeasIdToAddMod, i.e., the network node configures two separate MeasIdToAddMod with the same measId value. In one example, one of the MeasIdToAddMod instances includes/is associated to measurement reporting configuration with a conditional event for CPA, e.g., conditional event A4 (CondEvent A4) and the other MeasIdToAddMod instance includes/is associated to measurement reporting configuration with a conditional event for CPC, e.g., conditional event A3 (CondEvent A3) or A5 (CondEvent A5). In some embodiments, only one of the measurement configurations with the indicated measId is used by the UE at a time, where the configuration to use is dependent on whether the evaluation of the execution condition, i.e., of the conditional reconfiguration, is for CPA or for CPC.

In one example, the conditional reconfiguration with a PSCell target candidate cell corresponds to a Conditional PSCell Addition (CPA) configuration if/when the UE is not configured with any serving PSCell/SCG and it corresponds to a Conditional PSCell Change (CPC) configuration if/when the UE is configured with a serving PSCell/SCG.

In one alternative, the network configures two measurement reporting configurations (e.g., two ReportConfig ToAddMod instances) with the same reportConfigId. A measurement configuration with a measId that is included in the execution condition then includes a reportConfigId that is included within two different ReportConfig ToAddMod instances. In one example, one of the ReportConfig ToAddMod instances includes/is associated to a conditional event for CPA, e.g., conditional event A4 (CondEvent A4) and the other ReportConfig ToAddMod instance includes/is associated to a conditional event for CPC, e.g., conditional event A3 (CondEvent A3) or A5 (CondEvent A5).

In some embodiments, only one of the measurement reporting configurations with the indicated reportConfigId is used by the UE at a time, where the configuration to use is dependent on whether the evaluation of the execution condition, i.e. of the conditional reconfiguration, is for CPA or for CPC.

In one example, it is a node that is acting as, or that is a candidate to become, a Secondary Node (SN) for the UE that generates (or that provides input to) the configuration for at least one of the measurement reporting configurations (or measurement configurations).

Further embodiments include a method for a User Equipment (UE) for performing evaluation of at least one conditional reconfiguration with a PSCell target candidate cell. According to the method, the UE receives a message (e.g., RRCReconfiguration) including a conditional reconfiguration with a PSCell target candidate cell (with an execution condition that includes at least two different MeasIds, and a SCG/PSCell target candidate configuration).

In some embodiments, the conditional reconfiguration with a PSCell target candidate cell corresponds to either a Conditional PSCell Addition (CPA) configuration or a Conditional PSCell Change (CPC) configuration. The conditional reconfiguration corresponds to a Conditional PSCell Addition (CPA) configuration when the UE is not configured with a serving PSCell/SCG configuration, and the conditional reconfiguration corresponds to a Conditional PSCell Change (CPC) configuration when the UE is configured with a serving PSCell/SCG configuration.

Further according to the method, the UE performs the evaluation of the execution condition of a subset of the MeasIds that are configured as part of the execution condition, where the subset that is used depends on whether the conditional reconfiguration corresponds to a Conditional PSCell Addition (CPA) configuration or to a Conditional PSCell Change (CPC) configuration, i.e., whether the UE is configured with a serving PSCell or not.

In one example, the UE is configured with a conditional reconfiguration with a PSCell target candidate cell that is used either for CPA or CPC, where the execution condition is configured with e.g., condExecutionCond, which includes two different measurement configuration identities (i.e., two different MeasId). One of these MeasId is associated to a conditional event for CPA (e.g., CondEvent A4) and the other is associated to a conditional event for CPC (e.g., CondEvent A3 or CondEvent A5). When the UE is not configured with any serving PSCell, it then evaluates the execution condition for the conditional reconfiguration (i.e., CPA configuration) using only the MeasId (measurement configuration identity) that is associated to the conditional event for CPA (CondEvent A4). When the UE instead is configured with a serving PSCell, it evaluates the execution condition for the conditional reconfiguration (i.e., CPC configuration) using only the other MeasId (measurement configuration identity), i.e., the one that is associated to the conditional event for CPC (CondEvent A3 or CondEvent A5). In one alternative, the UE receives an indication from the network that the execution condition for the conditional reconfiguration is used for both CPA and for CPC. In one example, it is explicitly indicated which MeasId that is for CPA and which is for CPC. In another example, it is implicit which MeasId that is for CPA and which is for CPC, e.g., based on the order they are included in the message/IE or based on the type of conditional events that they are associated to (so that e.g., CondEvent A4 is used for CPA and CondEvent A3 or CondEvent A5 is used for CPC).

Below is an example implementation for TS 38.331, V17.3.0 (Rel-17), where the additions are underlined:

```
-- ASN1START
  -- TAG-CONDRECONFIGTOADDMODLIST-START
  CondReconfigToAddModList-r16 ::= SEQUENCE (SIZE (1.. maxNrofCondCells-
  r16)) OF CondReconfigToAddMod-r16
```

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |
| RRCReconfiguration) | OPTIONAL, -- Cond condReconfigAdd |

```
    ...,
    [[
```

| | |
|---|---|
| condExecutionCondSCG-r17 | OCTET STRING (CONTAINING |

```
  CondReconfigExecCondSCG-r17) OPTIONAL -- Need M
    ]],
    [[
    combinedCPAC-execCond-r18 ENUMERATED {true} OPTIONAL --
  Need M
    ]]
  }
  CondReconfigExecCondSCG-r17 ::= SEQUENCE (SIZE (1..2)) OF MeasId
  -- TAG-CONDRECONFIGTOADDMODLIST-STOP
  -- ASN1STOP
```

### 5.3.5.13.4 Conditional Reconfiguration Evaluation

The UE shall:
1> for each condReconfigId within the VarConditionalReconfig:
   2> if the RRCReconfiguration within condRRCReconfig includes the masterCellGroup including the reconfigurationWithSync:
      3> consider the cell which has a physical cell identity matching the value indicated in the ServingCellConfigCommon included in the reconfigurationWith Sync within the masterCellGroup in the received condRRCReconfig to be applicable cell;
   2> else if the RRCReconfiguration within condRRCReconfig includes the secondaryCellGroup including the reconfigurationWith Sync:
      3> consider the cell which has a physical cell identity matching the value indicated in the ServingCellConfigCommon included in the reconfigurationWithSync within the secondaryCellGroup within the received condRRCReconfig to be applicable cell;
      3> if the UE is currently configured with an SpCell for the SCG (i.e a PSCell);
         4> in the remainder of the procedure, consider the conditional reconfiguration with condReconfigId to correspond to a CPC configuration;
      3> else (the UE is currently not configured with any SpCell for the SCG. i.e. PSCell);
         4> in the remainder of the procedure, consider the conditional reconfiguration with condReconfigId to correspond to a CPA configuration;
   2> if condExecutionCondSCG is configured:
      3> in the remainder of the procedure, consider each measId indicated in the condExecutionCondSCG as a measId in the VarMeasConfig associated with the SCG measConfig;
   2> if condExecutionCond is configured:
      3> if it is configured via SRB3 or configured within nr-SCG or within nr-SecondaryCellGroupConfig (specified in TS 36.331 [10]) via SRB1:
         4> in the remainder of the procedure, consider each measId indicated in the condExecutionCond as a measId in the VarMeasConfig associated with the SCG measConfig;
      3> else:
         4> in the remainder of the procedure, consider each measId indicated in the condExecutionCond as a measId in the VarMeasConfig associated with the MCG measConfig;
   2> for each measId included in the measIdList within VarMeasConfig indicated in the condExecutionCond or condExecutionCondSCG associated to condReconfigId:
      3> if the condEventId is associated with condEventT1, and if the entry condition applicable for this event associated with the condReconfigId, i.e. the event corresponding with the condEventId(s) of the corresponding condTriggerConfig within VarConditionalReconfig, is fulfilled for the applicable cell; or
      3> if the condEventId is associated with condEventD1, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding time To Trigger defined for this event within the VarConditionalReconfig; or
      3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time To Trigger defined for this event within the VarConditionalReconfig:
         4> consider the event associated to that measId to be fulfilled;
      3> if the measId for this event associated with the condReconfigId has been modified; or
      3> if the condEventId is associated with condEventT1, and if the leaving condition applicable for this event associated with the condReconfigId, i.e. the event corresponding with the condEventId(s) of the corresponding condTriggerConfig within VarConditionalReconfig, is fulfilled for the applicable cell; or
      3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding time To Trigger defined for this event within the VarConditionalReconfig; or
      3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding time To Trigger defined for this event within the VarConditionalReconfig:
         4> consider the event associated to that measId to be not fulfilled;
   2> if combinedCPAC-execCond is configured:
      3> if the conditional reconfiguration corresponds to a CPC configuration and the conditional event A3 or A5 that is associated to one of the measId within condTriggerConfig for a target candidate cell within the stored condRRCReconfig is fulfilled; or
      3> if the conditional reconfiguration corresponds to a CPA configuration and the conditional event A4 that is associated to one of the measId within condTriggerConfig for a target candidate cell within the stored condRRCReconfig is fulfilled:
         4> consider the target candidate cell within the stored condRRCReconfig, associated to that condReconfigId, as a triggered cell;
         4> initiate the conditional reconfiguration execution, as specified in 5.3.5.13.5;
   2> else if event(s) associated to all measId(s) within condTriggerConfig for a target candidate cell within the stored condRRCReconfig are fulfilled:
      3> consider the target candidate cell within the stored condRRCReconfig, associated to that condReconfigId, as a triggered cell;
      3> initiate the conditional reconfiguration execution, as specified in 5.3.5.13.5;
NOTE 1: Up to 2 MeasId can be configured for each condReconfigId. The conditional reconfiguration event of the 2 MeasId may have the same or different event conditions, triggering quantity, time to trigger, and triggering threshold.
NOTE 2: Void.

In one alternative, at least one new execution condition is introduced, e.g., in CondReconfigToAddMod, where the execution condition, in one example, includes more than two MeasIds. A subset of the included MeasIds is then used for evaluation of CPA and a subset is used for CPC, as described above. This allows that more than one measurement configuration (MeasId) and associated reporting configuration can be defined for CPA and/or for CPC, respectively. The measurement configurations included in the new execution condition(s) may refer to the MCG measConfig or to the SCG measConfig. In one example, the MeasIds of the new execution condition may be defined (e.g., divided) in a manner that indicates what type of conditional reconfiguration they refer to, e.g., whether they refer to (are associated to a conditional event for) CPA or CPC.

In one alternative to the above embodiments, the different MeasIds for the same execution condition (as defined through e.g., condExecutionCond or condExecutionCondSCG or a new field or IE), are used for evaluation of two other types of conditional reconfigurations, e.g., a Conditional Handover (CHO) and a Conditional PSCell Addition (CPA), or CHO and CPC. In one example, the execution condition then includes different MeasIds, where one or more is/are for CHO and the other MeasId(s) is/are for CPA or CPC. In this case, different MeasIds of the same execution condition refer to different measurement objects (measObjects).

Yet other embodiments include a method for a network node, e.g., a node acting as a Master Node (MN) for a UE, for configuring the UE with at least one conditional reconfiguration with a PSCell target candidate cell. According to the method, the network node sends a message (e.g., RRCReconfiguration) to the UE including a conditional reconfiguration with a PSCell target candidate cell (with an execution condition and a SCG/PSCell target candidate configuration).

In some embodiments, the conditional reconfiguration with a PSCell target candidate cell corresponds to either a Conditional PSCell Addition (CPA) configuration or a Conditional PSCell Change (CPC) configuration.

In some embodiments, the execution condition includes at least two measIds, i.e., identities for at least two different measurement configurations, where one of these measurement configurations is associated to a conditional event for CPA, e.g., conditional event A4 (CondEvent A4) and the other different measurement configuration is associated to a conditional event for CPC, e.g., conditional event A3 (CondEvent A3) or A5 (CondEvent A5).

In some embodiments, only one of the measurement configurations (measIds) is used by the UE at a time, depending on whether the evaluation of the execution condition, i.e., of the conditional reconfiguration, is for CPA or for CPC. E.g., that the UE only uses the measurement configuration (measId) associated to conditional event A4 (CondEvent A4) when evaluating for CPA and only the measurement configuration (measId) associated to conditional event A3 or A5 (CondEvent A3 or CondEvent A5) when evaluating for CPC. In one example, the conditional reconfiguration with a PSCell target candidate cell corresponds to a Conditional PSCell Addition (CPA) configuration if/when the UE is not configured with any serving PSCell/SCG and it corresponds to a Conditional PSCell Change (CPC) configuration if/when the UE is configured with a serving PSCell/SCG.

In one alternative, the network provides an indication to the UE that the execution condition for the conditional reconfiguration is used for both CPA and for CPC.

In one alternative, at least one new execution condition is configured by the network node to the UE, e.g., within CondReconfigToAddMod, where the execution condition, in one example, includes more than two MeasIds. A subset of the included MeasIds is then indicated to the UE to be used for evaluation of CPA and a subset is used for CPC. The measurement configurations included in the new execution condition(s) may refer to the MCG measConfig or to the SCG measConfig. In one example, the MeasIds of the new execution condition may be defined (e.g., divided) in a manner that indicates what type of conditional reconfiguration they refer to, e.g., whether they refer to (are associated to a conditional event for) CPA or CPC.

In one example, it is a node that is acting as, or that is a candidate to become, a Secondary Node (SN) for the UE that generates (or that provides input to) the configuration for at least one of the measurement configurations (or associated measurement reporting configurations).

Still further embodiments include a method for a User Equipment (UE). According to the method, the UE receives one or more conditional reconfigurations, e.g., through one or more RRCReconfiguration message(s), that correspond to CPA configurations, i.e., they are conditional reconfigurations with a PSCell target candidate cell (including an execution condition and a SCG/PSCell target candidate configuration) and they are received by the UE when it is not configured with any serving PSCell/SCG configuration. In one example, the execution conditions and/or measurement configurations for the CPA configurations are associated to conditional event A4.

In some embodiments, at least one of the CPA configurations includes, or is associated to, an indication about how to update the execution conditions and/or measurement configurations for the other stored CPA configurations that the UE keeps at execution of the first CPA configuration. At execution of the CPA configuration, the UE then updates the execution conditions and/or measurement configurations for other CPA configurations that are kept after the corresponding addition of a PSCell/SCG configuration, i.e., that then correspond to CPC configurations.

In one alternative, the execution conditions and/or measurement configurations for the stored CPA configurations (that after the execution of the CPA configuration would correspond to CPC configurations) are updated to be associated to conditional event A3 or conditional event A5. Through the included or associated information about update of execution condition and/or measurement configuration for other CPA/CPC configurations at execution of the CPA configuration, the UE is then provided with triggering conditions that take a serving SpCell (PSCell) into account when evaluating the configuration for CPC. In addition, the UE can get configured with execution conditions and/or measurement configuration for the different CPA/CPC configurations (when used for CPC) that is relevant for the current serving PSCell. For example, when executing a CPA configuration for addition of PSCell A, that CPA configuration includes updates of execution condition and/or measurement configuration for the CPA/CPC configurations towards other candidate target PSCells, that is based on that PSCell A is the serving PSCell for the UE, whereas the CPA configuration for addition of PSCell B includes or is associated to execution condition and/or measurement configuration for the other CPA/CPC configurations that is based on that PSCell B is the serving PSCell for the UE.

In one example, the updated configuration for the other CPA/CPC configurations is included within the SCG/PSCell target candidate configuration (i.e., in the RRCReconfiguration message included in condRRCReconfig) of the CPA/CPC configuration that is executed.

In one example, the updated configuration for the other CPA/CPC configurations is included within the CondReconfigToAddMod IE, but outside the SCG/PSCell target candidate configuration (i.e., condRRCReconfig) that is applied.

In one alternative, the executed CPA configuration also includes, or is associated to, updates of the execution condition and/or measurement configuration for the own CPA configuration, i.e., the one that is executed where the serving PSCell (after CPA execution) is the candidate target PSCell. In one example, the updates of the execution condition and/or measurement configuration then correspond to that they become associated to conditional events A3 or A5, i.e., to take a serving SpCell (PSCell) into account. This CPA/CPC configuration can then be stored at a later PSCell change and then be used for a subsequent CPC.

In one alternative, the UE receives from the network indication about how to update the execution conditions and/or measurement configurations for stored CPA configurations that the UE keeps at execution of a normal (i.e., non-conditional) PSCell addition procedure. In one example, the UE then gets information in the PSCell addition command message, e.g., an RRC Reconfiguration message (such as RRCReconfiguration), about how to update the execution conditions and/or measurement configurations for those CPA configurations that now become CPC configurations as part of the PSCell addition procedure. In one example, the updates of the execution condition and/or measurement configuration correspond to that they become associated to conditional events A3 or A5, i.e., to take a serving SpCell (PSCell) into account.

In one alternative, the update of the execution condition and/or measurement configuration for a stored CPA/CPC configuration (i.e., a conditional reconfiguration that can either be used for CPA or for CPC) consists of that an execution condition is added for the conditional reconfiguration (the CPA/CPC configuration). As an example, before the update of the execution condition and/or measurement configuration, the UE has one execution condition for the conditional reconfiguration and after the update the UE has two execution conditions for the conditional reconfiguration. In one example, the two execution conditions consist of the condExecutionCond and condExecutionCondSCG in the CondReconfig ToAddMod that configures the CPA/CPC configuration. The condExecutionCond is then associated to conditional event A4 and used for CPA and the condExecutionCondSCG is associated to conditional events A3 or A5 and used for CPC. The execution condition for CPA (condExecutionCond) is then e.g., generated by the MN and the execution condition for CPC (condExecutionCondSCG) is e.g., generated by an SN, such as e.g., the SN that generates the updated configuration of execution condition and/or measurement configuration, e.g., the target SN of the CPA configuration (or normal PSCell change configuration) that is executed. In one example, the UE only applies the updates or additions of the execution conditions and/or measurement configuration when the executed CPA/CPC configuration corresponds to a CPA, i.e., only when it leads to a PSCell addition procedure.

In one embodiment, the UE receives, from the network, an indication about updates of the execution conditions and/or measurement configurations for the (at least one) stored CPC configurations that is/are kept (i.e., not released) when the PSCell/SCG configuration is released. In one example, the UE receives an RRC Reconfiguration message (e.g., RRCReconfiguration) that configures the release of the PSCell/SCG configuration, and the message includes an update of execution condition and/or measurement configuration for at least one CPC configuration that is kept and then to be used for CPA. In one example the execution condition and/or measurement configuration are updated to become associated to a conditional event A4.

In one alternative, the UE stores the execution conditions to be used for CPA configuration that the UE has received from the network, even if a PSCell/SCG configuration is added for the UE, and the execution condition and/or measurement configuration then are changed to be associated to conditional events that are to be used for CPC. When the PSCell/SCG configuration then is released, the UE uses the stored execution conditions to be used for CPA again. In one option, the UE is provided with additional execution conditions and/or measurement configurations for the CPA/CPC configuration when it applies/executes another CPA/CPC configuration (or executes another normal PSCell change procedure). The UE then keeps the original execution condition and/or measurement configuration (related to CPA) for the CPA/CPC configuration and uses that at evaluation when the UE is (again) not configured with any PSCell/SCG.

Other embodiments include a method for a network node, e.g., a node acting as a Master Node (MN) for a UE, for configuring the UE with at least two conditional reconfigurations with a PSCell target candidate cell. According to the method, the network node sends at least one message (e.g., RRCReconfiguration) to the UE providing at least two conditional reconfigurations with a PSCell target candidate cell (each with an execution condition and a SCG/PSCell target candidate configuration).

In some embodiments, the conditional reconfigurations with a PSCell target candidate cell correspond to either a Conditional PSCell Addition (CPA) configuration or a Conditional PSCell Change (CPC) configuration.

In some embodiments, at least one of the conditional reconfiguration includes information related to updates or additions of execution condition and/or measurement configuration for other conditional reconfigurations to be applied if/when the conditional reconfiguration is executed. In one example, the network node includes information about the updates of other conditional reconfigurations within the applied/executed SCG/PSCell target candidate configuration. In one example, the network node includes information about the updates of other conditional reconfigurations within the conditional reconfiguration (e.g., in CondReconfigToAddMod).

In one example, the conditional reconfiguration with a PSCell target candidate cell corresponds to a Conditional PSCell Addition (CPA) configuration if/when the UE is not configured with any serving PSCell/SCG, and it corresponds to a Conditional PSCell Change (CPC) configuration if/when the UE is configured with a serving PSCell/SCG. In one example, the network node provides to the UE an added/updated execution condition that is to be applied at CPA execution or at PSCell addition, which is associated to an SCG measurement configuration. It can e.g., be provided as a CondExecutionCondSCG IE.

In one example, it is a node that is acting as, or that is a candidate to become, a Secondary Node (SN) for the UE that generates (or that provides input to) the updates or additions of execution condition and/or measurement configuration that are provided to the UE.

In one alternative, the network node includes information about updates of execution conditions and/or measurement configurations for conditional reconfigurations that the UE has stored, which correspond to CPC configurations, in a message (e.g., an RRC Reconfiguration message such as RRCReconfiguration) that is sent to the UE to release the SCG configuration (i.e., the PSCell) and where those stored conditional reconfigurations become corresponding to CPA configurations. In one example, the execution conditions and/or measurement configurations are updated to be associated to conditional event A4 (condEvent A4) instead of conditional event A3 (condEvent A3) or conditional event A5 (condEvent A5). In one example, the network node corresponds to a node that is acting as a Master Node (MN) for the UE.

Further embodiments include a method for a User Equipment (UE) for performing evaluation of at least one conditional reconfiguration with a PSCell target candidate cell. According to the method, the UE receives a message (e.g., RRCReconfiguration) including a conditional reconfiguration with a PSCell target candidate cell (with two different execution conditions and one SCG/PSCell target candidate configuration).

In some embodiments, the conditional reconfiguration with a PSCell target candidate cell corresponds to either a Conditional PSCell Addition (CPA) configuration or a Conditional PSCell Change (CPC) configuration. For example, the conditional reconfiguration corresponds to a Conditional PSCell Addition (CPA) configuration when the UE is not configured with a serving PSCell/SCG configuration; and the conditional reconfiguration corresponds to a Conditional PSCell Change (CPC) configuration when the UE is configured with a serving PSCell/SCG configuration.

Further according to the method, the UE performs the evaluation of the conditional reconfiguration by evaluating only one of the configured execution conditions, where the UE determines which of the execution conditions to evaluate according to whether the conditional reconfiguration corresponds to a Conditional PSCell Addition (CPA) configuration or to a Conditional PSCell Change (CPC) configuration, i.e. whether the UE is configured with a serving PSCell or not.

Consider other embodiments that exploit multiple execution condition fields 26-1, 26-3 which are exemplified herein with Embodiments A20-A23 in GROUP A EMBODIMENTS HEREIN, and with respect to FIG. 7.

In one alternative, the two execution conditions are configured using condExecutionCond and condExecutionCondSCG in the CondReconfig ToAddMod that configures the CPA/CPC configuration. The UE then uses the execution condition configured in condExecutionCond for evaluation when the conditional reconfiguration corresponds to a CPA configuration, and it uses the execution condition configured in condExecutionCondSCG for evaluation when the conditional reconfiguration corresponds to a CPC configuration. In one example, the execution condition for CPA is configured by a node acting as a Master Node (MN) for the UE and the execution condition for CPC is configured by a node acting as a Secondary Node (SN) for the UE.

In another alternative, a new execution condition e.g., condExecutionCond-cpac is included in the CondReconfig ToAddMod that configures the CPA/CPC configuration and the UE is configured with both this new execution condition (condExecutionCond-cpac) and condExecutionCond. In one example, it is a node acting as a Master Node (MN) for the UE that generates both these execution condition configurations and the UE uses one of them in case of CPA and the other in case of CPC.

Some embodiments include a method for a network node, e.g., a node acting as a Master Node (MN) for a UE, for configuring the UE with at least one conditional reconfiguration with a PSCell target candidate cell. According to the method, the network node sends at least one message (e.g., RRCReconfiguration) to the UE providing at least one conditional reconfiguration with a PSCell target candidate cell (with two different execution conditions configurations and a SCG/PSCell target candidate configuration).

In some embodiments, the conditional reconfiguration with a PSCell target candidate cell corresponds to either a Conditional PSCell Addition (CPA) configuration or a Conditional PSCell Change (CPC) configuration.

In some embodiments, one of the provided execution condition configurations is to be used by the UE when the conditional reconfiguration corresponds to a CPA configuration, i.e., when the UE is not configured with a serving PSCell/SCG, and the other execution condition configuration is to be used by the UE when the conditional reconfiguration corresponds to a CPC configuration, i.e., when the UE is configured with a serving PSCell/SCG.

In one example, the two execution conditions configurations are configured using the condExecutionCond and the condExecutionCondSCG within CondReconfigToAddMod that is used to configure the conditional reconfiguration. The execution condition to be used for CPA is then configured with condExecutionCond and the execution condition to be used for CPC is configured with condExecutionCondSCG. The execution condition can then also be associated to a corresponding measurement configuration.

In one example, a node that is acting as, or that is a candidate to become, a Secondary Node (SN) for the UE generates the execution condition and/or measurement configuration for CPC.

Note that the disclosure refers to a first network node operating as a Master Node (MN), e.g., having a Master Cell Group (MCG) configured to the UE; that MN can be a gNodeB, or a Central Unit gNodeB (CU-gNB) or an eNodeB, or a Central Unit eNodeB (CU-eNB), or any network node and/or network function. The disclosure also refers to a second network node operating as a Secondary Node (SN), or Source Secondary Node (S-SN) e.g., having a Secondary Cell Group (SCG) pre-configured (i.e., not connected to) to the UE; that SN can be a gNodeB, or a Central Unit gNodeB (CU-gNB) or an eNodeB, or a Central Unit eNodeB (CU-eNB), or any network node and/or network function. Notice that MN, S-SN, and T-SN may be from the same or different Radio Access Technologies (and possibly be associated to different Core Network nodes).

The text often refers to a “Secondary Node (SN)”, or target SN. This is equivalent to say this is a target candidate SN, or a network node associated to a target candidate PSCell that is being configured. If the UE would connect to that cell, transmissions and receptions with the UE would be handled by that node if the cell is associated to that node.

The text says that a cell resides in a node, e.g., a target candidate cell resides in the S-SN or the t-SN. That is equivalent to say that a cell is managed by the node, or is associated to the node, or associated with the node, or that the cell belongs to the node, or that the cell is of the node.

“SN-initiated CPC” corresponds to a procedure wherein the Source SN for a UE configured with MR-DC determines to configure CPC. Upon determining the Source SN selects, e.g. based on reported measurements, one or more target candidate cells (target candidate PSCell(s)) wherein at least one cell is associated to the Source SN, and at least another cell is associated to a neighbour SN. It can be said that if all target candidate cells are associated to the Source SN that is an “SN-initiated intra-SN CPC”, which may be referred as the Release 16 solution. It can be said that if at least one target candidate cell is associated to a neighbour SN that is an “SN-initiated inter-SN CPC”, which may be referred as a Release 17 solution.

The document refers to a candidate SN, or SN candidate, or an SN, as the network node (e.g., gNodeB) that is prepared during the CPA procedure and that can create an RRC Reconfiguration message with an SCG configuration (e.g., RRCReconfiguration**) to be provided to the UE and stored, with an execution condition, wherein the UE only applies the message upon the fulfillment of the execution condition. That candidate SN is associated to one or multiple PSCell candidate cell(s) that the UE can be configured with. The UE then can execute the condition and accesses one of these candidate cells, associated to a candidate SN that becomes the SN or simply the SN after execution (i.e., upon fulfillment of the execution condition).

The document refers to a Conditional PSCell Change (CPC) configuration and procedures (like CPC execution), most of the time to refer to the procedure from the UE perspective. Other terms may be considered as synonyms such as conditional reconfiguration, or Conditional Configuration (since the message that is stored and applied upon fulfillment of a condition is an RRCReconfiguration or RRCConnectionReconfiguration). Terminology wise, one could also interpret conditional handover (CHO) in a broader sense, also covering CPA (Conditional PSCell Change) procedures. The document refers to a Conditional SN Change most of the time to refer to the procedure from the UE perspective, to refer to procedures between network nodes wherein a node requests a target candidate SN (which may be the same as the Source SN or a neighbour SN) to configure a conditional PSCell Change (CPC) for at least one of its associated cells (cell associated to the target candidate SN).

The document refers to CPAC as a way to refer to either a Conditional PSCell Addition (CPA) or a Conditional PSCell Change (CPC).

The document refers to a neighbour SN and a Source SN as different entities, though both could be a target candidate SN for CPC.

The configuration of CPC can be done using the same IEs as conditional handover, which may be called at some point conditional configuration or conditional reconfiguration. The principle for the configuration is the same with configuring triggering/execution condition(s) and a reconfiguration message to be applied when the triggering condition(s) are fulfilled.

In the different embodiments of the disclosure, these IEs are used differently, e.g., sometimes generated by the MN, sometimes generated by the source SN, sometimes by a target candidate SN.

In the different embodiments of the disclosure, it is said the CPC is in MN format when the CPC configuration is not configured as an MR-DC configuration in mrdc-SecondaryCellGroup (as defined in TS 38.331 V17.3.0). In other words, the UE receives an RRCReconfiguration from the MN that may contain the mrdc-SecondaryCellGroup (e.g., in case the UE is also configured with an SCG MeasConfig for inter-SN CPC) but the CPC is not within that container. That means the IEs to configure CPC (e.g., the IE ConditionalReconfiguration) are not included in mrdc-SecondaryCellGroup. The CPA is also in MN format, but the UE is configured with CPA when it does not have any PSCell/SCG configured, i.e., it has not been configured with mrdc-SecondaryCellGroup.

In the different embodiments of the disclosure, it is said the CPC is in SN format when the CPC configuration is configured as an MR-DC configuration in mrdc-SecondaryCellGroup (as defined in TS 38.331 V17.3.0). In other words, the UE receives an RRCReconfiguration from the MN that may contain the mrdc-SecondaryCellGroup and the CPC is within that container. That means the IEs to configure CPC (e.g., the IE ConditionalReconfiguration) are included in mrdc-SecondaryCellGroup (e.g., within a series of other nested IEs).

In the different embodiments of the disclosure, it is said that a conditional reconfiguration with a PSCell target candidate cell includes an SCG/PSCell target candidate configuration. The SCG/PSCell target candidate configuration can then in some examples be interpreted as the condRRCReconfig-r16 (containing an RRCReconfiguration message) within CondReconfigToAddMod-r16, which is the configuration (including a target PSCell/SCG configuration) that the UE applies when the associated execution conditions are fulfilled (and the conditional reconfiguration is to be executed). It is also sometimes said that a conditional reconfiguration with a PSCell target candidate cell includes an execution condition, where this can in some examples be interpreted as (but not restricted to) the condExecutionCond-r16 and/or the condExecutionCondSCG-r17 within CondReconfigToAddMod-r16.

In a different embodiment of the disclosure, it is said that an execution condition corresponds to, or is associated to, a certain conditional event. This can be interpreted as (but is not restricted to) that the execution condition includes a measurement configuration identity (measId), which is included in a MeasIdToAddMod instance that includes a measurement reporting configuration identity (ReportConfigId) that is included in a ReportConfig ToAddMod instance with a configuration that includes that conditional event, e.g., that an included ReportConfigNR has reportType set to condTriggerConfig and this condTriggerConfig includes configuration for the corresponding conditional event.

In view of the modifications and variations herein, FIG. 15 depicts a method performed by a communication device 12 in accordance with particular embodiments. The method includes receiving, from a network node 14 in a communication network 10, a conditional reconfiguration 20 (Block 1500). The conditional reconfiguration 20 indicates a configuration 22 of a candidate target cell (Block 1500A). The conditional reconfiguration 20 also indicates a first condition 24-1 that the communication device 12 is to evaluate, for determining whether to apply the configuration 22, when the communication device 12 is not configured with a serving Primary Secondary Cell Group, SCG, Cell, PSCell (Block 1500B). The conditional reconfiguration 20 further indicates a second condition 24-2 that the communication device 12 is to evaluate, for determining whether to apply the configuration 22, when the communication device 12 is configured with a serving PSCell (Block 1500C).

In some embodiments, the method also comprises making a determination as to whether or not the communication device 12 is configured with a serving PSCell (Block 1530).

In some embodiments, the method also comprises, based on the determination, evaluating the first or the second condition 24-2 for determining whether to apply the configuration 22 (Block 1540).

In some embodiments, the method also comprises, responsive to determining to apply the configuration 22, applying the configuration 22 (Block 1550).

In some embodiments, the communication device 12 is to evaluate the first condition 24-1 when the communication device 12 is not configured with a serving PSCell, for determining whether to apply the configuration 22 for adding the candidate target cell as a serving PSCell, and the communication device 12 is to evaluate the second condition 24-2 when the communication device 12 is configured with a serving PSCell, for determining whether to apply the configuration 22 for changing a serving PSCell from a source cell to the candidate target cell.

In some embodiments, the conditional reconfiguration 20 includes an execution condition field 26 that indicates both the first and second conditions 24-1, 24-2.

In some embodiments, the execution condition field 26 identifies a measurement configuration 28. In some embodiments, the measurement configuration 28 is associated with a reporting configuration 30. In some embodiments, the reporting configuration 30 indicates both the first and second conditions 24-1, 24-2.

In some embodiments, the reporting configuration 30 indicates an event whose occurrence is to trigger the communication device 12 to apply the configuration 22. In some embodiments, the event is defined to occur when the first condition 24-1 is fulfilled while the communication device 12 is not configured with a serving PSCell. In some embodiments, the event is defined to also occur when the second condition 24-2 is fulfilled while the communication device 12 is configured with a serving PSCell.

In some embodiments, the first condition 24-1 is a function of results of one or more measurements performed on the candidate target cell, and is not a function of results of any measurements performed on a serving PSCell. In some embodiments, the second condition 24-2 is a function of both results of one or more measurements performed on the candidate target cell and results of one or more measurements performed on a serving PSCell.

In some embodiments, the event is defined to occur when an entering condition is satisfied and a leaving condition is not satisfied. In some embodiments, the entering condition is defined to be satisfied when a first subcondition is fulfilled while the communication device 12 is not configured with a serving PSCell. In some embodiments, the entering condition is defined to be satisfied when both the first subcondition and a second subcondition are fulfilled while the communication device 12 is configured with a serving PSCell. In some embodiments, the leaving condition is defined to be satisfied when a third subcondition is fulfilled while the communication device 12 is not configured with a serving PSCell. In some embodiments, the leaving condition is defined to be satisfied when either the third subcondition or a fourth subcondition are fulfilled while the communication device 12 is configured with a serving PSCell. In some embodiments, the first condition 24-1 is fulfilled when the first subcondition is fulfilled and the third subcondition is not fulfilled while the communication device 12 is not configured with a serving PSCell. In some embodiments, the second condition 24-2 is fulfilled when the first subcondition and the second subcondition are fulfilled, and neither the third subcondition nor the fourth subcondition are fulfilled, while the communication device 12 is configured with a serving PSCell.

In some embodiments, the event is an A5 Event, an A4 Event, an A5-CPAC Event, or an A4-CPAC Event.

In other embodiments, the event is defined to occur when an entering condition is satisfied and a leaving condition is not satisfied. In some embodiments, the entering condition is defined to be satisfied when a first subcondition is fulfilled while the communication device 12 is not configured with a serving PSCell. In some embodiments, the entering condition is defined to be satisfied when a second subcondition is fulfilled while the communication device 12 is configured with a serving PSCell. In some embodiments, the leaving condition is defined to be satisfied when a third subcondition is fulfilled while the communication device 12 is not configured with a serving PSCell. In some embodiments, the leaving condition is defined to be satisfied when a fourth subcondition is fulfilled while the communication device 12 is configured with a serving PSCell. In some embodiments, the first condition 24-1 is fulfilled when the first subcondition is fulfilled and the third subcondition is not fulfilled while the communication device 12 is not configured with a serving PSCell. In some embodiments, the second condition 24-2 is fulfilled when the second subcondition is fulfilled and the fourth subcondition is not fulfilled while the communication device 12 is configured with a serving PSCell.

In some embodiments, the event is an A3 Event or an A3-CPAC Event.

In some embodiments, the reporting configuration 30 indicates first and second events whose occurrence is to trigger the communication device 12 to apply the configuration 22 while the communication device 12 is and is not configured with a serving PSCell, respectively. In some embodiments, the first condition 24-1 is fulfilled when the first event occurs and the second condition 24-2 is fulfilled when the second even occurs.

In some embodiments, the execution condition field 26 identifies a measurement configuration 28. In some embodiments, the measurement configuration 28 is associated with first and second reporting configurations 30. In some embodiments, the first reporting configuration 30 indicates the first condition 24-1 and the second reporting configuration 30 indicates the second condition 24-2.

In some embodiments, the first reporting configuration 30 indicates a first event whose occurrence is to trigger the communication device 12 to apply the configuration 22. In some embodiments, the first event is defined to occur when the first condition 24-1 is fulfilled while the communication device 12 is not configured with a serving PSCell. In some embodiments, the second reporting configuration 30 indicates a second event whose occurrence is to trigger the communication device 12 to apply the configuration 22.

In some embodiments, the second event is defined to occur when the second condition 24-2 is fulfilled while the communication device 12 is configured with a serving PSCell. In some embodiments, the first and second reporting configurations 30 have a same reporting configuration identifier.

In some embodiments, the execution condition field 26 identifies first and second measurement configurations 28.

In some embodiments, the first measurement configuration 28 is associated with a first reporting configuration 30 and the second measurement configuration 28 is associated with a second reporting configuration 30. In some embodiments, the first reporting configuration 30 indicates the first condition 24-1 and the second reporting configuration 30 indicates the second condition 24-2. In some embodiments, the first reporting configuration 30 indicates a first event whose occurrence is to trigger the communication device 12 to apply the configuration 22.

In some embodiments, the first event is defined to occur when the first condition 24-1 is fulfilled while the communication device 12 is not configured with a serving PSCell. In some embodiments, the second reporting configuration 30 indicates a second event whose occurrence is to trigger the communication device 12 to apply the configuration 22. In some embodiments, the second event is defined to occur when the second condition 24-2 is fulfilled while the communication device 12 is configured with a serving PSCell.

In some embodiments, the first and second measurement configurations 28 have a same measurement configuration identifier.

In some embodiments, the execution condition field 26 identifies first and second measurement configurations 28. In some embodiments, the first measurement configuration 28 is associated with a first reporting configuration 30 and the second measurement configuration 28 is associated with a second reporting configuration 30. In some embodiments, the first reporting configuration 30 indicates the first condition 24-1 and the second reporting configuration 30 indicates the second condition 24-2.

In some embodiments, the first and second measurement configurations 28 have different measurement configuration identifiers.

In some embodiments, the execution condition field 26 identifies first and second measurement configuration sets. In some embodiments, the first measurement configuration set includes one or more first measurement configurations 28 that are respectively associated with one or more first reporting configurations 30 and the second measurement configuration set includes one or more second measurement configurations 28 that are respectively associated with one or more second reporting configurations 30. In some embodiments, the one or more first reporting configurations 30 indicate the first condition 24-1 and the one or more second reporting configurations 30 indicate the second condition 24-2.

In some embodiments, the conditional reconfiguration 20 includes first and second execution condition fields 26 that respectively indicate the first and second conditions 24-1, 24-2. In some embodiments, the first and second execution condition fields 26 identify first and second measurement configurations 28, respectively. In some embodiments, the first and second measurement configurations 28 are respectively associated with first and second reporting configurations 30. In some embodiments, the first and second reporting configurations 30 respectively indicate the first and second conditions 24-1, 24-2. In some embodiments, the first reporting configuration 30 indicates a first event whose occurrence is to trigger the communication device 12 to apply the configuration 22. In some embodiments, the first event is defined to occur when the first condition 24-1 is fulfilled while the communication device 12 is not configured with a serving PSCell. In some embodiments, the second reporting configuration 30 indicates a second event whose occurrence is to trigger the communication device 12 to apply the configuration 22. In some embodiments, the second event is defined to occur when the second condition 24-2 is fulfilled while the communication device 12 is configured with a serving PSCell.

In some embodiments, the first condition 24-1 is a function of results of one or more measurements performed on the candidate target cell and is not a function of results of any measurements performed on a serving PSCell, and the second condition 24-2 is a function of both results of one or more measurements performed on the candidate target cell and results of one or more measurements performed on a serving PSCell.

In some embodiments, the condition reconfiguration corresponds to a conditional PSCell addition configuration when the communication device 12 is not configured with a serving PSCell and corresponds to a conditional PSCell change configuration when the communication device 12 is configured with a serving PSCell.

In some embodiments, the conditional reconfiguration 20 is reusable for PSCell addition or PSCell change.

In some embodiments, the method further comprises making a determination as to whether or not the communication device 12 is configured with a serving PSCell. In some embodiments, the method further comprises, based on the determination, evaluating the first or the second condition 24-2 for determining whether to apply the configuration 22. In some embodiments, the method further comprises responsive to determining to apply the configuration 22, applying the configuration 22. In some embodiments, applying the configuration 22 comprises adding the candidate target cell as a serving PSCell or changing a serving PSCell from a source cell to the candidate target cell, depending on whether or not the communication device 12 is configured with a serving PSCell.

In some embodiments, the method further comprises, after applying the configuration 22 for PSCell addition, re-using the configuration 22 for PSCell change.

In some embodiments, the method further comprises evaluating the first condition 24-1 when the communication device 12 is not configured with a serving PSCell, for determining whether to apply the configuration 22 for adding the candidate target cell as a serving PSCell. In other embodiments, the method further comprises alternatively or additionally evaluating the second condition 24-2 when the communication device 12 is configured with a serving PSCell, for determining whether to apply the configuration 22 for changing a serving PSCell from a source cell to the candidate target cell.

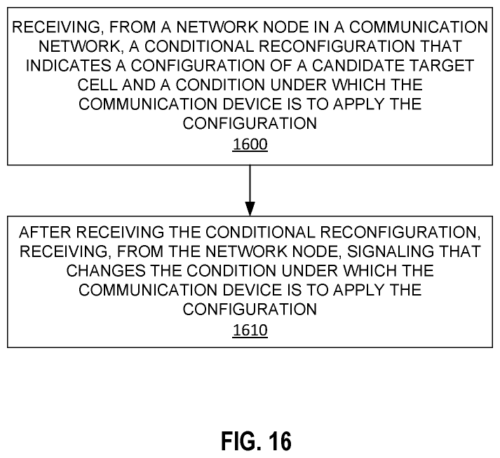

FIG. 16 depicts a method performed by a communication device 12 in accordance with other particular embodiments. The method includes receiving, from a network node 14 in a communication network 10, a conditional reconfiguration 20 that indicates a configuration 22 of a candidate target cell and a condition under which the communication device 12 is to apply the configuration 22 (Block 1600). The method also includes, after receiving the conditional reconfiguration 20, receiving, from the network node 14, signaling that changes the condition under which the communication device 12 is to apply the configuration 22 (Block 1610).

In some embodiments, the method further comprises, before receiving the signaling, detecting fulfilment of the condition and applying the configuration 22 for adding the candidate target cell as a serving PSCell. In some embodiments, the signaling is received after applying the configuration 22 for adding the candidate target cell as a serving PSCell, receiving. In some embodiments, the method further comprises, after receiving the signaling, detecting fulfilment of the changed condition and applying the configuration 22 for changing a serving PSCell from a source cell to the candidate target cell.

In some embodiments, the conditional reconfiguration 20 includes an execution condition field 26 whose value indicates the condition. In some embodiments, the signaling changes the condition by indicating a changed value for the execution condition field 26.

In some embodiments, the conditional reconfiguration 20 includes an execution condition field 26, wherein the execution condition field 26 identifies a measurement configuration 28 that indicates the condition. In some embodiments, the signaling changes the condition by indicating a different measurement configuration 28 for the conditional reconfiguration 20.

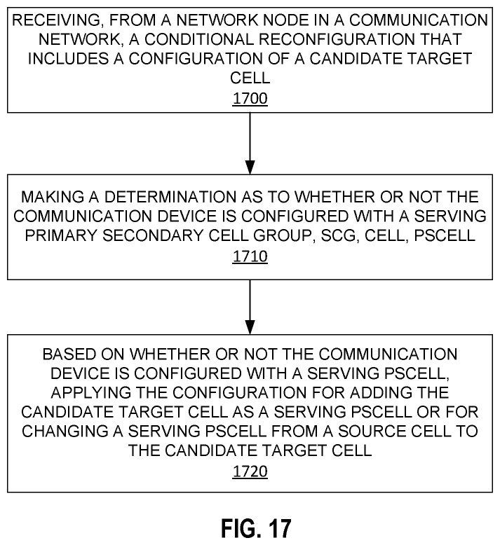

FIG. 17 depicts a method performed by a communication device 12 in accordance with other particular embodiments. The method includes receiving, from a network node 14 in a communication network 10, a conditional reconfiguration 20 that includes a configuration 22 of a candidate target cell (Block 1700). The method also includes making a determination as to whether or not the communication device 12 is configured with a serving Primary Secondary Cell Group, SCG, Cell, PSCell (Block 1710). The method also includes, based on whether or not the communication device 12 is configured with a serving PSCell, applying the configuration 22 for adding the candidate target cell as a serving PSCell or for changing a serving PSCell from a source cell to the candidate target cell (Block 1720).

In some embodiments, the method further comprises determining which condition to evaluate for deciding whether or not to apply the configuration 22, based on whether or not the communication device 12 is configured with a serving PSCell.

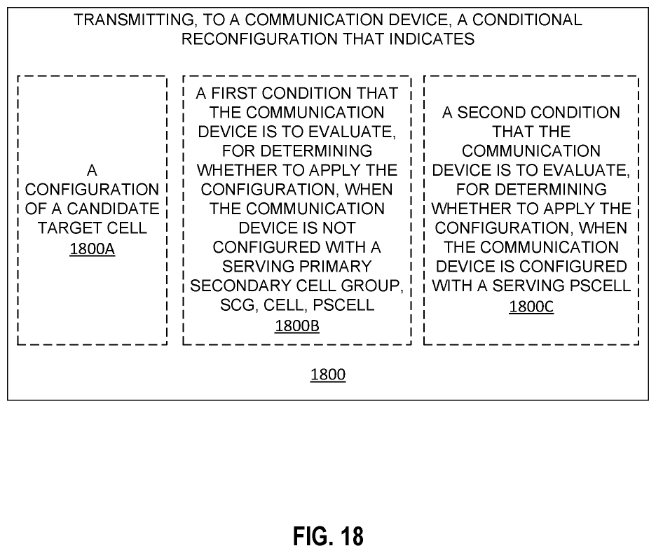

FIG. 18 depicts a method performed by a network node 14 in a communication network 10 in accordance with particular embodiments. The method includes transmitting, to a communication device 12, a conditional reconfiguration 20 (Block 1800). In some embodiments, the conditional reconfiguration 20 indicates a configuration 22 of a candidate target cell (Block 1800A). The conditional reconfiguration 20 also indicates a first condition 24-1 that the communication device 12 is to evaluate, for determining whether to apply the configuration 22, when the communication device 12 is not configured with a serving Primary Secondary Cell Group, SCG, Cell, PSCell (Block 1800B). The conditional reconfiguration 20 further indicates a second condition 24-2 that the communication device 12 is to evaluate, for determining whether to apply the configuration 22, when the communication device 12 is configured with a serving PSCell (Block 1800C).

In some embodiments, the communication device 12 is to evaluate the first condition 24-1 when the communication device 12 is not configured with a serving PSCell, for determining whether to apply the configuration 22 for adding the candidate target cell as a serving PSCell, and the communication device 12 is to evaluate the second condition 24-2 when the communication device 12 is configured with a serving PSCell, for determining whether to apply the configuration 22 for changing a serving PSCell from a source cell to the candidate target cell.

In some embodiments, the conditional reconfiguration 20 includes an execution condition field 26 that indicates both the first and second conditions 24-1, 24-2.

In some embodiments, the execution condition field 26 identifies a measurement configuration 28. In some embodiments, the measurement configuration 28 is associated with a reporting configuration 30. In some embodiments, the reporting configuration 30 indicates both the first and second conditions 24-1, 24-2.

In some embodiments, the reporting configuration 30 indicates an event whose occurrence is to trigger the communication device 12 to apply the configuration 22. In some embodiments, the event is defined to occur when the first condition 24-1 is fulfilled while the communication device 12 is not configured with a serving PSCell. In some embodiments, the event is defined to also occur when the second condition 24-2 is fulfilled while the communication device 12 is configured with a serving PSCell.

In some embodiments, the first condition 24-1 is a function of results of one or more measurements performed on the candidate target cell, and is not a function of results of any measurements performed on a serving PSCell. In some embodiments, the second condition 24-2 is a function of both results of one or more measurements performed on the candidate target cell and results of one or more measurements performed on a serving PSCell.

In some embodiments, the event is defined to occur when an entering condition is satisfied and a leaving condition is not satisfied. In some embodiments, the entering condition is defined to be satisfied when a first subcondition is fulfilled while the communication device 12 is not configured with a serving PSCell. In some embodiments, the entering condition is defined to be satisfied when both the first subcondition and a second subcondition are fulfilled while the communication device 12 is configured with a serving PSCell. In some embodiments, the leaving condition is defined to be satisfied when a third subcondition is fulfilled while the communication device 12 is not configured with a serving PSCell. In some embodiments, the leaving condition is defined to be satisfied when either the third subcondition or a fourth subcondition are fulfilled while the communication device 12 is configured with a serving PSCell. In some embodiments, the first condition 24-1 is fulfilled when the first subcondition is fulfilled and the third subcondition is not fulfilled while the communication device 12 is not configured with a serving PSCell. In some embodiments, the second condition 24-2 is fulfilled when the first subcondition and the second subcondition are fulfilled, and neither the third subcondition nor the fourth subcondition are fulfilled, while the communication device 12 is configured with a serving PSCell.

In some embodiments, the event is an A5 Event, an A4 Event, an A5-CPAC Event, or an A4-CPAC Event.

In other embodiments, the event is defined to occur when an entering condition is satisfied and a leaving condition is not satisfied. In some embodiments, the entering condition is defined to be satisfied when a first subcondition is fulfilled while the communication device 12 is not configured with a serving PSCell. In some embodiments, the entering condition is defined to be satisfied when a second subcondition is fulfilled while the communication device 12 is configured with a serving PSCell. In some embodiments, the leaving condition is defined to be satisfied when a third subcondition is fulfilled while the communication device 12 is not configured with a serving PSCell. In some embodiments, the leaving condition is defined to be satisfied when a fourth subcondition is fulfilled while the communication device 12 is configured with a serving PSCell. In some embodiments, the first condition 24-1 is fulfilled when the first subcondition is fulfilled and the third subcondition is not fulfilled while the communication device 12 is not configured with a serving PSCell. In some embodiments, the second condition 24-2 is fulfilled when the second subcondition is fulfilled and the fourth subcondition is not fulfilled while the communication device 12 is configured with a serving PSCell.

In some embodiments, the event is an A3 Event or an A3-CPAC Event.

In some embodiments, the reporting configuration 30 indicates first and second events whose occurrence is to trigger the communication device 12 to apply the configuration 22 while the communication device 12 is and is not configured with a serving PSCell, respectively. In some embodiments, the first condition 24-1 is fulfilled when the first event occurs and the second condition 24-2 is fulfilled when the second even occurs.

In some embodiments, the execution condition field 26 identifies a measurement configuration 28. In some embodiments, the measurement configuration 28 is associated with first and second reporting configurations 30. In some embodiments, the first reporting configuration 30 indicates the first condition 24-1 and the second reporting configuration 30 indicates the second condition 24-2.

In some embodiments, the first reporting configuration 30 indicates a first event whose occurrence is to trigger the communication device 12 to apply the configuration 22. In some embodiments, the first event is defined to occur when the first condition 24-1 is fulfilled while the communication device 12 is not configured with a serving PSCell. In some embodiments, the second reporting configuration 30 indicates a second event whose occurrence is to trigger the communication device 12 to apply the configuration 22.

In some embodiments, the second event is defined to occur when the second condition 24-2 is fulfilled while the communication device 12 is configured with a serving PSCell. In some embodiments, the first and second reporting configurations 30 have a same reporting configuration identifier.

In some embodiments, the execution condition field 26 identifies first and second measurement configurations 28.

In some embodiments, the first measurement configuration 28 is associated with a first reporting configuration 30 and the second measurement configuration 28 is associated with a second reporting configuration 30. In some embodiments, the first reporting configuration 30 indicates the first condition 24-1 and the second reporting configuration 30 indicates the second condition 24-2. In some embodiments, the first reporting configuration 30 indicates a first event whose occurrence is to trigger the communication device 12 to apply the configuration 22.

In some embodiments, the first event is defined to occur when the first condition 24-1 is fulfilled while the communication device 12 is not configured with a serving PSCell. In some embodiments, the second reporting configuration 30 indicates a second event whose occurrence is to trigger the communication device 12 to apply the configuration 22. In some embodiments, the second event is defined to occur when the second condition 24-2 is fulfilled while the communication device 12 is configured with a serving PSCell.

In some embodiments, the first and second measurement configurations 28 have a same measurement configuration identifier.

In some embodiments, the execution condition field 26 identifies first and second measurement configurations 28. In some embodiments, the first measurement configuration 28 is associated with a first reporting configuration 30 and the second measurement configuration 28 is associated with a second reporting configuration 30. In some embodiments, the first reporting configuration 30 indicates the first condition 24-1 and the second reporting configuration 30 indicates the second condition 24-2.

In some embodiments, the first and second measurement configurations 28 have different measurement configuration identifiers.

In some embodiments, the execution condition field 26 identifies first and second measurement configuration sets. In some embodiments, the first measurement configuration set includes one or more first measurement configurations 28 that are respectively associated with one or more first reporting configurations 30 and the second measurement configuration set includes one or more second measurement configurations 28 that are respectively associated with one or more second reporting configurations 30. In some embodiments, the one or more first reporting configurations 30 indicate the first condition 24-1 and the one or more second reporting configurations 30 indicate the second condition 24-2.

In some embodiments, the conditional reconfiguration 20 includes first and second execution condition fields 26 that respectively indicate the first and second conditions 24-1, 24-2. In some embodiments, the first and second execution condition fields 26 identify first and second measurement configurations 28, respectively. In some embodiments, the first and second measurement configurations 28 are respectively associated with first and second reporting configurations 30. In some embodiments, the first and second reporting configurations 30 respectively indicate the first and second conditions 24-1, 24-2. In some embodiments, the first reporting configuration 30 indicates a first event whose occurrence is to trigger the communication device 12 to apply the configuration 22. In some embodiments, the first event is defined to occur when the first condition 24-1 is fulfilled while the communication device 12 is not configured with a serving PSCell. In some embodiments, the second reporting configuration 30 indicates a second event whose occurrence is to trigger the communication device 12 to apply the configuration 22. In some embodiments, the second event is defined to occur when the second condition 24-2 is fulfilled while the communication device 12 is configured with a serving PSCell.

In some embodiments, the first condition 24-1 is a function of results of one or more measurements performed on the candidate target cell and is not a function of results of any measurements performed on a serving PSCell, and the second condition 24-2 is a function of both results of one or more measurements performed on the candidate target cell and results of one or more measurements performed on a serving PSCell.

In some embodiments, the condition reconfiguration corresponds to a conditional PSCell addition configuration when the communication device 12 is not configured with a serving PSCell and corresponds to a conditional PSCell change configuration when the communication device 12 is configured with a serving PSCell.

In some embodiments, the conditional reconfiguration 20 is reusable for PSCell addition or PSCell change.

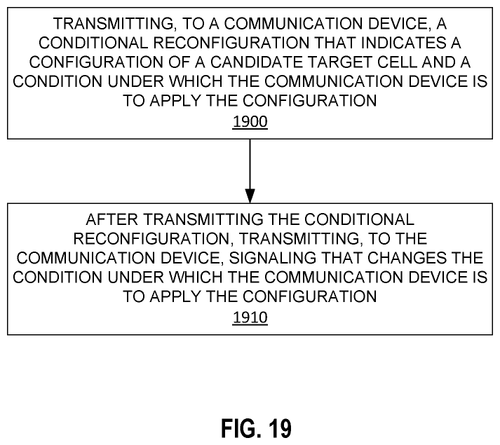

FIG. 19 depicts a method performed by a network node 14 in a communication network 10 in accordance with other particular embodiments. The method includes transmitting, to a communication device 12, a conditional reconfiguration 20 that indicates a configuration 22 of a candidate target cell and a condition under which the communication device 12 is to apply the configuration 22 (Block 1900). The method also includes, after transmitting the conditional reconfiguration 20, transmitting, to the communication device 12, signaling that changes the condition under which the communication device 12 is to apply the configuration 22 (Block 1910).

In some embodiments, the conditional reconfiguration 20 includes an execution condition field 26 whose value indicates the condition. In some embodiments, the signaling changes the condition by indicating a changed value for the execution condition field 26.

In some embodiments, the conditional reconfiguration 20 includes an execution condition field 26. In some embodiments, the execution condition field 26 identifies a measurement configuration 22 that indicates the condition. In some embodiments, the signaling changes the condition by indicating a different measurement configuration 22 for the conditional reconfiguration 20.

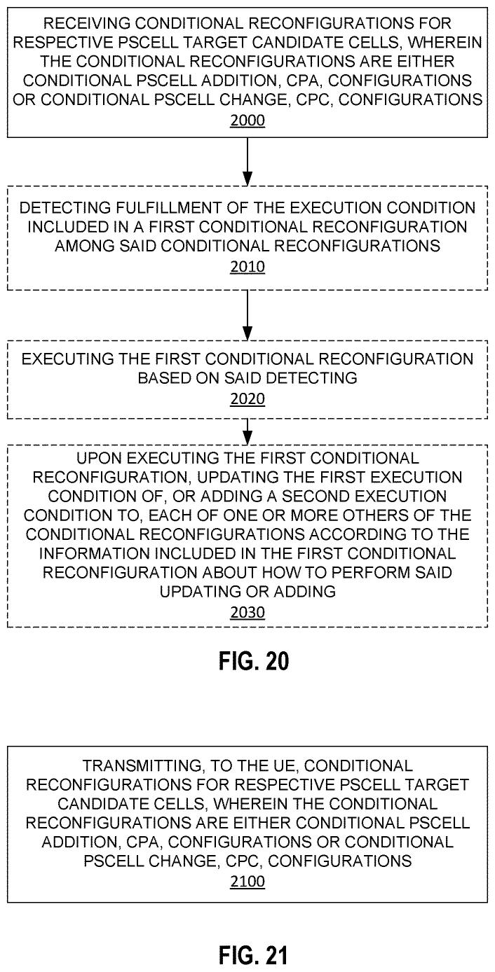

FIG. 20 depicts a method performed by a user equipment, UE, 12 for re-using a conditional reconfiguration 40-1 . . . 40-N both for conditional addition of a primary cell of a secondary cell group, PSCell, in multi-connectivity operation and for conditional change of a PSCell in multi-connectivity operation. The method comprises receiving conditional reconfigurations 40-1 . . . 40-N for respective PSCell target candidate cells. In some embodiments, the conditional reconfigurations 40-1 . . . 40-N are either conditional PSCell addition, CPA, configurations or conditional PSCell change, CPC, configurations (Block 2000). In some embodiments, each of the conditional reconfigurations 40-1 . . . 40-N includes a first execution condition 42-1 . . . 42-2 that needs to be fulfilled in order to trigger execution of the conditional reconfiguration 40-1 . . . 40-N. In some embodiments, each of the conditional reconfigurations 40-1 . . . 40-N includes a PSCell target candidate configuration 44-1 . . . 44-N that is a configuration to be applied towards the PSCell target candidate cell of the conditional reconfiguration 40-1 . . . 40-N when the conditional reconfiguration 40-1 . . . 40-N is executed. In some embodiments, each of at least one of the conditional reconfigurations 40-1 . . . 40-N also includes information 46-1 . . . 46-N about how to, upon execution of the conditional reconfiguration 40-1 . . . 40-N, update the first execution condition 42-1 . . . 42-2 of, or add a second execution condition to, each of one or more others of the conditional reconfigurations 40-1 . . . 40-N.

In some embodiments, the information 46-1 . . . 46-N included in each of the at least one of the conditional reconfigurations 40-1 . . . 40-N is information 46-1 . . . 46-N about how to, upon execution of the conditional reconfiguration 40-1 . . . 40-N, add a second execution condition to each of one or more others of the conditional reconfigurations 40-1 . . . 40-N. In some embodiments, the conditional reconfigurations 40-1 . . . 40-N are CPA configurations, and the information 46-1 . . . 46-N in each of at least one of the conditional reconfigurations 40-1 . . . 40-N is information 46-1 . . . 46-N about how to, upon execution of the conditional reconfiguration 40-1 . . . 40-N, add a second execution condition to each of one or more others of the conditional reconfigurations 40-1 . . . 40-N in order to configure the other conditional reconfiguration 40-1 . . . 40-N to be re-usable as a CPC configuration. In some embodiments, the information 46-1 . . . 46-N included in each of the at least one of the conditional reconfigurations 40-1 . . . 40-N is information 46-1 . . . 46-N about how to, upon execution of the conditional reconfiguration 40-1 . . . 40-N towards the PSCell target candidate cell of the conditional reconfiguration 40-1 . . . 40-N, add a second execution condition to each of one or more others of the conditional reconfigurations 40-1 . . . 40-N in order to configure the other conditional reconfiguration 40-1 . . . 40-N to be re-usable as a CPC configuration that is based on the PSCell target candidate cell of the conditional configuration being a serving PSCell for the UE 12. In some embodiments, for each of the one or more others of the conditional reconfigurations 40-1 . . . 40-N to which a second execution condition is added, the first execution condition 42-1 . . . 42-2 needs to be fulfilled in order to trigger execution of the conditional reconfiguration 40-1 . . . 40-N when the UE 12 is not configured with any serving PSCell configuration or with any secondary cell group, SCG. In some embodiments, for each of the one or more others of the conditional reconfigurations 40-1 . . . 40-N to which a second execution condition is added the second execution condition 42-1 . . . 42-2 needs to be fulfilled in order to trigger execution of the conditional reconfiguration 40-1 . . . 40-N when the UE 12 is configured with a serving PSCell configuration or with an SCG. In some embodiments, for each of the one or more others of the conditional reconfigurations 40-1 . . . 40-N to which a second execution condition is added the first execution condition 42-1 . . . 42-2 is associated with conditional event A4. In some embodiments, for each of the one or more others of the conditional reconfigurations 40-1 . . . 40-N to which a second execution condition is added the second execution condition 42-1 . . . 42-2 is associated with conditional event A3 or conditional event A5. In some embodiments, the information 46-1 . . . 46-N included in each of the at least one of the conditional reconfigurations 40-1 . . . 40-N comprises the second execution condition to be added to each of the one or more other conditional reconfigurations 40-1 . . . 40-N. In some embodiments, for each of the one or more others of the conditional reconfigurations 40-1 . . . 40-N to which a second execution condition is added, the second execution condition is added in a condExecutionCondSCG information element of the conditional reconfiguration 40-1 . . . 40-N.

In some embodiments, for each of the conditional reconfigurations 40-1 . . . 40-N, the first execution condition is included in a condExecutionCond information element of the conditional reconfiguration 40-1 . . . 40-N.

In some embodiments, receiving the conditional reconfigurations 40-1 . . . 40-N comprises receiving the conditional reconfigurations 40-1 . . . 40-N when the UE 12 is not configured with any serving PSCell configuration or with any SCG.

In some embodiments, the information 46-1 . . . 46-N included in each of the at least one of the conditional reconfigurations 40-1 . . . 40-N is information 46-1 . . . 46-N about how to, upon execution of the conditional reconfiguration 40-1 . . . 40-N, update the first execution condition 42-1 . . . 42-2 of each of one or more others of the conditional reconfigurations 40-1 . . . 40-N in order to change the other conditional reconfiguration 40-1 . . . 40-N from a CPA configuration to a CPC configuration or from a CPC configuration to a CPA configuration.

In some embodiments, the information 46-1 . . . 46-N included in each of the at least one of the conditional reconfigurations 40-1 . . . 40-N is included in the conditional reconfiguration 40-1 . . . 40-N outside of the PSCell target candidate configuration 44-1 . . . 44-N of the conditional reconfiguration 40-1 . . . 40-N.

In some embodiments, receiving the conditional reconfigurations 40-1 . . . 40-N comprises receiving one or more radio resource control, RRC, reconfiguration messages, wherein each RRC reconfiguration message includes a condReconfig ToAddModList information element that comprises a list of one or more of the conditional reconfigurations 40-1 . . . 40-N.

In some embodiments, the method further comprises detecting fulfillment of the execution condition 42-1 . . . 42-2 included in a first conditional reconfiguration 40-1 . . . 40-N among said conditional reconfigurations 40-1 . . . 40-N(Block 2010). In some embodiments, the method further comprises executing the first conditional reconfiguration 40-1 . . . 40-N based on said detecting (Block 2020). In some embodiments, the method further comprises upon executing the first conditional reconfiguration 40-1 . . . 40-N, (2030) updating the first execution condition 42-1 . . . 42-2 of, or adding a second execution condition to, each of one or more others of the conditional reconfigurations 40-1 . . . 40-N according to the information 46-1 . . . 46-N included in the first conditional reconfiguration 40-1 . . . 40-N about how to perform said updating or adding (Block 2030). In some embodiments, said updating or adding comprises adding a second execution condition to each of one or more others of the conditional reconfigurations 40-1 . . . 40-N according to the information 46-1 . . . 46-N included in the first conditional reconfiguration 40-1 . . . 40-N about how to perform said updating or adding. In some embodiments, the method further comprises, after said adding, for each of the one or more others of the conditional reconfigurations 40-1 . . . 40-N to which a second execution condition is added, determining whether to execute the conditional reconfiguration 40-1 . . . 40-N by evaluating whether the second execution condition is fulfilled. In some embodiments, the method further comprises, after said adding, receiving a message that configures a release of a PSCell configuration of the UE 12. In some embodiments, the method further comprises, after said adding, after receiving the message, for each of the one or more others of the conditional reconfigurations 40-1 . . . 40-N to which a second execution condition is added, determining whether to execute the conditional reconfiguration 40-1 . . . 40-N by evaluating whether the first execution condition 42-1 . . . 42-2 is fulfilled.

FIG. 21 depicts a method performed by a network node 14 in a communication network 10 for enabling a user equipment, UE, 12 to re-use a conditional reconfiguration 40-1 . . . 40-N both for conditional addition of a primary cell of a secondary cell group, PSCell, in multi-connectivity operation and for conditional change of a PSCell in multi-connectivity operation. The method includes transmitting, to the UE 12, conditional reconfigurations 40-1 . . . 40-N for respective PSCell target candidate cells. In some embodiments, the conditional reconfigurations 40-1 . . . 40-N are either conditional PSCell addition, CPA, configurations or conditional PSCell change, CPC, configurations (Block 2100). In some embodiments, each of the conditional reconfigurations 40-1 . . . 40-N includes a first execution condition 42-1 . . . 42-2 that needs to be fulfilled in order to trigger execution of the conditional reconfiguration 40-1 . . . 40-N. In some embodiments, each of the conditional reconfigurations 40-1 . . . 40-N includes a PSCell target candidate configuration 44-1 . . . 44-N that is a configuration to be applied towards the PSCell target candidate cell of the conditional reconfiguration 40-1 . . . 40-N when the conditional reconfiguration 40-1 . . . 40-N is executed In some embodiments, each of at least one of the conditional reconfigurations 40-1 . . . 40-N also includes information 46-1 . . . 46-N about how to, upon execution of the conditional reconfiguration 40-1 . . . 40-N, update the first execution condition 42-1 . . . 42-2 of each of, or add a second execution condition to, one or more others of the conditional reconfigurations 40-1 . . . 40-N.

In some embodiments, the information 46-1 . . . 46-N included in each of the at least one of the conditional reconfigurations 40-1 . . . 40-N is information 46-1 . . . 46-N about how to, upon execution of the conditional reconfiguration 40-1 . . . 40-N, add a second execution condition to each of one or more others of the conditional reconfigurations. In some embodiments, the conditional reconfigurations 40-1 . . . 40-N are CPA configurations, and the information 46-1 . . . 46-N in each of at least one of the conditional reconfigurations 40-1 . . . 40-N is information 46-1 . . . 46-N about how to, upon execution of the conditional reconfiguration 40-1 . . . 40-N, add a second execution condition to each of one or more others of the conditional reconfigurations 40-1 . . . 40-N in order to configure the other conditional reconfiguration 40-1 . . . 40-N to be re-usable as a CPC configuration. In some embodiments, the information 46-1 . . . 46-N included in each of the at least one of the conditional reconfigurations 40-1 . . . 40-N is information 46-1 . . . 46-N about how to, upon execution of the conditional reconfiguration 40-1 . . . 40-N towards the PSCell target candidate cell of the conditional reconfiguration 40-1 . . . 40-N, add a second execution condition to each of one or more others of the conditional reconfigurations 40-1 . . . 40-N in order to configure the other conditional reconfiguration 40-1 . . . 40-N to be re-usable as a CPC configuration that is based on the PSCell target candidate cell of the conditional configuration being a serving PSCell for the UE. In some embodiments, for each of the one or more others of the conditional reconfigurations 40-1 . . . 40-N to which a second execution condition is added, the first execution condition 42-1 . . . 42-2 needs to be fulfilled in order to trigger execution of the conditional reconfiguration 40-1 . . . 40-N when the UE 12 is not configured with any serving PSCell configuration or with any secondary cell group, SCG. In some embodiments, for each of the one or more others of the conditional reconfigurations 40-1 . . . 40-N to which a second execution condition is added, the second execution condition 42-1 . . . 42-2 needs to be fulfilled in order to trigger execution of the conditional reconfiguration 40-1 . . . 40-N when the UE 12 is configured with a serving PSCell configuration or with an SCG. In some embodiments, for each of the one or more others of the conditional reconfigurations 40-1 . . . 40-N to which a second execution condition is added, the first execution condition 42-1 . . . 42-2 is associated with conditional event A4. In some embodiments, for each of the one or more others of the conditional reconfigurations 40-1 . . . 40-N to which a second execution condition is added, the second execution condition 42-1 . . . 42-2 is associated with conditional event A3 or conditional event A5. In some embodiments, the information 46-1 . . . 46-N included in each of the at least one of the conditional reconfigurations 40-1 . . . 40-N comprises the second execution condition to be added to each of the one or more other conditional reconfigurations 40-1 . . . 40-N. In some embodiments, for each of the one or more others of the conditional reconfigurations 40-1 . . . 40-N to which a second execution condition is added, the second execution condition is added in a condExecutionCondSCG information element of the conditional reconfiguration 40-1 . . . 40-N.

In some embodiments, for each of the conditional reconfigurations 40-1 . . . 40-N, the first execution condition is included in a condExecutionCond information element of the conditional reconfiguration 40-1 . . . 40-N.

In some embodiments, transmitting the conditional reconfigurations 40-1 . . . 40-N comprises transmitting the conditional reconfigurations 40-1 . . . 40-N when the UE 12 is not configured with any serving PSCell configuration or with any SCG.

In some embodiments, the information 46-1 . . . 46-N included in each of the at least one of the conditional reconfigurations 40-1 . . . 40-N is information 46-1 . . . 46-N about how to, upon execution of the conditional reconfiguration 40-1 . . . 40-N, update the first execution condition 42-1 . . . 42-2 of each of one or more others of the conditional reconfigurations 40-1 . . . 40-N in order to change the other conditional reconfiguration 40-1 . . . 40-N from a CPA configuration to a CPC configuration or from a CPC configuration to a CPA configuration.

In some embodiments, the information 46-1 . . . 46-N included in each of the at least one of the conditional reconfigurations 40-1 . . . 40-N is included in the conditional reconfiguration 40-1 . . . 40-N outside of the PSCell target candidate configuration 44-1 . . . 44-N of the conditional reconfiguration 40-1 . . . 40-N.

In some embodiments, transmitting the conditional reconfigurations 40-1 . . . 40-N comprises transmitting one or more radio resource control, RRC, reconfiguration messages, wherein each RRC reconfiguration message includes a condReconfig ToAddModList information element that comprises a list of one or more of the conditional reconfigurations 40-1 . . . 40-N.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

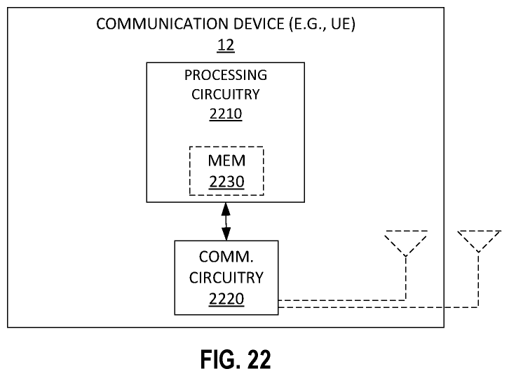

FIG. 22 for example illustrates a communication device 12 as implemented in accordance with one or more embodiments. As shown, the communication device 12 includes processing circuitry 2210 and communication circuitry 2220. The communication circuitry 2220 (e.g., radio circuitry) is configured to transmit and/or receive information to and/or from one or more other nodes, e.g., via any communication technology. Such communication may occur via one or more antennas that are either internal or external to the communication device 12. The processing circuitry 2210 is configured to perform processing described above, e.g., in FIG. 15, FIG. 16, FIG. 17, and/or FIG. 20, such as by executing instructions stored in memory 2230. The processing circuitry 2210 in this regard may implement certain functional means, units, or modules.

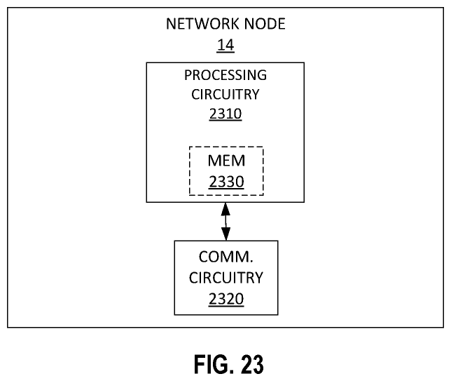

FIG. 23 illustrates a network node 14 as implemented in accordance with one or more embodiments. As shown, the network node 14 includes processing circuitry 2310 and communication circuitry 2320. The communication circuitry 2320 is configured to transmit and/or receive information to and/or from one or more other nodes, e.g., via any communication technology. The processing circuitry 2310 is configured to perform processing described above, e.g., in FIG. 18, FIG. 19, and/or FIG. 21, such as by executing instructions stored in memory 2330. The processing circuitry 2310 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

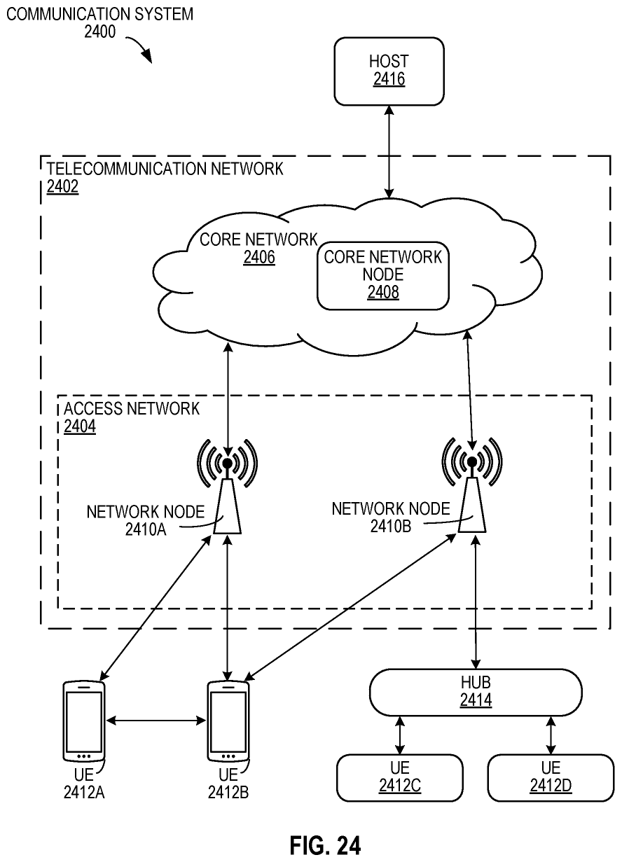

FIG. 24 shows an example of a communication system 2400 in accordance with some embodiments.

In the example, the communication system 2400 includes a telecommunication network 2402 that includes an access network 2404, such as a radio access network (RAN), and a core network 2406, which includes one or more core network nodes 2408. The access network 2404 includes one or more access network nodes, such as network nodes 2410a and 2410b (one or more of which may be generally referred to as network nodes 2410), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 2402 includes one or more Open-RAN (ORAN) network nodes. An ORAN network node is a node in the telecommunication network 2402 that supports an ORAN specification (e.g., a specification published by the O-RAN Alliance, or any similar organization) and may operate alone or together with other nodes to implement one or more functionalities of any node in the telecommunication network 2402, including one or more network nodes 2410 and/or core network nodes 2408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 2410 facilitate direct or indirect connection of user equipment (UE), such as by connecting UEs 2412a, 2412b, 2412c, and 2412d (one or more of which may be generally referred to as UEs 2412) to the core network 2406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2400 may include any number of wired or wireless networks, network nodes, UEs, and/or any other components or systems that may facilitate or participate in the communication of data and/or signals whether via wired or wireless connections. The communication system 2400 may include and/or interface with any type of communication, telecommunication, data, cellular, radio network, and/or other similar type of system.

The UEs 2412 may be any of a wide variety of communication devices, including wireless devices arranged, configured, and/or operable to communicate wirelessly with the network nodes 2410 and other communication devices. Similarly, the network nodes 2410 are arranged, capable, configured, and/or operable to communicate directly or indirectly with the UEs 2412 and/or with other network nodes or equipment in the telecommunication network 2402 to enable and/or provide network access, such as wireless network access, and/or to perform other functions, such as administration in the telecommunication network 2402.

In the depicted example, the core network 2406 connects the network nodes 2410 to one or more hosts, such as host 2416. These connections may be direct or indirect via one or more intermediary networks or devices. In other examples, network nodes may be directly coupled to hosts. The core network 2406 includes one more core network nodes (e.g., core network node 2408) that are structured with hardware and software components. Features of these components may be substantially similar to those described with respect to the UEs, network nodes, and/or hosts, such that the descriptions thereof are generally applicable to the corresponding components of the core network node 2408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2416 may be under the ownership or control of a service provider other than an operator or provider of the access network 2404 and/or the telecommunication network 2402, and may be operated by the service provider or on behalf of the service provider. The host 2416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2400 of FIG. 24 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2402 is a cellular network that implements 3GPP standardized features. Accordingly, the telecommunications network 2402 may support network slicing to provide different logical networks to different devices that are connected to the telecommunication network 2402. For example, the telecommunications network 2402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2412 are configured to transmit and/or receive information without direct human interaction. For instance, a UE may be designed to transmit information to the access network 2404 on a predetermined schedule, when triggered by an internal or external event, or in response to requests from the access network 2404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2414 communicates with the access network 2404 to facilitate indirect communication between one or more UEs (e.g., UE 2412c and/or 2412d) and network nodes (e.g., network node 2410b). In some examples, the hub 2414 may be a controller, router, content source and analytics, or any of the other communication devices described herein regarding UEs. For example, the hub 2414 may be a broadband router enabling access to the core network 2406 for the UEs. As another example, the hub 2414 may be a controller that sends commands or instructions to one or more actuators in the UEs. Commands or instructions may be received from the UEs, network nodes 2410, or by executable code, script, process, or other instructions in the hub 2414. As another example, the hub 2414 may be a data collector that acts as temporary storage for UE data and, in some embodiments, may perform analysis or other processing of the data. As another example, the hub 2414 may be a content source. For example, for a UE that is a VR headset, display, loudspeaker or other media delivery device, the hub 2414 may retrieve VR assets, video, audio, or other media or data related to sensory information via a network node, which the hub 2414 then provides to the UE either directly, after performing local processing, and/or after adding additional local content. In still another example, the hub 2414 acts as a proxy server or orchestrator for the UEs, in particular if one or more of the UEs are low energy IoT devices.

The hub 2414 may have a constant/persistent or intermittent connection to the network node 2410b. The hub 2414 may also allow for a different communication scheme and/or schedule between the hub 2414 and UEs (e.g., UE 2412c and/or 2412d), and between the hub 2414 and the core network 2406. In other examples, the hub 2414 is connected to the core network 2406 and/or one or more UEs via a wired connection. Moreover, the hub 2414 may be configured to connect to an M2M service provider over the access network 2404 and/or to another UE over a direct connection. In some scenarios, UEs may establish a wireless connection with the network nodes 2410 while still connected via the hub 2414 via a wired or wireless connection. In some embodiments, the hub 2414 may be a dedicated hub—that is, a hub whose primary function is to route communications to/from the UEs from/to the network node 2410b. In other embodiments, the hub 2414 may be a non-dedicated hub—that is, a device which is capable of operating to route communications between the UEs and network node 2410b, but which is additionally capable of operating as a communication start and/or end point for certain data channels.

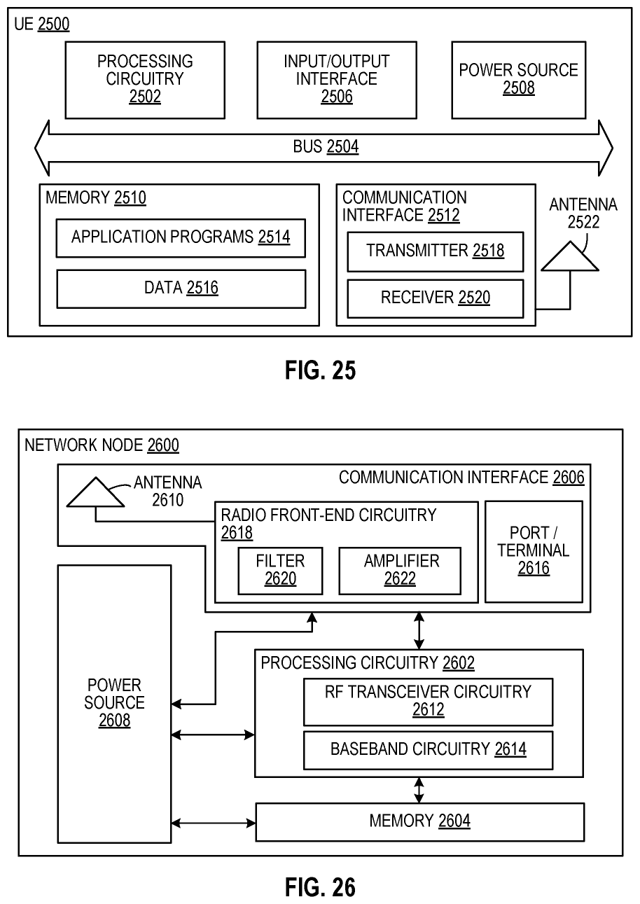

FIG. 25 shows a UE 2500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2500 includes processing circuitry 2502 that is operatively coupled via a bus 2504 to an input/output interface 2506, a power source 2508, a memory 2510, a communication interface 2512, and/or any other component, or any combination thereof. Certain UEs may utilize all or a subset of the components shown in FIG. 25. The level of integration between the components may vary from one UE to another UE. Further, certain UEs may contain multiple instances of a component, such as multiple processors, memories, transceivers, transmitters, receivers, etc.

The processing circuitry 2502 is configured to process instructions and data and may be configured to implement any sequential state machine operative to execute instructions stored as machine-readable computer programs in the memory 2510. The processing circuitry 2502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2502 may include multiple central processing units (CPUs).

In the example, the input/output interface 2506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2508 is structured as a battery or battery pack. Other types of power sources, such as an external power source (e.g., an electricity outlet), photovoltaic device, or power cell, may be used. The power source 2508 may further include power circuitry for delivering power from the power source 2508 itself, and/or an external power source, to the various parts of the UE 2500 via input circuitry or an interface such as an electrical power cable. Delivering power may be, for example, for charging of the power source 2508. Power circuitry may perform any formatting, converting, or other modification to the power from the power source 2508 to make the power suitable for the respective components of the UE 2500 to which power is supplied.

The memory 2510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2510 includes one or more application programs 2514, such as an operating system, web browser application, a widget, gadget engine, or other application, and corresponding data 2516. The memory 2510 may store, for use by the UE 2500, any of a variety of various operating systems or combinations of operating systems.

The memory 2510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2510 may allow the UE 2500 to access instructions, application programs and the like, stored on transitory or non-transitory memory media, to off-load data, or to upload data. An article of manufacture, such as one utilizing a communication system may be tangibly embodied as or in the memory 2510, which may be or comprise a device-readable storage medium.

The processing circuitry 2502 may be configured to communicate with an access network or other network using the communication interface 2512. The communication interface 2512 may comprise one or more communication subsystems and may include or be communicatively coupled to an antenna 2522. The communication interface 2512 may include one or more transceivers used to communicate, such as by communicating with one or more remote transceivers of another device capable of wireless communication (e.g., another UE or a network node in an access network). Each transceiver may include a transmitter 2518 and/or a receiver 2520 appropriate to provide network communications (e.g., optical, electrical, frequency allocations, and so forth). Moreover, the transmitter 2518 and receiver 2520 may be coupled to one or more antennas (e.g., antenna 2522) and may share circuit components, software or firmware, or alternatively be implemented separately.

In the illustrated embodiment, communication functions of the communication interface 2512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2500 shown in FIG. 25.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 26 shows a network node 2600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2600 includes a processing circuitry 2602, a memory 2604, a communication interface 2606, and a power source 2608. The network node 2600 may be composed of multiple physically separate components (e.g., a NodeB component and a RNC component, or a BTS component and a BSC component, etc.), which may each have their own respective components. In certain scenarios in which the network node 2600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2600 may be configured to support multiple radio access technologies (RATs). In such embodiments, some components may be duplicated (e.g., separate memory 2604 for different RATs) and some components may be reused (e.g., a same antenna 2610 may be shared by different RATs). The network node 2600 may also include multiple sets of the various illustrated components for different wireless technologies integrated into network node 2600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2600.

The processing circuitry 2602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2600 components, such as the memory 2604, to provide network node 2600 functionality.

In some embodiments, the processing circuitry 2602 includes a system on a chip (SOC). In some embodiments, the processing circuitry 2602 includes one or more of radio frequency (RF) transceiver circuitry 2612 and baseband processing circuitry 2614. In some embodiments, the radio frequency (RF) transceiver circuitry 2612 and the baseband processing circuitry 2614 may be on separate chips (or sets of chips), boards, or units, such as radio units and digital units. In alternative embodiments, part or all of RF transceiver circuitry 2612 and baseband processing circuitry 2614 may be on the same chip or set of chips, boards, or units.

The memory 2604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2602. The memory 2604 may store any suitable instructions, data, or information, including a computer program, software, an application including one or more of logic, rules, code, tables, and/or other instructions capable of being executed by the processing circuitry 2602 and utilized by the network node 2600. The memory 2604 may be used to store any calculations made by the processing circuitry 2602 and/or any data received via the communication interface 2606. In some embodiments, the processing circuitry 2602 and memory 2604 is integrated.

The communication interface 2606 is used in wired or wireless communication of signaling and/or data between a network node, access network, and/or UE. As illustrated, the communication interface 2606 comprises port(s)/terminal(s) 2616 to send and receive data, for example to and from a network over a wired connection. The communication interface 2606 also includes radio front-end circuitry 2618 that may be coupled to, or in certain embodiments a part of, the antenna 2610. Radio front-end circuitry 2618 comprises filters 2620 and amplifiers 2622. The radio front-end circuitry 2618 may be connected to an antenna 2610 and processing circuitry 2602. The radio front-end circuitry may be configured to condition signals communicated between antenna 2610 and processing circuitry 2602. The radio front-end circuitry 2618 may receive digital data that is to be sent out to other network nodes or UEs via a wireless connection. The radio front-end circuitry 2618 may convert the digital data into a radio signal having the appropriate channel and bandwidth parameters using a combination of filters 2620 and/or amplifiers 2622. The radio signal may then be transmitted via the antenna 2610. Similarly, when receiving data, the antenna 2610 may collect radio signals which are then converted into digital data by the radio front-end circuitry 2618. The digital data may be passed to the processing circuitry 2602. In other embodiments, the communication interface may comprise different components and/or different combinations of components.

In certain alternative embodiments, the network node 2600 does not include separate radio front-end circuitry 2618, instead, the processing circuitry 2602 includes radio front-end circuitry and is connected to the antenna 2610. Similarly, in some embodiments, all or some of the RF transceiver circuitry 2612 is part of the communication interface 2606. In still other embodiments, the communication interface 2606 includes one or more ports or terminals 2616, the radio front-end circuitry 2618, and the RF transceiver circuitry 2612, as part of a radio unit (not shown), and the communication interface 2606 communicates with the baseband processing circuitry 2614, which is part of a digital unit (not shown).

The antenna 2610 may include one or more antennas, or antenna arrays, configured to send and/or receive wireless signals. The antenna 2610 may be coupled to the radio front-end circuitry 2618 and may be any type of antenna capable of transmitting and receiving data and/or signals wirelessly. In certain embodiments, the antenna 2610 is separate from the network node 2600 and connectable to the network node 2600 through an interface or port.

The antenna 2610, communication interface 2606, and/or the processing circuitry 2602 may be configured to perform any receiving operations and/or certain obtaining operations described herein as being performed by the network node. Any information, data and/or signals may be received from a UE, another network node and/or any other network equipment. Similarly, the antenna 2610, the communication interface 2606, and/or the processing circuitry 2602 may be configured to perform any transmitting operations described herein as being performed by the network node. Any information, data and/or signals may be transmitted to a UE, another network node and/or any other network equipment.

The power source 2608 provides power to the various components of network node 2600 in a form suitable for the respective components (e.g., at a voltage and current level needed for each respective component). The power source 2608 may further comprise, or be coupled to, power management circuitry to supply the components of the network node 2600 with power for performing the functionality described herein. For example, the network node 2600 may be connectable to an external power source (e.g., the power grid, an electricity outlet) via an input circuitry or interface such as an electrical cable, whereby the external power source supplies power to power circuitry of the power source 2608. As a further example, the power source 2608 may comprise a source of power in the form of a battery or battery pack which is connected to, or integrated in, power circuitry. The battery may provide backup power should the external power source fail.

Embodiments of the network node 2600 may include additional components beyond those shown in FIG. 26 for providing certain aspects of the network node's functionality, including any of the functionality described herein and/or any functionality necessary to support the subject matter described herein. For example, the network node 2600 may include user interface equipment to allow input of information into the network node 2600 and to allow output of information from the network node 2600. This may allow a user to perform diagnostic, maintenance, repair, and other administrative functions for the network node 2600.

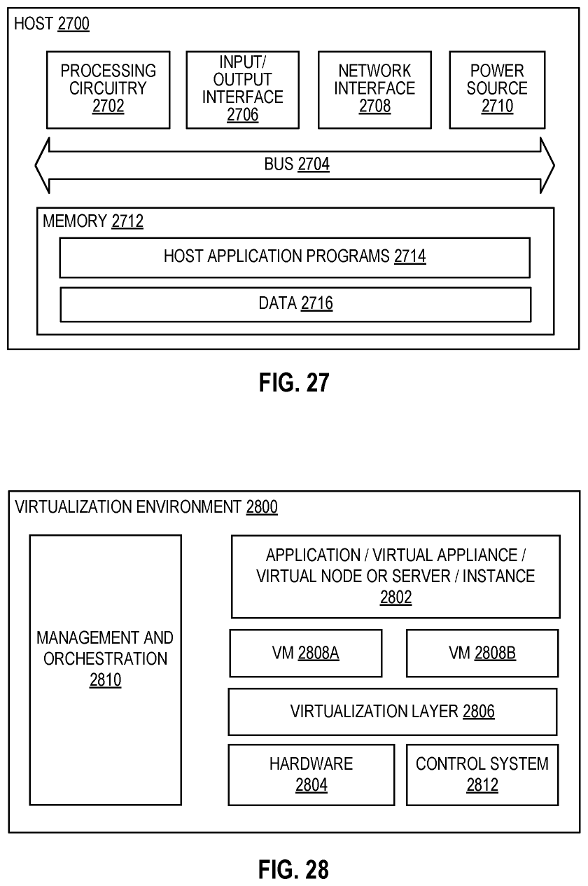

FIG. 27 is a block diagram of a host 2700, which may be an embodiment of the host 2416 of FIG. 24, in accordance with various aspects described herein. As used herein, the host 2700 may be or comprise various combinations hardware and/or software, including a standalone server, a blade server, a cloud-implemented server, a distributed server, a virtual machine, container, or processing resources in a server farm. The host 2700 may provide one or more services to one or more UEs.

The host 2700 includes processing circuitry 2702 that is operatively coupled via a bus 2704 to an input/output interface 2706, a network interface 2708, a power source 2710, and a memory 2712. Other components may be included in other embodiments. Features of these components may be substantially similar to those described with respect to the devices of previous figures, such as FIGS. 25 and 26, such that the descriptions thereof are generally applicable to the corresponding components of host 2700.

The memory 2712 may include one or more computer programs including one or more host application programs 2714 and data 2716, which may include user data, e.g., data generated by a UE for the host 2700 or data generated by the host 2700 for a UE. Embodiments of the host 2700 may utilize only a subset or all of the components shown. The host application programs 2714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2714 may also provide for user authentication and licensing checks and may periodically report health, routes, and content availability to a central node, such as a device in or on the edge of a core network. Accordingly, the host 2700 may select and/or indicate a different host for over-the-top services for a UE. The host application programs 2714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 28 is a block diagram illustrating a virtualization environment 2800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2800 includes components defined by the O-RAN Alliance, such as an O-Cloud environment orchestrated by a Service Management and Orchestration Framework via an O-2 interface.

Applications 2802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2806 (also referred to as hypervisors or virtual machine monitors (VMMs)), provide VMs 2808a and 2808b (one or more of which may be generally referred to as VMs 2808), and/or perform any of the functions, features and/or benefits described in relation with some embodiments described herein. The virtualization layer 2806 may present a virtual operating platform that appears like networking hardware to the VMs 2808.

The VMs 2808 comprise virtual processing, virtual memory, virtual networking or interface and virtual storage, and may be run by a corresponding virtualization layer 2806. Different embodiments of the instance of a virtual appliance 2802 may be implemented on one or more of VMs 2808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2808 may be a software implementation of a physical machine that runs programs as if they were executing on a physical, non-virtualized machine. Each of the VMs 2808, and that part of hardware 2804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2808 on top of the hardware 2804 and corresponds to the application 2802.

Hardware 2804 may be implemented in a standalone network node with generic or specific components. Hardware 2804 may implement some functions via virtualization. Alternatively, hardware 2804 may be part of a larger cluster of hardware (e.g. such as in a data center or CPE) where many hardware nodes work together and are managed via management and orchestration 2810, which, among others, oversees lifecycle management of applications 2802. In some embodiments, hardware 2804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2812 which may alternatively be used for communication between hardware nodes and radio units.

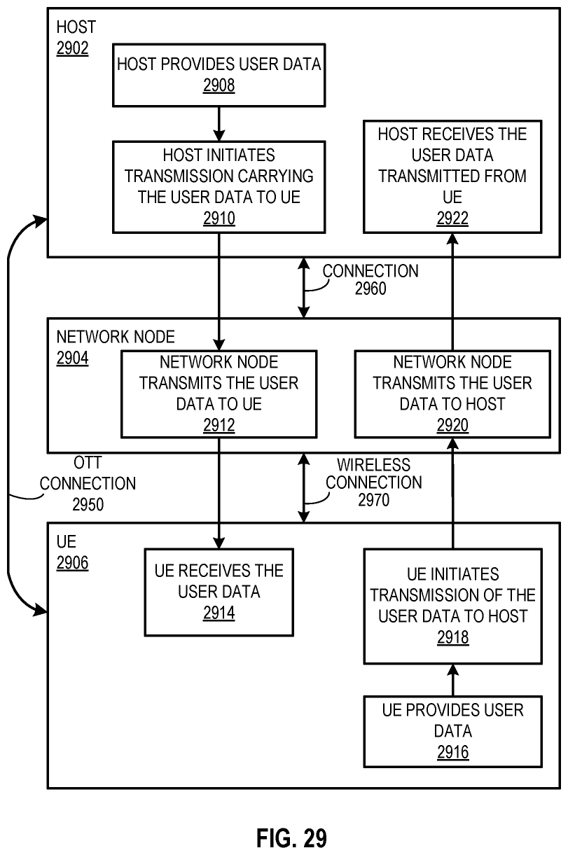

FIG. 29 shows a communication diagram of a host 2902 communicating via a network node 2904 with a UE 2906 over a partially wireless connection in accordance with some embodiments. Example implementations, in accordance with various embodiments, of the UE (such as a UE 2412a of FIG. 24 and/or UE 2500 of FIG. 25), network node (such as network node 2410a of FIG. 24 and/or network node 2600 of FIG. 26), and host (such as host 2416 of FIG. 24 and/or host 2700 of FIG. 27) discussed in the preceding paragraphs will now be described with reference to FIG. 29.

Like host 2700, embodiments of host 2902 include hardware, such as a communication interface, processing circuitry, and memory. The host 2902 also includes software, which is stored in or accessible by the host 2902 and executable by the processing circuitry. The software includes a host application that may be operable to provide a service to a remote user, such as the UE 2906 connecting via an over-the-top (OTT) connection 2950 extending between the UE 2906 and host 2902. In providing the service to the remote user, a host application may provide user data which is transmitted using the OTT connection 2950.

The network node 2904 includes hardware enabling it to communicate with the host 2902 and UE 2906. The connection 2960 may be direct or pass through a core network (like core network 2406 of FIG. 24) and/or one or more other intermediate networks, such as one or more public, private, or hosted networks. For example, an intermediate network may be a backbone network or the Internet.

The UE 2906 includes hardware and software, which is stored in or accessible by UE 2906 and executable by the UE's processing circuitry. The software includes a client application, such as a web browser or operator-specific “app” that may be operable to provide a service to a human or non-human user via UE 2906 with the support of the host 2902. In the host 2902, an executing host application may communicate with the executing client application via the OTT connection 2950 terminating at the UE 2906 and host 2902. In providing the service to the user, the UE's client application may receive request data from the host's host application and provide user data in response to the request data. The OTT connection 2950 may transfer both the request data and the user data. The UE's client application may interact with the user to generate the user data that it provides to the host application through the OTT connection 2950.

The OTT connection 2950 may extend via a connection 2960 between the host 2902 and the network node 2904 and via a wireless connection 2970 between the network node 2904 and the UE 2906 to provide the connection between the host 2902 and the UE 2906. The connection 2960 and wireless connection 2970, over which the OTT connection 2950 may be provided, have been drawn abstractly to illustrate the communication between the host 2902 and the UE 2906 via the network node 2904, without explicit reference to any intermediary devices and the precise routing of messages via these devices.

As an example of transmitting data via the OTT connection 2950, in step 2908, the host 2902 provides user data, which may be performed by executing a host application. In some embodiments, the user data is associated with a particular human user interacting with the UE 2906. In other embodiments, the user data is associated with a UE 2906 that shares data with the host 2902 without explicit human interaction. In step 2910, the host 2902 initiates a transmission carrying the user data towards the UE 2906. The host 2902 may initiate the transmission responsive to a request transmitted by the UE 2906. The request may be caused by human interaction with the UE 2906 or by operation of the client application executing on the UE 2906. The transmission may pass via the network node 2904, in accordance with the teachings of the embodiments described throughout this disclosure. Accordingly, in step 2912, the network node 2904 transmits to the UE 2906 the user data that was carried in the transmission that the host 2902 initiated, in accordance with the teachings of the embodiments described throughout this disclosure. In step 2914, the UE 2906 receives the user data carried in the transmission, which may be performed by a client application executed on the UE 2906 associated with the host application executed by the host 2902.

In some examples, the UE 2906 executes a client application which provides user data to the host 2902. The user data may be provided in reaction or response to the data received from the host 2902. Accordingly, in step 2916, the UE 2906 may provide user data, which may be performed by executing the client application. In providing the user data, the client application may further consider user input received from the user via an input/output interface of the UE 2906. Regardless of the specific manner in which the user data was provided, the UE 2906 initiates, in step 2918, transmission of the user data towards the host 2902 via the network node 2904. In step 2920, in accordance with the teachings of the embodiments described throughout this disclosure, the network node 2904 receives user data from the UE 2906 and initiates transmission of the received user data towards the host 2902. In step 2922, the host 2902 receives the user data carried in the transmission initiated by the UE 2906.

One or more of the various embodiments improve the performance of OTT services provided to the UE 2906 using the OTT connection 2950, in which the wireless connection 2970 forms the last segment.

In an example scenario, factory status information may be collected and analyzed by the host 2902. As another example, the host 2902 may process audio and video data which may have been retrieved from a UE for use in creating maps. As another example, the host 2902 may collect and analyze real-time data to assist in controlling vehicle congestion (e.g., controlling traffic lights). As another example, the host 2902 may store surveillance video uploaded by a UE. As another example, the host 2902 may store or control access to media content such as video, audio, VR or AR which it can broadcast, multicast or unicast to UEs. As other examples, the host 2902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2950 between the host 2902 and UE 2906, in response to variations in the measurement results. The measurement procedure and/or the network functionality for reconfiguring the OTT connection may be implemented in software and hardware of the host 2902 and/or UE 2906. In some embodiments, sensors (not shown) may be deployed in or in association with other devices through which the OTT connection 2950 passes; the sensors may participate in the measurement procedure by supplying values of the monitored quantities exemplified above, or supplying values of other physical quantities from which software may compute or estimate the monitored quantities. The reconfiguring of the OTT connection 2950 may include message format, retransmission settings, preferred routing etc.; the reconfiguring need not directly alter the operation of the network node 2904. Such procedures and functionalities may be known and practiced in the art. In certain embodiments, measurements may involve proprietary UE signaling that facilitates measurements of throughput, propagation times, latency and the like, by the host 2902. The measurements may be implemented in that software causes messages to be transmitted, in particular empty or ‘dummy’ messages, using the OTT connection 2950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some embodiments herein may be enumerated as below:

### Group A Embodiments

A1. A method performed by a communication device, the method comprising:
receiving, from a network node in a communication network, a conditional reconfiguration that indicates:
   a configuration of a candidate target cell;
   a first condition that the communication device is to evaluate, for determining whether to apply the configuration, when the communication device is not configured with a serving Primary Secondary Cell Group, SCG, Cell, PSCell; and
   a second condition that the communication device is to evaluate, for determining whether to apply the configuration, when the communication device is configured with a serving PSCell.
      A2. The method of embodiment A1, wherein the communication device is to evaluate the first condition when the communication device is not configured with a serving PSCell, for determining whether to apply the configuration for adding the candidate target cell as a serving PSCell, and wherein the communication device is to evaluate the second condition when the communication device is configured with a serving PSCell, for determining whether to apply the configuration for changing a serving PSCell from a source cell to the candidate target cell.
      A3. The method of any of embodiments A1-A2, wherein the conditional reconfiguration includes an execution condition field that indicates both the first and second conditions.
      A4. The method of embodiment A3, wherein the execution condition field identifies a measurement configuration, wherein the measurement configuration is associated with a reporting configuration, wherein the reporting configuration indicates both the first and second conditions.
      A5. The method of embodiment A4, wherein the reporting configuration indicates an event whose occurrence is to trigger the communication device to apply the configuration, wherein the event is defined to occur:
when the first condition is fulfilled while the communication device is not configured with a serving PSCell; and
when the second condition is fulfilled while the communication device is configured with a serving PSCell.
   A6. The method of embodiment A5, wherein:
the first condition is a function of results of one or more measurements performed on the candidate target cell, and is not a function of results of any measurements performed on a serving PSCell; and
the second condition is a function of both results of one or more measurements performed on the candidate target cell and results of one or more measurements performed on a serving PSCell.
   A7. The method of any of embodiments A5-A6, wherein the event is defined to occur when an entering condition is satisfied and a leaving condition is not satisfied, wherein:
the entering condition is defined to be satisfied:
   when a first subcondition is fulfilled while the communication device is not configured with a serving PSCell; and
   when both the first subcondition and a second subcondition are fulfilled while the communication device is configured with a serving PSCell; and
the leaving condition is defined to be satisfied:
   when a third subcondition is fulfilled while the communication device is not configured with a serving PSCell; and
   when either the third subcondition or a fourth subcondition are fulfilled while the communication device is configured with a serving PSCell;
wherein the first condition is fulfilled when the first subcondition is fulfilled and the third subcondition is not fulfilled while the communication device is not configured with a serving PSCell;
wherein the second condition is fulfilled when the first subcondition and the second subcondition are fulfilled, and neither the third subcondition nor the fourth subcondition are fulfilled, while the communication device is configured with a serving PSCell.
   A8. The method of any of embodiments A5-A7, wherein the event is an A5 Event, an A4 Event, an A5-CPAC Event, or an A4-CPAC Event
   A9. The method of any of embodiments A5-A6, wherein the event is defined to occur when an entering condition is satisfied and a leaving condition is not satisfied, wherein:
the entering condition is defined to be satisfied:
   when a first subcondition is fulfilled while the communication device is not configured with a serving PSCell; and
   when a second subcondition is fulfilled while the communication device is configured with a serving PSCell; and
the leaving condition is defined to be satisfied:
   when a third subcondition is fulfilled while the communication device is not configured with a serving PSCell; and
   when a fourth subcondition is fulfilled while the communication device is configured with a serving PSCell;
wherein the first condition is fulfilled when the first subcondition is fulfilled and the third subcondition is not fulfilled while the communication device is not configured with a serving PSCell;
wherein the second condition is fulfilled when the second subcondition is fulfilled and the fourth subcondition is not fulfilled while the communication device is configured with a serving PSCell.
   A10. The method of any of embodiments A5-A7 and A9, wherein the event is an A3 Event or an A3-CPAC Event.
   A11. The method of embodiment A4, wherein the reporting configuration indicates first and second events whose occurrence is to trigger the communication device to apply the configuration while the communication device is and is not configured with a serving PSCell, respectively, wherein the first condition is fulfilled when the first event occurs and the second condition is fulfilled when the second even occurs.
   A12. The method of embodiment A3, wherein the execution condition field identifies a measurement configuration, wherein the measurement configuration is associated with first and second reporting configurations, wherein the first reporting configuration indicates the first condition and the second reporting configuration indicates the second condition.
   A13. The method of embodiment A12, wherein the first reporting configuration indicates a first event whose occurrence is to trigger the communication device to apply the configuration, wherein the first event is defined to occur when the first condition is fulfilled while the communication device is not configured with a serving PSCell, wherein the second reporting configuration indicates a second event whose occurrence is to trigger the communication device to apply the configuration, wherein the second event is defined to occur when the second condition is fulfilled while the communication device is configured with a serving PSCell.
   A14. The method of embodiment A13, wherein the first and second reporting configurations have a same reporting configuration identifier.
   A15. The method of embodiment A3, wherein the execution condition field identifies first and second measurement configurations, wherein the first measurement configuration is associated with a first reporting configuration and wherein the second measurement configuration is associated with a second reporting configuration, wherein the first reporting configuration indicates the first condition and the second reporting configuration indicates the second condition.
   A16. The method of embodiment A15, wherein the first reporting configuration indicates a first event whose occurrence is to trigger the communication device to apply the configuration, wherein the first event is defined to occur when the first condition is fulfilled while the communication device is not configured with a serving PSCell, wherein the second reporting configuration indicates a second event whose occurrence is to trigger the communication device to apply the configuration, wherein the second event is defined to occur when the second condition is fulfilled while the communication device is configured with a serving PSCell.
   A17. The method of any of embodiments A15-A16, wherein the first and second measurement configurations have a same measurement configuration identifier.
   A18. The method of embodiment A3, wherein the execution condition field identifies first and second measurement configurations, wherein the first measurement configuration is associated with a first reporting configuration and wherein the second measurement configuration is associated with a second reporting configuration, wherein the first reporting configuration indicates the first condition and the second reporting configuration indicates the second condition.
   A19. The method of embodiment A18, wherein the first and second measurement configurations have different measurement configuration identifiers.
   A20. The method of embodiment A3, wherein the execution condition field identifies first and second measurement configuration sets, wherein the first measurement configuration set includes one or more first measurement configurations that are respectively associated with one or more first reporting configurations and wherein the second measurement configuration set includes one or more second measurement configurations that are respectively associated with one or more second reporting configurations, wherein the one or more first reporting configurations indicate the first condition and the one or more second reporting configurations indicate the second condition.
   A21. The method of any of embodiments A1-A2, wherein the conditional reconfiguration includes first and second execution condition fields that respectively indicate the first and second conditions.
   A22. The method of embodiment A21, wherein the first and second execution condition fields identify first and second measurement configurations, respectively, wherein the first and second measurement configurations are respectively associated with first and second reporting configurations, wherein the first and second reporting configurations respectively indicate the first and second conditions.
   A23. The method of embodiment A22, wherein the first reporting configuration indicates a first event whose occurrence is to trigger the communication device to apply the configuration, wherein the first event is defined to occur when the first condition is fulfilled while the communication device is not configured with a serving PSCell, wherein the second reporting configuration indicates a second event whose occurrence is to trigger the communication device to apply the configuration, wherein the second event is defined to occur when the second condition is fulfilled while the communication device is configured with a serving PSCell.
   A24. The method of any of embodiments A1-A23, wherein the first condition is a function of results of one or more measurements performed on the candidate target cell and is not a function of results of any measurements performed on a serving PSCell, and wherein the second condition is a function of both results of one or more measurements performed on the candidate target cell and results of one or more measurements performed on a serving PSCell.
   A25. The method of any of embodiments A1-A24, wherein the condition reconfiguration corresponds to a conditional PSCell addition configuration when the communication device is not configured with a serving PSCell and corresponds to a conditional PSCell change configuration when the communication device is configured with a serving PSCell.
   A26. The method of any of embodiments A1-A25, wherein the conditional reconfiguration is reusable for PSCell addition or PSCell change.
   A27. The method of any of embodiments A1-A26, further comprising:
making a determination as to whether or not the communication device is configured with a serving PSCell; and
based on the determination, evaluating the first or the second condition for determining whether to apply the configuration.
   A28. The method of embodiment A27, further comprising, responsive to determining to apply the configuration, applying the configuration.
   A29. The method of embodiment A28, wherein applying the configuration comprises adding the candidate target cell as a serving PSCell or changing a serving PSCell from a source cell to the candidate target cell, depending on whether or not the communication device is configured with a serving PSCell.
   A30. The method of any of embodiments A1-A29, further comprising, after applying the configuration for PSCell addition, re-using the configuration for PSCell change.
   A31. The method of any of embodiments A1-A30, further comprising:
evaluating the first condition when the communication device is not configured with a serving PSCell, for determining whether to apply the configuration for adding the candidate target cell as a serving PSCell; and/or
evaluating the second condition when the communication device is configured with a serving PSCell, for determining whether to apply the configuration for changing a serving PSCell from a source cell to the candidate target cell.
   AA1. A method performed by a communication device, the method comprising:
receiving, from a network node in a communication network, a conditional reconfiguration that indicates a configuration of a candidate target cell and an condition under which the communication device is to apply the configuration; and
after receiving the conditional reconfiguration, receiving, from the network node, signaling that changes the condition under which the communication device is to apply the configuration.
   AA2. The method of embodiment AA1, further comprising:
before receiving the signaling, detecting fulfilment of the condition and applying the configuration for adding the candidate target cell as a serving PSCell;
wherein the signaling is received after applying the configuration for adding the candidate target cell as a serving PSCell, receiving.
   AA3. The method of embodiment AA2, further comprising, after receiving the signaling, detecting fulfilment of the changed condition and applying the configuration for changing a serving PSCell from a source cell to the candidate target cell.
   AA4. The method of any of embodiments AA1-AA3, wherein the conditional reconfiguration includes an execution condition field whose value indicates the condition, wherein the signaling changes the condition by indicating a changed value for the execution condition field.
   AA5. The method of any of embodiments AA1-AA3, wherein the conditional reconfiguration includes an execution condition field, wherein the execution condition field identifies a measurement configuration that indicates the condition, wherein the signaling changes the condition by indicating a different measurement configuration for the conditional reconfiguration.
   AAA1. A method performed by a communication device, the method comprising:
receiving, from a network node in a communication network, a conditional reconfiguration that includes a configuration of a candidate target cell;
making a determination as to whether or not the communication device is configured with a serving Primary Secondary Cell Group, SCG, Cell, PSCell;
based on whether or not the communication device is configured with a serving PSCell, applying the configuration for adding the candidate target cell as a serving PSCell or for changing a serving PSCell from a source cell to the candidate target cell.
   AAA2. The method of embodiment AAA1, further comprising determining which condition to evaluate for deciding whether or not to apply the configuration, based on whether or not the communication device is configured with a serving PSCell.
   AA. The method of any of the previous embodiments, further comprising:
providing user data; and
forwarding the user data to a host computer via the transmission to a base station.

### Group B Embodiments

B1. A method performed by a network node in a communication network, the method comprising:
transmitting, to a communication device, a conditional reconfiguration that indicates:
   a configuration of a candidate target cell;
   a first condition that the communication device is to evaluate, for determining whether to apply the configuration, when the communication device is not configured with a serving Primary Secondary Cell Group, SCG, Cell, PSCell; and
   a second condition that the communication device is to evaluate, for determining whether to apply the configuration, when the communication device is configured with a serving PSCell.
      B2. The method of embodiment B1, wherein the communication device is to evaluate the first condition when the communication device is not configured with a serving PSCell, for determining whether to apply the configuration for adding the candidate target cell as a serving PSCell, and wherein the communication device is to evaluate the second condition when the communication device is configured with a serving PSCell, for determining whether to apply the configuration for changing a serving PSCell from a source cell to the candidate target cell.
      B3. The method of any of embodiments B1-B2, wherein the conditional reconfiguration includes an execution condition field that indicates both the first and second conditions.
      B4. The method of embodiment B3, wherein the execution condition field identifies a measurement configuration, wherein the measurement configuration is associated with a reporting configuration, wherein the reporting configuration indicates both the first and second conditions.
      B5. The method of embodiment B4, wherein the reporting configuration indicates an event whose occurrence is to trigger the communication device to apply the configuration, wherein the event is defined to occur:
when the first condition is fulfilled while the communication device is not configured with a serving PSCell; and
when the second condition is fulfilled while the communication device is configured with a serving PSCell.
   B6. The method of embodiment B5, wherein:
the first condition is a function of results of one or more measurements performed on the candidate target cell, and is not a function of results of any measurements performed on a serving PSCell; and
the second condition is a function of both results of one or more measurements performed on the candidate target cell and results of one or more measurements performed on a serving PSCell.
   B7. The method of any of embodiments B5-B6, wherein the event is defined to occur when an entering condition is satisfied and a leaving condition is not satisfied, wherein:
the entering condition is defined to be satisfied:
   when a first subcondition is fulfilled while the communication device is not configured with a serving PSCell; and
   when both the first subcondition and a second subcondition are fulfilled while the communication device is configured with a serving PSCell; and
the leaving condition is defined to be satisfied:
   when a third subcondition is fulfilled while the communication device is not configured with a serving PSCell; and
   when either the third subcondition or a fourth subcondition are fulfilled while the communication device is configured with a serving PSCell;
wherein the first condition is fulfilled when the first subcondition is fulfilled and the third subcondition is not fulfilled while the communication device is not configured with a serving PSCell;
wherein the second condition is fulfilled when the first subcondition and the second subcondition are fulfilled, and neither the third subcondition nor the fourth subcondition are fulfilled, while the communication device is configured with a serving PSCell.
   B8. The method of any of embodiments B5-B7, wherein the event is an A5 Event, an A4 Event, an A5-CPAC Event, or an A4-CPAC Event.
   B9. The method of any of embodiments B5-B6, wherein the event is defined to occur when an entering condition is satisfied and a leaving condition is not satisfied, wherein:
the entering condition is defined to be satisfied:
   when a first subcondition is fulfilled while the communication device is not configured with a serving PSCell; and
   when a second subcondition is fulfilled while the communication device is configured with a serving PSCell; and
the leaving condition is defined to be satisfied:
   when a third subcondition is fulfilled while the communication device is not configured with a serving PSCell; and
   when a fourth subcondition is fulfilled while the communication device is configured with a serving PSCell;
wherein the first condition is fulfilled when the first subcondition is fulfilled and the third subcondition is not fulfilled while the communication device is not configured with a serving PSCell;
wherein the second condition is fulfilled when the second subcondition is fulfilled and the fourth subcondition is not fulfilled while the communication device is configured with a serving PSCell.
   B10. The method of any of embodiments B5-B7 and B9, wherein the event is an A3 Event or an A3-CPAC Event.
   B11. The method of embodiment B4, wherein the reporting configuration indicates first and second events whose occurrence is to trigger the communication device to apply the configuration while the communication device is and is not configured with a serving PSCell, respectively, wherein the first condition is fulfilled when the first event occurs and the second condition is fulfilled when the second even occurs.
   B12. The method of embodiment B3, wherein the execution condition field identifies a measurement configuration, wherein the measurement configuration is associated with first and second reporting configurations, wherein the first reporting configuration indicates the first condition and the second reporting configuration indicates the second condition.
   B13. The method of embodiment B12, wherein the first reporting configuration indicates a first event whose occurrence is to trigger the communication device to apply the configuration, wherein the first event is defined to occur when the first condition is fulfilled while the communication device is not configured with a serving PSCell, wherein the second reporting configuration indicates a second event whose occurrence is to trigger the communication device to apply the configuration, wherein the second event is defined to occur when the second condition is fulfilled while the communication device is configured with a serving PSCell.
   B14. The method of embodiment B13, wherein the first and second reporting configurations have a same reporting configuration identifier.
   B15. The method of embodiment B3, wherein the execution condition field identifies first and second measurement configurations, wherein the first measurement configuration is associated with a first reporting configuration and wherein the second measurement configuration is associated with a second reporting configuration, wherein the first reporting configuration indicates the first condition and the second reporting configuration indicates the second condition.
   B16. The method of embodiment B15, wherein the first reporting configuration indicates a first event whose occurrence is to trigger the communication device to apply the configuration, wherein the first event is defined to occur when the first condition is fulfilled while the communication device is not configured with a serving PSCell, wherein the second reporting configuration indicates a second event whose occurrence is to trigger the communication device to apply the configuration, wherein the second event is defined to occur when the second condition is fulfilled while the communication device is configured with a serving PSCell.
   B17. The method of any of embodiments B15-B16, wherein the first and second measurement configurations have a same measurement configuration identifier.
   B18. The method of embodiment B3, wherein the execution condition field identifies first and second measurement configurations, wherein the first measurement configuration is associated with a first reporting configuration and wherein the second measurement configuration is associated with a second reporting configuration, wherein the first reporting configuration indicates the first condition and the second reporting configuration indicates the second condition.
   B19. The method of embodiment B18, wherein the first and second measurement configurations have different measurement configuration identifiers.
   B20. The method of embodiment B3, wherein the execution condition field identifies first and second measurement configuration sets, wherein the first measurement configuration set includes one or more first measurement configurations that are respectively associated with one or more first reporting configurations and wherein the second measurement configuration set includes one or more second measurement configurations that are respectively associated with one or more second reporting configurations, wherein the one or more first reporting configurations indicate the first condition and the one or more second reporting configurations indicate the second condition.
   B21. The method of any of embodiments B1-B2, wherein the conditional reconfiguration includes first and second execution condition fields that respectively indicate the first and second conditions.
   B22. The method of embodiment B21, wherein the first and second execution condition fields identify first and second measurement configurations, respectively, wherein the first and second measurement configurations are respectively associated with first and second reporting configurations, wherein the first and second reporting configurations respectively indicate the first and second conditions.
   B23. The method of embodiment B22, wherein the first reporting configuration indicates a first event whose occurrence is to trigger the communication device to apply the configuration, wherein the first event is defined to occur when the first condition is fulfilled while the communication device is not configured with a serving PSCell, wherein the second reporting configuration indicates a second event whose occurrence is to trigger the communication device to apply the configuration, wherein the second event is defined to occur when the second condition is fulfilled while the communication device is configured with a serving PSCell.
   B24. The method of any of embodiments B1-B23, wherein the first condition is a function of results of one or more measurements performed on the candidate target cell and is not a function of results of any measurements performed on a serving PSCell, and wherein the second condition is a function of both results of one or more measurements performed on the candidate target cell and results of one or more measurements performed on a serving PSCell.
   B25. The method of any of embodiments B1-B24, wherein the condition reconfiguration corresponds to a conditional PSCell addition configuration when the communication device is not configured with a serving PSCell and corresponds to a conditional PSCell change configuration when the communication device is configured with a serving PSCell.
   B26. The method of any of embodiments B1-B25, wherein the conditional reconfiguration is reusable for PSCell addition or PSCell change.
   BB1. A method performed by a network node in a communication network, the method comprising:
transmitting, to a communication device, a conditional reconfiguration that indicates a configuration of a candidate target cell and a condition under which the communication device is to apply the configuration; and
after transmitting the conditional reconfiguration, transmitting, to the communication device, signaling that changes the condition under which the communication device is to apply the configuration.
   BB2. The method of embodiment BB1, wherein the conditional reconfiguration includes an execution condition field whose value indicates the condition, wherein the signaling changes the condition by indicating a changed value for the execution condition field.
   BB3. The method of any of embodiments BB1-BB2, wherein the conditional reconfiguration includes an execution condition field, wherein the execution condition field identifies a measurement configuration that indicates the condition, wherein the signaling changes the condition by indicating a different measurement configuration for the conditional reconfiguration.
   BB. The method of any of the previous embodiments, further comprising:
obtaining user data; and
forwarding the user data to a host computer or a communication device.

### Group C Embodiments

C1. A communication device configured to perform the method of any of the Group A embodiments.
C2. A communication device comprising processing circuitry configured to perform the method of any of the Group A embodiments.
C3. A communication device comprising:
communication circuitry; and
processing circuitry configured to perform the method of any of the Group A embodiments.
   C4. A communication device comprising:
processing circuitry configured to perform the method of any of the Group A embodiments; and
power supply circuitry configured to supply power to the communication device.
   C5. A communication device comprising:

processing circuitry and memory, the memory containing instructions executable by the processing circuitry whereby the communication device is configured to perform the method of any of the Group A embodiments.

C6. The communication device of any of embodiments C1-C5, wherein the communication device is a wireless communication device.
C7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform the method of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C8. A computer program comprising instructions which, when executed by at least one processor of a communication device, causes the communication device to perform the method of any of the Group A embodiments.
   C9. A carrier containing the computer program of embodiment C7, wherein the carrier is one of an electronic signal, optical signal, radio signal, or computer readable storage medium.
   C10. A network node configured to perform the method of any of the Group B embodiments.
   C11. A network node comprising processing circuitry configured to perform the method of any of the Group B embodiments.
   C12. A network node comprising:
communication circuitry; and
processing circuitry configured to perform the method of any of the Group B embodiments.
   C13. A network node comprising:
processing circuitry configured to perform the method of any of the Group B embodiments;
power supply circuitry configured to supply power to the network node.
   C14. A network node comprising:
processing circuitry and memory, the memory containing instructions executable by the processing circuitry whereby the network node is configured to perform the method of any of the Group B embodiments.
   C15. The network node of any of embodiments C10-C14, wherein the network node is a base station.
   C16. A computer program comprising instructions which, when executed by at least one processor of a network node, causes the network node to perform the method of any of the Group B embodiments.
   C17. The computer program of embodiment C16, wherein the network node is a base station.
   C18. A carrier containing the computer program of any of embodiments C16-C17, wherein the carrier is one of an electronic signal, optical signal, radio signal, or computer readable storage medium.

### Group D Embodiments

D1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
   D2. The host of the previous embodiment, wherein:
the processing circuitry of the host is configured to execute a host application that provides the user data; and
the UE comprises processing circuitry configured to execute a client application associated with the host application to receive the transmission of user data from the host.
   D3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.
   D4. The method of the previous embodiment, further comprising, at the network node, transmitting the user data provided by the host for the UE.
   D5. The method of any of the previous 2 embodiments, wherein the user data is provided at the host by executing a host application that interacts with a client application executing on the UE, the client application being associated with the host application.
   D6. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
   D7. The communication system of the previous embodiment, further comprising:
the network node; and/or
the UE.
   D8. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
   D9. The host of the previous 2 embodiments, wherein:
the processing circuitry of the host is configured to execute a host application that receives the user data; and
the host application is configured to interact with a client application executing on the UE, the client application being associated with the host application.
   D10. The host of the any of the previous 2 embodiments, wherein the initiating receipt of the user data comprises requesting the user data.
   D11. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.
   D12. The method of the previous embodiment, further comprising at the network node, transmitting the received user data to the host.
   D13. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.
   D14. The host of the previous embodiment, wherein the cellular network further includes a network node configured to communicate with the UE to transmit the user data to the UE from the host.
   D15. The host of the previous 2 embodiments, wherein:
the processing circuitry of the host is configured to execute a host application, thereby providing the user data; and
the host application is configured to interact with a client application executing on the UE, the client application being associated with the host application.
   D16. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.
   D17. The method of the previous embodiment, further comprising:
at the host, executing a host application associated with a client application executing on the UE to receive the user data from the host application.
   D18. The method of the previous embodiment, further comprising:
at the host, transmitting input data to the client application executing on the UE, the input data being provided by executing the host application,
wherein the user data is provided by the client application in response to the input data from the host application.
   D19. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
   D20. The host of the previous embodiment, wherein the cellular network further includes a network node configured to communicate with the UE to transmit the user data from the UE to the host.
   D21. The host of the previous 2 embodiments, wherein:
the processing circuitry of the host is configured to execute a host application, thereby providing the user data; and
the host application is configured to interact with a client application executing on the UE, the client application being associated with the host application.
   D22. A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.
   D23. The method of the previous embodiment, further comprising:
at the host, executing a host application associated with a client application executing on the UE to receive the user data from the UE.
   D24. The method of the previous 2 embodiments, further comprising:
at the host, transmitting input data to the client application executing on the UE, the input data being provided by executing the host application,
wherein the user data is provided by the client application in response to the input data from the host application.

1.-39. (canceled)

40. A method performed by a user equipment (UE) for re-using a conditional reconfiguration both for conditional addition of a primary cell of a secondary cell group (PSCell) in multi-connectivity operation and for conditional change of a PSCell in multi-connectivity operation, the method comprising:
receiving conditional reconfigurations for respective PSCell target candidate cells, wherein the conditional reconfigurations are either conditional PSCell addition (CPA) configurations or conditional PSCell change (CPC) configurations;
wherein each of the conditional reconfigurations includes:
a first execution condition that needs to be fulfilled in order to trigger execution of the conditional reconfiguration; and
a PSCell target candidate configuration that is a configuration to be applied towards the PSCell target candidate cell of the conditional reconfiguration when the conditional reconfiguration is executed;
wherein each of at least one of the conditional reconfigurations also includes information about how to, upon execution of the conditional reconfiguration, update the first execution condition of, or add a second execution condition to, each of one or more others of the conditional reconfigurations, wherein the information is included in the conditional reconfiguration outside of the PSCell target candidate configuration of the conditional reconfiguration.

41. The method of claim 40, wherein the information included in each of the at least one of the conditional reconfigurations is information about how to, upon execution of the conditional reconfiguration, add a second execution condition to each of one or more others of the conditional reconfigurations.

42. The method of claim 41, wherein the conditional reconfigurations are CPA configurations, and wherein the information in each of at least one of the conditional reconfigurations is information about how to, upon execution of the conditional reconfiguration, add a second execution condition to each of one or more others of the conditional reconfigurations in order to configure the other conditional reconfiguration to be re-usable as a CPC configuration.

43. The method of claim 42, wherein the information included in each of the at least one of the conditional reconfigurations is information about how to, upon execution of the conditional reconfiguration towards the PSCell target candidate cell of the conditional reconfiguration, add a second execution condition to each of one or more others of the conditional reconfigurations in order to configure the other conditional reconfiguration to be re-usable as a CPC configuration that is based on the PSCell target candidate cell of the conditional configuration being a serving PSCell for the UE.

44. The method of claim 41, wherein, for each of the one or more others of the conditional reconfigurations to which a second execution condition is added:
the first execution condition needs to be fulfilled in order to trigger execution of the conditional reconfiguration when the UE is not configured with any serving PSCell configuration or with any secondary cell group (SCG); and
the second execution condition needs to be fulfilled in order to trigger execution of the conditional reconfiguration when the UE is configured with a serving PSCell configuration or with an SCG.

45. The method of claim 41, wherein, for each of the one or more others of the conditional reconfigurations to which a second execution condition is added:
the first execution condition is associated with conditional event A4; and
the second execution condition is associated with conditional event A3 or conditional event A5.

46. The method of claim 41, wherein the information included in each of the at least one of the conditional reconfigurations comprises the second execution condition to be added to each of the one or more other conditional reconfigurations.

47. The method of claim 41, wherein, for each of the one or more others of the conditional reconfigurations to which a second execution condition is added, the second execution condition is added in a condExecutionCondSCG information element of the conditional reconfiguration.

48. The method of claim 40, wherein, for each of the conditional reconfigurations, the first execution condition is included in a condExecutionCond information element of the conditional reconfiguration.

49. The method of claim 40, wherein receiving the conditional reconfigurations comprises receiving the conditional reconfigurations when the UE is not configured with any serving PSCell configuration or with any SCG.

50. The method of claim 40, wherein the information included in each of the at least one of the conditional reconfigurations is information about how to, upon execution of the conditional reconfiguration, update the first execution condition of each of one or more others of the conditional reconfigurations in order to change the other conditional reconfiguration from a CPA configuration to a CPC configuration or from a CPC configuration to a CPA configuration.

51. The method of claim 40, wherein receiving the conditional reconfigurations comprises receiving one or more radio resource control (RRC) reconfiguration messages, wherein each RRC reconfiguration message includes a condReconfig ToAddModList information element that comprises a list of one or more of the conditional reconfigurations.

52. The method of claim 40, further comprising:
detecting fulfillment of the execution condition included in a first conditional reconfiguration among said conditional reconfigurations;
executing the first conditional reconfiguration based on said detecting; and
upon executing the first conditional reconfiguration, updating the first execution condition of, or adding a second execution condition to, each of one or more others of the conditional reconfigurations according to the information included in the first conditional reconfiguration about how to perform said updating or adding.

53. The method of claim 52, wherein said updating or adding comprises adding a second execution condition to each of one or more others of the conditional reconfigurations according to the information included in the first conditional reconfiguration about how to perform said updating or adding, and wherein the method further comprises, after said adding:
for each of the one or more others of the conditional reconfigurations to which a second execution condition is added, determining whether to execute the conditional reconfiguration by evaluating whether the second execution condition is fulfilled;
receiving a message that configures a release of a PSCell configuration of the UE; and
after receiving the message, for each of the one or more others of the conditional reconfigurations to which a second execution condition is added, determining whether to execute the conditional reconfiguration by evaluating whether the first execution condition is fulfilled.

54. A method performed by a network node in a communication network for enabling a user equipment (UE) to re-use a conditional reconfiguration both for conditional addition of a primary cell of a secondary cell group (PSCell) in multi-connectivity operation and for conditional change of a PSCell in multi-connectivity operation, the method comprising:
transmitting, to the UE, conditional reconfigurations for respective PSCell target candidate cells, wherein the conditional reconfigurations are either conditional PSCell addition (CPA) configurations or conditional PSCell change (CPC) configurations;
wherein each of the conditional reconfigurations includes:
a first execution condition that needs to be fulfilled in order to trigger execution of the conditional reconfiguration; and
a PSCell target candidate configuration that is a configuration to be applied towards the PSCell target candidate cell of the conditional reconfiguration when the conditional reconfiguration is executed;
wherein each of at least one of the conditional reconfigurations also includes information about how to, upon execution of the conditional reconfiguration, update the first execution condition of, or add a second execution condition to, each of one or more others of the conditional reconfiguration, wherein the information is included in the conditional reconfiguration outside of the PSCell target candidate configuration of the conditional reconfiguration.

55. The method of claim 54, wherein, for each of the one or more others of the conditional reconfigurations to which a second execution condition is added:
the first execution condition needs to be fulfilled in order to trigger execution of the conditional reconfiguration when the UE is not configured with any serving PSCell configuration or with any secondary cell group (SCG); and
the second execution condition needs to be fulfilled in order to trigger execution of the conditional reconfiguration when the UE is configured with a serving PSCell configuration or with an SCG.

56. The method of claim 54, wherein, for each of the one or more others of the conditional reconfigurations to which a second execution condition is added:
the first execution condition is associated with conditional event A4; and
the second execution condition is associated with conditional event A3 or conditional event A5.

57. The method of claim 54, wherein transmitting the conditional reconfigurations comprises transmitting the conditional reconfigurations when the UE is not configured with any serving PSCell configuration or with any SCG.

58. The method of claim 54, wherein transmitting the conditional reconfigurations comprises transmitting one or more radio resource control (RRC) reconfiguration messages, wherein each RRC reconfiguration message includes a condReconfig ToAddModList information element that comprises a list of one or more of the conditional reconfigurations.

59. A user equipment (UE) configured for re-using a conditional reconfiguration both for conditional addition of a primary cell of a secondary cell group (PSCell) in multi-connectivity operation and for conditional change of a PSCell in multi-connectivity operation, the UE comprising:
communication circuitry; and
processing circuitry configured to receive conditional reconfigurations for respective PSCell target candidate cells, wherein the conditional reconfigurations are either conditional PSCell addition (CPA) configurations or conditional PSCell change (CPC) configurations;
wherein each of the conditional reconfigurations includes:
a first execution condition that needs to be fulfilled in order to trigger execution of the conditional reconfiguration; and
a PSCell target candidate configuration that is a configuration to be applied towards the PSCell target candidate cell of the conditional reconfiguration when the conditional reconfiguration is executed;
wherein each of at least one of the conditional reconfigurations also includes information about how to, upon execution of the conditional reconfiguration, update the first execution condition of, or add a second execution condition to, each of one or more others of the conditional reconfigurations.

60. The UE of claim 59, wherein the information included in each of the at least one of the conditional reconfigurations is information about how to, upon execution of the conditional reconfiguration, add a second execution condition to each of one or more others of the conditional reconfigurations.

61. The UE of claim 60, wherein the conditional reconfigurations are CPA configurations, and wherein the information in each of at least one of the conditional reconfigurations is information about how to, upon execution of the conditional reconfiguration, add a second execution condition to each of one or more others of the conditional reconfigurations in order to configure the other conditional reconfiguration to be re-usable as a CPC configuration.

62. The UE of claim 61, wherein the information included in each of the at least one of the conditional reconfigurations is information about how to, upon execution of the conditional reconfiguration towards the PSCell target candidate cell of the conditional reconfiguration, add a second execution condition to each of one or more others of the conditional reconfigurations in order to configure the other conditional reconfiguration to be re-usable as a CPC configuration that is based on the PSCell target candidate cell of the conditional configuration being a serving PSCell for the UE.

63. The UE of claim 60, wherein, for each of the one or more others of the conditional reconfigurations to which a second execution condition is added:
the first execution condition needs to be fulfilled in order to trigger execution of the conditional reconfiguration when the UE is not configured with any serving PSCell configuration or with any secondary cell group (SCG); and
the second execution condition needs to be fulfilled in order to trigger execution of the conditional reconfiguration when the UE is configured with a serving PSCell configuration or with an SCG.

64. The UE of claim 59, wherein the processing circuitry is further configured to:
detect fulfillment of the execution condition included in a first conditional reconfiguration among said conditional reconfigurations;
execute the first conditional reconfiguration based on said detecting; and
upon executing the first conditional reconfiguration, update the first execution condition of, or add a second execution condition to, each of one or more others of the conditional reconfigurations according to the information included in the first conditional reconfiguration about how to perform said updating or adding.

65. A network node configured for use in a communication network for enabling a user equipment (UE) to re-use a conditional reconfiguration both for conditional addition of a primary cell of a secondary cell group (PSCell) in multi-connectivity operation and for conditional change of a PSCell in multi-connectivity operation, the network node comprising:
communication circuitry; and
processing circuitry configured to transmit, via the communication circuitry, to the UE, conditional reconfigurations for respective PSCell target candidate cells, wherein the conditional reconfigurations are either conditional PSCell addition (CPA) configurations or conditional PSCell change (CPC) configurations;
wherein each of the conditional reconfigurations includes:
a first execution condition that needs to be fulfilled in order to trigger execution of the conditional reconfiguration; and
a PSCell target candidate configuration that is a configuration to be applied towards the PSCell target candidate cell of the conditional reconfiguration when the conditional reconfiguration is executed;
wherein each of at least one of the conditional reconfigurations also includes information about how to, upon execution of the conditional reconfiguration, update the first execution condition of, or add a second execution condition to, each of one or more others of the conditional reconfiguration.
